(19) United States
(12) Patent Application Publication
(10) Pub. No.: US 2026/0197754 A1
(43) Pub. Date: Jul. 9, 2026

(54) MANAGEMENT AND CONTROL APPARATUS, BASE STATION, COMMUNICATION SYSTEM AND CONTROL METHOD

(71) Applicant: NTT, Inc., Tokyo (JP)

(72) Inventors: Karin UMEDA, Musashino-shi (JP); Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/129,582

(22) PCT Filed: Jun. 19, 2023
(86) PCT No.: PCT/JP2023/022640

§ 371 Date: May 13, 2025

(30) Foreign Application Priority Data
Nov. 16, 2022 (WO) PCT/JP2022/042544

(51) Int. Cl. H04W 52/02; H04W 28/086

(52) U.S. Cl. CPC H04W 52/0206; H04W 28/0861

(57) ABSTRACT

A management control device includes a linkage information collection unit that acquires linkage information indicating a communication state with one or more terminals from each of one or more first base stations which perform radio communication with the one or more terminals and one or more second base stations which form a smaller range communication area than that of the one or more first base stations in a communication area formed by the one or more first base stations and perform the radio communication with the one or more terminals, an analysis unit that determines whether or not an optical path switching is necessary on the basis of the linkage information, an optical path switching control unit that controls the switching of optical paths of the one or more first base stations or optical paths of the one or more second base stations when it is determined that the optical path switching is necessary, and a sleep control unit that shifts the one or more first base stations or the one or more second base stations to a sleep state before the optical path switching is performed or after the switching is performed.

The present application claims priority based on PCT/JP2022/042544 filed in Japan on Nov. 16, 2022, and invokes the content herein.

### TECHNICAL FIELD

The present invention relates to a management control device, a base station, a communication system, and a control method.

### BACKGROUND ART

Conventionally, a communication system for improving communication efficiency by arranging a plurality of small cells in a communication area of a macro cell has been proposed (for example, see NPL 1).

### CITATION LIST

### Non Patent Literature

Non Patent Literature 1: “3GPP TS 38.802 V14.2.0”, 3GPP (Registered Trademark), 2017.

### SUMMARY OF INVENTION

### Technical Problem

However, in the conventional communication system, even when small traffic flows to the small cell, a base station of the small cell consumes the same power as that of when the maximum traffic flows. Therefore, there is a problem that power consumption is increased. Note that such a problem may similarly occur not only in the small cell but also in the case where the base station constructing a communication area smaller than the communication area of the macro cell is arranged in the communication area of the macro cell.

In view of the above-mentioned circumstances, an object of the present invention is to provide a technique capable of suppressing the power consumption in a communication system in which one or more base stations constructing the communication area smaller than the communication area of the macro cell are arranged in the communication area of the macro cell.

### Solution to Problem

One aspect of the present invention is a management control device that includes a linkage information collection unit that acquires linkage information indicating a communication state with one or more terminals from each of one or more first base stations which perform radio communication with the one or more terminals and one or more second base stations which form a smaller range communication area than that of the one or more first base stations in a communication area formed by the one or more first base stations and perform the radio communication with the one or more terminals, an analysis unit that determines whether or not an optical path switching is necessary on the basis of the linkage information, an optical path switching control unit that controls the switching of optical paths of the one or more first base stations or optical paths of the one or more second base stations when it is determined that the optical path switching is necessary, and a sleep control unit that shifts the one or more first base stations or the one or more second base stations to a sleep state before the optical path switching is performed or after the switching is performed.

One aspect of the present invention is a base station that forms a first communication area or a base station that forms a second communication area with a range smaller than that of the base station in a first communication area formed by the base station, the base station includes a transmission unit that transmits linkage information indicating a communication state with one or more terminals to a management control device that controls a system, a reception unit that receives an optical path switching instruction indicating that the management control device determines that an optical path switching is necessary on the basis of the linkage information, and a sleep processing unit that shifts to a sleep state before the optical path switching is performed or after the switching is performed based on the optical path switching instruction.

An aspect of the present invention is a communication system that includes one or more first base stations that perform radio communication with one or more terminals, one or more second base stations that form a communication area in a range smaller than that of the one or more first base stations in a communication area formed by the one or more first base stations and perform the radio communication with the one or more terminals, a linkage information collection unit that acquires linkage information indicating a communication state with the one or more terminals from each of the one or more first base stations and the one or more second base stations, an analysis unit that determines whether or not an optical path switching is necessary on the basis of the linkage information, an optical path switching control unit that controls the switching of optical paths of the one or more first base stations or optical paths of the one or more second base stations when it is determined that the optical path switching is necessary, and a sleep control unit that shifts the one or more first base stations or the one or more second base stations to a sleep state before the optical path switching is performed or after the switching is performed.

One aspect of the present invention is a control method that includes acquiring linkage information indicating a communication state with one or more terminals from each of one or more first base stations which perform radio communication with the one or more terminals and one or more second base stations which form a smaller range communication area than that of the one or more first base stations in a communication area formed by the one or more first base stations and perform the radio communication with the one or more terminals, determining whether or not an optical path switching is necessary on the basis of the linkage information, controlling the switching of optical paths of the one or more first base stations or optical paths of the one or more second base stations when it is determined that the optical path switching is necessary, and shifting the one or more first base stations or the one or more second base stations to a sleep state before the optical path switching is performed or after the switching is performed.

### Advantageous Effects of Invention

According to the present invention, it is possible to suppress the power consumption in the communication system in which one or more base stations constructing the communication area smaller than the communication area of the macro cell are arranged in the communication area of the macro cell.

### BRIEF DESCRIPTION OF DRAWINGS

FIG. 1 A diagram for explaining an outline of processing of a mobile NW system according to a first embodiment.

FIG. 2 A diagram showing a configuration example of the mobile NW system according to the first embodiment.

FIG. 3 A flowchart showing one example of a flow of sleep processing executed by a management control device according to the first embodiment.

FIG. 4 A flowchart showing one example of a flow of sleep processing executed by the management control device according to the first embodiment.

FIG. 5 A flowchart showing one example of a flow of sleep release processing executed by the management control device according to the first embodiment.

FIG. 6 A diagram showing a configuration example of a mobile NW system according to a modification example 1 of the first embodiment.

FIG. 7 A diagram showing a configuration example of a mobile NW system according to a modification example 2 of the first embodiment.

FIG. 8 A diagram showing a configuration example of a mobile NW system according to a modification example 3 of the first embodiment.

FIG. 9 A diagram for explaining an outline of processing of a mobile NW system according to a second embodiment.

FIG. 10 A diagram showing a configuration example of the mobile NW system according to the second embodiment.

FIG. 11 A flowchart showing one example of a flow of sleep processing executed by a management control device according to the second embodiment.

FIG. 12 A flowchart showing one example of a flow of sleep processing executed by the management control device according to the second embodiment.

FIG. 13 A flowchart showing one example of a flow of sleep release processing executed by the management control device according to the second embodiment.

FIG. 14 A diagram for explaining an outline of processing of a mobile NW system according to a third embodiment.

FIG. 15 A diagram showing a configuration example of the mobile NW system according to the third embodiment.

FIG. 16 A flowchart showing one example of a flow of sleep processing executed by the management control device according to the third embodiment.

FIG. 17 A flowchart showing one example of a flow of sleep processing executed by the management control device according to the third embodiment.

FIG. 18 A flowchart showing one example of a flow of sleep release processing executed by the management control device according to the third embodiment.

FIG. 19 A diagram for explaining an outline of processing of a mobile NW system according to a fourth embodiment.

FIG. 20 A diagram showing a configuration example of the mobile NW system according to the fourth embodiment.

FIG. 21 A flowchart showing one example of a flow of sleep processing executed by a management control device according to the fourth embodiment.

FIG. 22 A flowchart showing one example of a flow of sleep processing executed by the management control device according to the fourth embodiment.

FIG. 23 A flowchart showing one example of a flow of sleep release processing executed by the management control device according to the fourth embodiment.

FIG. 24 A diagram for explaining an outline of processing of a mobile NW system according to a fifth embodiment.

FIG. 25 A diagram showing a configuration example of the mobile NW system according to the fifth embodiment.

FIG. 26 A flowchart showing one example of a flow of sleep processing executed by a management control device according to the fifth embodiment.

FIG. 27 A flowchart showing one example of a flow of sleep processing executed by the management control device according to the fifth embodiment.

FIG. 28 A flowchart showing one example of a flow of sleep processing executed by the management control device according to the fifth embodiment.

FIG. 29 A flowchart showing one example of a flow of sleep release processing executed by the management control device according to the fifth embodiment.

FIG. 30 A diagram for explaining an outline of processing of a mobile NW system according to a sixth embodiment.

FIG. 31 A diagram showing a configuration example of the mobile NW system according to the sixth embodiment.

FIG. 32 A flowchart showing one example of a flow of sleep processing executed by a management control device according to the sixth embodiment.

FIG. 33 A flowchart showing one example of a flow of sleep processing executed by the management control device according to the sixth embodiment.

FIG. 34 A flowchart showing one example of a flow of sleep processing executed by the management control device according to the sixth embodiment.

FIG. 35 A flowchart showing one example of a flow of sleep release processing executed by the management control device according to the sixth embodiment.

FIG. 36 A diagram showing a configuration example of a mobile NW system according to a modification example 3 of the fifth embodiment.

FIG. 37 A diagram showing a configuration example of a mobile NW system according to a modification example 4 of the fifth embodiment.

FIG. 38 A diagram showing a configuration example of a mobile NW system according to a modification example 5 of the fifth embodiment.

FIG. 39 A diagram showing a configuration example of a mobile NW system according to a modification example 6 of the fifth embodiment.

FIG. 40 A diagram showing a configuration example of a mobile NW system according to a modification example 7 of the fifth embodiment.

FIG. 41 A diagram showing a configuration example of a mobile NW system according to a modification example 8 of the fifth embodiment.

FIG. 42 A diagram showing a configuration example of a mobile NW system according to a modification example 9 of the fifth embodiment.

FIG. 43 A flowchart showing one example of a flow of sleep processing executed by a management control device according to a modification example 11 of the fifth embodiment.

FIG. 44 A flowchart showing one example of a flow of sleep processing executed by a management control device according to a modification example 12 of the fifth embodiment.

FIG. 45 A flowchart showing one example of a flow of sleep processing executed by a management control device according to a modification example 13 of the fifth embodiment.

### DESCRIPTION OF EMBODIMENTS

Hereinafter, one embodiment of the present invention will be described with reference to the drawings.

### Outline of First Embodiment

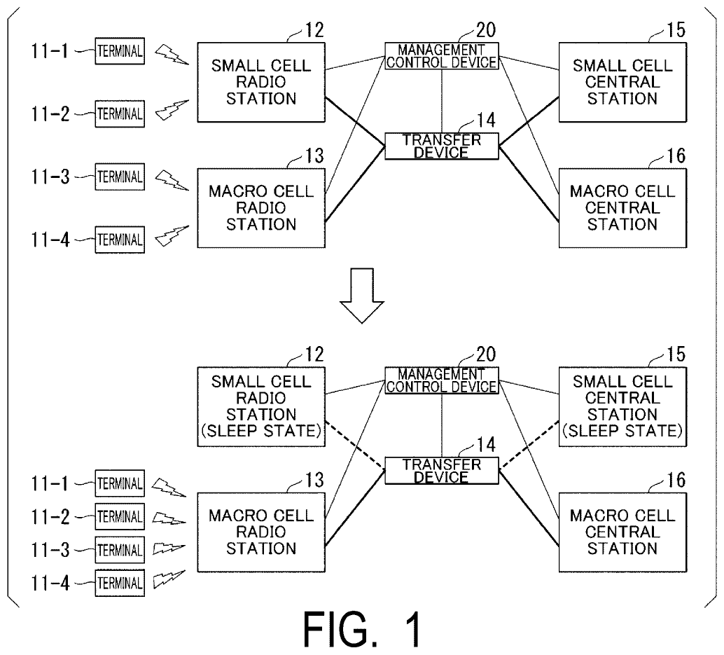

FIG. 1 is a diagram for explaining an outline of processing of a mobile NW system according to a first embodiment. First, an entire configuration of the mobile NW system according to the first embodiment will be described. The mobile NW system according to the first embodiment is one example of a communication system. The mobile NW system according to the first embodiment is a fifth-generation mobile communication system (hereinafter referred to as “5G”). The mobile NW system according to the first embodiment includes one or more small cell radio stations 12, one or more macro cell radio stations 13, a transfer device 14, one or more small cell central stations 15, one or more macro cell central stations 16, and a management control device 20.

The small cell radio station 12 and the transfer device 14, the macro cell radio station 13 and the transfer device 14, the transfer device 14 and the small cell central station 15, and the transfer device 14 and the macro cell central station 16 are connected by optical fibers for transmitting optical signals. The transfer device 14 and the management control device 20, the small cell central station 15 and the management control device 20, and the macro cell central station 16 and the management control device 20 are connected by the optical fibers or electric lines for transmitting electric signals.

In an example shown in FIG. 1, the small cell radio station 12, the macro cell radio station 13, the small cell central station 15, and the macro cell central station 16 are each one. Note that although a plurality of transfer devices 14 may be provided, the following description will be given by taking one transfer device as an example. In the following description, when the small cell radio station 12 and the macro cell radio station 13 are not distinguished from each other, they are simply referred to as radio stations, and when the small cell central station 15 and the macro cell central station 16 are not distinguished from each other, they are simply referred to as central stations.

The central station is a distribution station in mobile communication, for example, and the radio station is an antenna station in the mobile communication, for example. The transfer device 14 and the management control device 20 are installed in a section called a mobile front haul (MFH). The central station may be regarded as an aggregation station, the antenna station may be regarded as a distribution station, and the transfer device 14 and the management control device 20 may be regarded as being installed in a mobile mid haul (MMH).

The small cell radio station 12 is connected to the small cell central station 15 through the transfer device 14. The macro cell radio station 13 is connected to the macro cell central station 16 through the transfer device 14.

The small cell radio station 12 is a radio station installed in a communication area formed by the macro cell radio station 13. The small cell radio station 12 forms the smaller range communication area than that of the communication area formed by the macro cell radio station 13. For example, the communication area formed by the small cell radio station 12 has a radius of several meters to several hundred meters. The small cell radio station 12 includes one or more antennas, and performs radio communication with a terminal 11 located in the communication area. For example, the small cell radio station 12 receives a signal transmitted from the terminal 11, and transmits the received signal to the small cell central station 15 connected through the transfer device 14. The small cell radio station 12 transmits the signal received through the transfer device 14 to the terminal 11.

The small cell radio station 12 is a RU (Radio Unit) in a 5G communication standard, for example. When the small cell radio station 12 includes a plurality of antennas, the small cell radio station 12 may perform the radio communication with the terminal 11 by beam forming. The small cell radio station 12 shifts to a sleep state in accordance with a sleep instruction transmitted from the management control device 20. The sleep state is a state in which power saving can be achieved by partially stopping or stopping the entire base station. Further, the small cell radio station 12 performs an optical path switching in accordance with an optical path switching instruction transmitted from the management control device 20. The optical path is a route of an optical signal. The optical path switching instruction is an instruction related to an optical path control, and includes information instructing to stop the optical path setting, for example. When receiving the optical path switching start instruction after receiving the optical path switching instruction, the small cell radio station 12 stops the optical path setting with the transfer device 14. Stopping the optical path setting in the small cell radio station 12 means that light is not irradiated onto a route from the small cell radio station 12 to the transfer device 14.

The macro cell radio station 13 is a radio station forming the larger range communication area than that of the communication area formed by the small cell radio station 12. For example, the communication area formed by the macro cell radio station 13 has a radius of several hundred meters to several kilometers. The macro cell radio station 13 includes one or more antennas, and performs the radio communication with the terminal 11 located in the communication area. For example, the macro cell radio station 13 receives the signal transmitted from the terminal 11 and transmits the received signal to the macro cell central station 16 connected through the transfer device 14. The macro cell radio station 13 transmits the signal received through the transfer device 14 to the terminal 11. The macro cell radio station 13 is a RU in the 5G communication standard, for example.

The macro cell radio station 13 shifts to the sleep state in accordance with the sleep instruction transmitted from the management control device 20. Further, the macro cell radio station 13 performs the optical path switching in accordance with the optical path switching instruction transmitted from the management control device 20. When receiving the optical path switching start instruction after receiving the optical path switching instruction, the macro cell radio station 13 stops the optical path setting with the transfer device 14. Stopping the optical path setting in the macro cell radio station 13 means that light is not irradiated onto a route from the macro cell radio station 13 to the transfer device 14.

The transfer device 14 is provided between the radio station and the central station. The transfer device 14 performs the optical path switching in accordance with the instruction (hereinafter referred to as “switching destination information”) indicating the optical path switching destination transmitted from the management control device 20. The transfer device 14 switches the connections between the radio station and the central station by switching the optical paths. For example, when receiving the optical path switching destination information transmitted from the management control device 20, the transfer device 14 instructs switching so that the optical path is connected between the radio station and the central station which become the optical path switching destinations.

The small cell central station 15 receives upstream signals transmitted by the small cell radio station 12 through the transfer device 14. The small cell central station 15 transmits downstream signals to the small cell radio station 12 through the transfer device 14. Note that the upstream signals are signals transmitted by the terminal 11, and the downstream signals are signals in which the terminal 11 is the destination. The small cell central station 15 shifts to the sleep state in accordance with the sleep instruction transmitted from the management control device 20. The small cell central station 15 is a DU (Distributed Unit) in the 5G communication standard, for example. Information that the management control device 20 obtains from the central station is referred to as linkage information. The linkage information according to the first embodiment is information indicating a communication state between each central station and the terminal 11.

The linkage information according to the first embodiment includes traffic amount information on each central station, for example. Hereinafter, the traffic amount information is referred to as traffic information. Note that the traffic information is one described in DCI (Downlink Control Information) or O-RAN CTI (O-RAN.WG4.CTI-TCP.0-v01.00), for example. In O-RAN CTI, it is intended to be schedule information. Further, the small cell central station 15 performs the optical path switching in accordance with the optical path switching instruction transmitted from the management control device 20. When receiving the optical path switching start instruction after receiving the optical path switching instruction, the small cell central station 15 stops the optical path setting with the transfer device 14. Stopping the optical path setting in the small cell central station 15 means that light is not irradiated onto a route from the small cell central station 15 to the transfer device 14.

The macro cell central station 16 receives the upstream signals transmitted by the macro cell radio station 13 through the transfer device 14. The macro cell central station 16 transmits the downstream signals to the macro cell radio station 13 through the transfer device 14. The macro cell central station 16 shifts to the sleep state in accordance with the sleep instruction transmitted from the management control device 20. The macro cell central station 16 is a DU in the 5G communication standard, for example. The macro cell central station 16 transmits the linkage information to the management control device 20.

Further, the macro cell central station 16 performs the optical path switching in accordance with the optical path switching instruction transmitted from the management control device 20. When receiving the optical path switching start instruction after receiving the optical path switching instruction, the macro cell central station 16 stops the optical path setting with the transfer device 14. Stopping the optical path setting in the macro cell central station 16 means that light is not irradiated onto a route from the macro cell central station 16 to the transfer device 14.

The management control device 20 is a device that manages the entire mobile NW system 100. The management control device 20 acquires the linkage information from each central station. The management control device 20 determines whether or not the optical path switching and the sleep control are necessary on the basis of the acquired linkage information. When it is determined that the optical path switching and sleep control are necessary, the management control device 20 performs the optical path switching control processing and the sleep control processing. The optical path switching control processing is processing for performing the optical path switching between the radio station and the central station. The sleep control processing is processing for executing sleep or performing sleep release for each radio station or each central station.

Next, an outline of processing of the mobile NW system will be described.

An upper figure in FIG. 1 represents a connection state of the mobile NW system before the optical path switching, and a lower figure in FIG. 1 represents the connection state of the mobile NW system after the optical path switching. In the upper figure in FIG. 1 shows an example in which the terminals 11-1 and 11-2 are connected to the small cell radio station 12, the small cell radio station 12 is connected to the small cell central station 15 through the transfer device 14, the terminals 11-3 and 11-4 are connected to the macro cell radio station 13, and the macro cell radio station 13 is connected to the macro cell central station 16 through the transfer device 14.

The management control device 20 judges whether or not the optical path switching control processing is performed on the basis of the linkage information collected from each central station. The management control device 20 compares a switching determination threshold value held in advance with a traffic amount indicated by the traffic information included in the collected linkage information. The switching determination threshold value is a threshold value for determining that the optical path switching is necessary. In the first embodiment, when the traffic amount flowing to the small cell central station 15 is small, the small cell central station 15 and the small cell radio station 12 connected to the small cell central station 15 are shifted to the sleep state, the optical path between the small cell radio station 12 and the small cell central station 15 is switched to the optical path between the macro cell radio station 13 and the macro cell central station 16. By doing this, power consumption in the small cell central station 15 with the flowing small traffic amount and in the small cell radio station 12 connected to the small cell central station 15 can be suppressed.

For the above-mentioned purpose, it is desirable that a value which becomes a reference indicating that the traffic amount is large is set as the switching determination threshold value. When the switching determination threshold value is larger than the traffic amount of the small cell central station 15, the management control device 20 judges that the optical path switching control processing is performed. When the switching determination threshold value is larger than the traffic amount of the small cell central station 15, it means that the traffic amount flowing to the small cell central station 15 is small. On the other hand, when the switching determination threshold value is equal to or less than the traffic amount of the small cell central station 15, the management control device 20 judges that the optical path switching control processing is not performed. When the switching determination threshold value is equal to or less than the traffic amount of the small cell central station 15, it means that the traffic amount flowing to the small cell central station 15 is large.

When it is judged that the optical path switching control processing is performed, the management control device 20 transmits information on optical path switching destination to the transfer device 14, and instructs the optical path switching to the radio station and the central station which become optical path switching targets. Note that since the connection destinations of the terminals 11 are changed by the optical path switching, the management control device 20 may instruct the central station which becomes the optical path switching target to change the connections. The transfer device 14 switches the optical paths between the radio station and the central station in accordance with the instruction from the management control device 20. The transfer device 14 notifies the management control device 20 of the optical path switching completion after the optical path switching is completed. The radio station and the central station which become the optical path switching targets perform the optical path switching in accordance with the instruction from the management control device 20.

When the optical path switching control processing is completed, the management control device 20 transmits a sleep permission notification to the radio station and the central station which become the targets to be shifted to the sleep state. The sleep permission notification is a signal including an instruction for shifting the radio station and the central station to the sleep state. By doing this, the radio station and the central station which become the targets to be shifted to the sleep state shift to the sleep state.

The lower figure in FIG. 1 shows an example in which the terminals 11-1 to 11-4 are connected to the macro cell radio station 13 and the small cell radio station 12 and the small cell central station 15 are shifted to the sleep state. In this way, in the mobile NW system according to the first embodiment, on the basis of the linkage information collected from each central station, the optical path between the small cell central station 15 with the small traffic amount and the small cell radio station 12 connected to the small cell central station 15 is switched to the optical path between the macro cell radio station 13 and the macro cell central station 16 covering a range larger than that of the small cell. Then, the unused small cell central station 15 and small cell radio station 12 connected to the small cell central station 15 are shifted to the sleep state. Hereinafter, a radio station and a central station which become the optical path switching targets may be described as a switching source radio station and a switching source central station, respectively, and a radio station and a central station which become the optical path switching destinations may be described as a switching destination radio station and a switching destination central station, respectively.

### Detail of First Embodiment

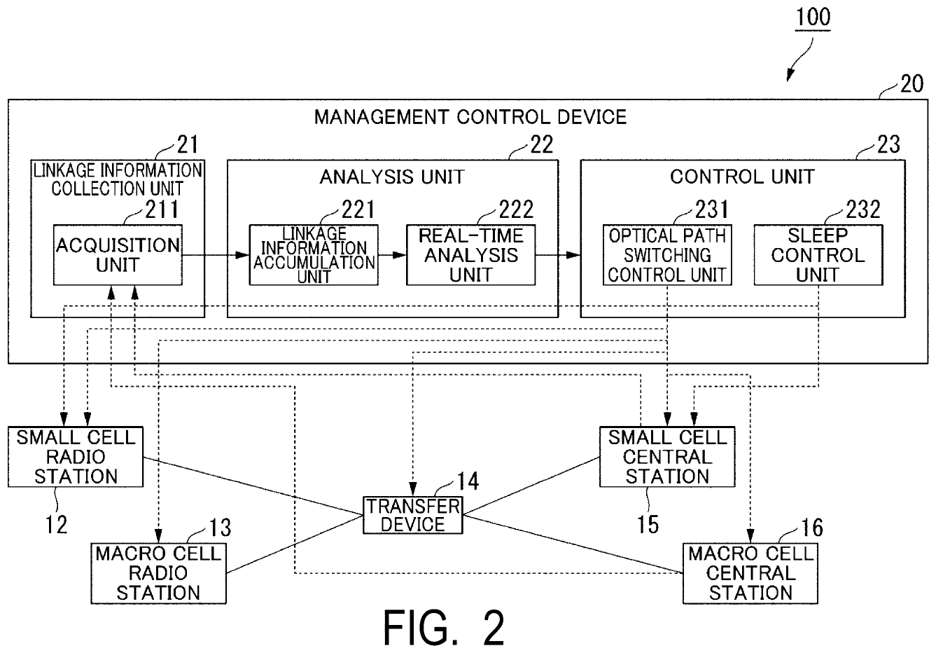

FIG. 2 is a diagram showing a configuration example of the mobile NW system 100 according to the first embodiment. The mobile NW system 100 according to the first embodiment includes one or more small cell radio stations 12, one or more macro cell radio stations 13, a transfer device 14, one or more small cell central stations 15, one or more macro cell central stations 16, and a management control device 20. In the following description, a case in which the mobile NW system 100 includes one small cell radio station 12, one macro cell radio station 13, one small cell central station 15, and one macro cell central station 16, respectively, will be described as an example.

The small cell radio station 12 and the small cell central station 15 are one aspect of a small cell base station (second base station). The macro cell radio station 13 and the macro cell central station 16 are one aspect of a macro cell base station (first base station). Note that since the configuration of the small cell radio station 12, the macro cell radio station 13, the transfer device 14, the small cell central station 15, and the macro cell central station 16 has been described in FIG. 1, the description thereof will be omitted. The management control device 20 includes a linkage information collection unit 21, an analysis unit 22, and a control unit 23.

The linkage information collection unit 21 includes an acquisition unit 211. The acquisition unit 211 collects the linkage information from each central station at a predetermined period or at arbitrary timing. For example, the acquisition unit 211 collects traffic information on each central station as the linkage information.

The analysis unit 22 includes a linkage information accumulation unit 221 and a real-time analysis unit 222. The linkage information accumulation unit 221 records the collected linkage information in a predetermined storage device. The real-time analysis unit 222 analyzes a communication state between each central station and the terminal 11 on the basis of the linkage information. Specifically, the real-time analysis unit 222 determines whether or not the optical path switching and sleep control are necessary on the basis of the linkage information.

When determining whether or not the optical path switching and sleep control are necessary, the real-time analysis unit 222 compares the switching determination threshold value held in advance with the traffic amount indicated by the traffic information included in the collected linkage information. The real-time analysis unit 222 holds the switching determination threshold value for each central station. That is, the real-time analysis unit 222 holds the switching determination threshold value for the small cell central station 15 and the switching determination threshold value for the macro cell central station 16.

Note that when a plurality of small cell central stations 15 is provided, the real-time analysis unit 222 may hold the switching determination threshold values different for each small cell central station 15, or may hold one switching determination threshold value common to all the small cell central stations 15. Similarly, when a plurality of macro cell central stations 16 is provided, the real-time analysis unit 222 may hold the switching determination threshold values different for each macro cell central station 16, or may hold one switching determination threshold value common to all the macro cell central stations 16.

The real-time analysis unit 222 judges whether or not a first switching condition is satisfied as a result of the comparison. The first switching condition is a condition indicating that the optical path switching between the small cell radio station 12 and the small cell central station 15 is necessary. The first switching condition is that the switching determination threshold value for the small cell central station 15 is larger than the traffic amount obtained from the small cell central station 15, and the switching determination threshold value for the macro cell central station 16 is larger than the traffic amount obtained from the macro cell central station 16, for example.

When the first switching condition is satisfied, the real-time analysis unit 222 judges that the optical path switching control processing is performed. On the other hand, when the first switching condition is not satisfied, the management control device 20 judges that the optical path switching control processing is not performed. When it is judged that the optical path switching control processing is performed, the real-time analysis unit 222 notifies a control unit 23 of control information including information indicating the central station which becomes the optical path switching source, information indicating the central station which becomes the optical path switching destination, and information indicating the radio station and the central station which become the sleep control targets.

Here, in the first embodiment, when the first switching condition is satisfied, the central station which becomes the optical path switching source is the small cell central station 15 in which the switching determination threshold value for the small cell central station 15 is larger than the traffic amount. In the first embodiment, when the first switching condition is satisfied, the central station which becomes the optical path switching destination is the macro cell central station 16 in which the switching determination threshold value for the macro cell central station 16 is larger than the traffic amount. In the first embodiment, when the first switching condition is satisfied, the radio station and the central station which become the sleep control targets are the small cell central station 15 and the small cell radio station 12 connected to the small cell central station 15 which become the optical path switching sources. In this way, the real-time analysis unit 222 aggregates the traffic by switching the optical path of the small cell central station 15 with the small flowing traffic to the macro cell central station 16 with the small flowing traffic.

Further, the real-time analysis unit 222 judges whether or not a first sleep release condition is satisfied as a result of the comparison. The first sleep release condition is a condition indicating that sleep of the sleeping radio station and central station is released. The first sleep release condition is that the traffic amount of the macro cell central station 16 is larger than the switching determination threshold value for the macro cell central station 16, for example.

When the first sleep release condition is satisfied, the real-time analysis unit 222 judges that the optical path switching control processing is performed. On the other hand, when the first sleep release condition is not satisfied, the real-time analysis unit 222 judges that the optical path switching control processing is not performed. When it is judged that the optical path switching control processing is performed, the real-time analysis unit 222 notifies the control unit 23 of the control information including information indicating the central station which becomes the optical path switching source, information indicating the central station which becomes the optical path switching destination, and information indicating the radio station and the central station which become the sleep control targets.

Here, in the first embodiment, when the first sleep release condition is satisfied, the central station which becomes the optical path switching source is the macro cell central station 16 whose traffic amount is larger than the switching determination threshold value for the macro cell central station 16. In the first embodiment, when the first sleep release condition is satisfied, the central station which becomes the optical path switching destination is the sleeping small cell central station 15. In the first embodiment, when the first sleep release condition is satisfied, the radio station and the central station which become the sleep control targets are the sleeping small cell central station 15 and small cell radio station 12 connected to the small cell central station 15. By doing this, when the traffic flowing to the macro cell central station 16 increases after the first switching condition is satisfied and the optical path switching is performed, the real-time analysis unit 222 switches the optical path of the macro cell central station 16 in which the flowing traffic increases to the small cell central station 15 in which the sleep release has been performed.

The control unit 23 includes an optical path switching control unit 231 and a sleep control unit 232. The optical path switching control unit 231 determines the radio station and the central station which become the optical path switching sources, and the radio station and the central station which become the optical path switching destinations, on the basis of the analysis result of the real-time analysis unit 222. For example, the optical path switching control unit 231 determines the radio station and the central station which become the optical path switching sources on the basis of information indicating the central station which becomes the optical path switching source included in the control information notified from the real-time analysis unit 222. For example, the optical path switching control unit 231 determines the radio station and the central station which become the optical path switching destinations on the basis of information indicating the central station which becomes the optical path switching destination included in the control information notified from the real-time analysis unit 222. The optical path switching control unit 231 holds information on the radio station connected to the central station.

The optical path switching control unit 231 transmits switching destination information including information indicating the radio station and the central station which become the determined optical path switching destinations to the transfer device 14. By doing this, the optical path switching control unit 231 instructs the optical path switching to the transfer device 14. Further, the optical path switching control unit 231 transmits the optical path switching instruction to the radio station and the central station which become the determined optical path switching sources.

The sleep control unit 232 causes the radio station and the central station which become the sleep control targets to execute the sleep or release the sleep on the basis of the analysis result of the real-time analysis unit 222.

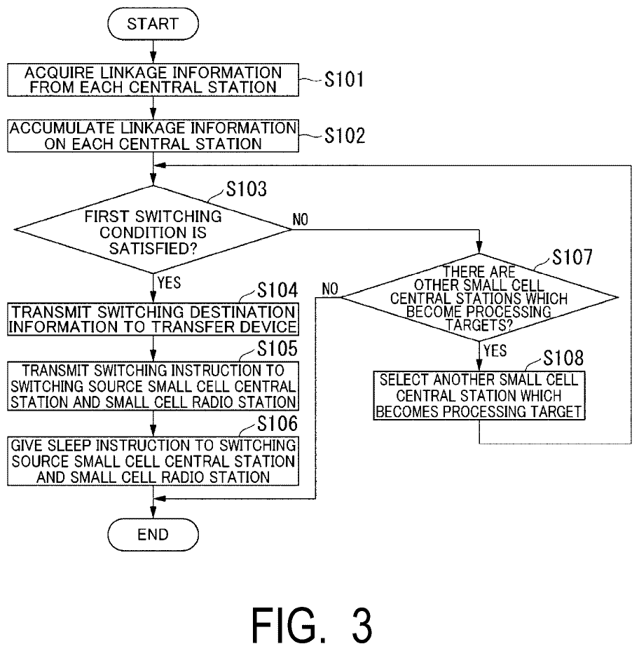

FIG. 3 is a flowchart showing one example of a flow of sleep processing executed by the management control device 20 according to the first embodiment. The flow of the processing in FIG. 3 is repeatedly executed with a predetermined period.

The acquisition unit 211 acquires the linkage information from each central station (step S101). For example, the acquisition unit 211 acquires the linkage information from each of the small cell central station 15 and the macro cell central station 16. The acquisition unit 211 accumulates the acquired linkage information on each central station in the linkage information accumulation unit 221 (step S102). The real-time analysis unit 222 judges whether or not the first switching condition is satisfied on the basis of the linkage information on each central station accumulated in the linkage information accumulation unit 221 and the switching determination threshold value held in advance (step S103).

When it is judged that the first switching condition is satisfied (step S103—YES), the real-time analysis unit 222 notifies the control unit 23 of the control information. The optical path switching control unit 231 determines the radio station and the central station which become the optical path switching destinations on the basis of the control information notified from the real-time analysis unit 222. Here, it is assumed that the optical path switching control unit 231 determines the macro cell radio station 13 and the macro cell central station 16 as the optical path switching destinations. The optical path switching control unit 231 transmits the switching destination information including information indicating the macro cell radio station 13 and the macro cell central station 16 which become the determined optical path switching destinations to the transfer device 14 (step S104). By doing this, the optical path switching control unit 231 instructs that the optical path between the switching source radio station (for example, small cell radio station 12) and the switching source central station (for example, small cell central station 15) is switched to the optical path between the macro cell radio station 13 and the macro cell central station 16.

Further, the optical path switching control unit 231 determines the radio station and the central station which become the optical path switching sources on the basis of the control information notified from the real-time analysis unit 222. Here, it is assumed that the optical path switching control unit 231 determines the small cell radio station 12 and the small cell central station 15 as the optical path switching sources. The optical path switching control unit 231 transmits the optical path switching instruction to the small cell radio station 12 and the small cell central station 15 which are the determined optical path switching sources (step S105). By doing this, the optical path switching control unit 231 controls the optical path between the switching source radio station (for example, small cell radio station 12) and the switching source central station (for example, small cell central station 15).

The sleep control unit 232 determines the radio station and the central station which become the sleep control targets on the basis of the control information notified from the real-time analysis unit 222. Here, the sleep control unit 232 determines the small cell radio station 12 and the small cell central station 15 as the sleep control targets. The sleep control unit 232 transmits the sleep permission notification to the determined small cell radio station 12 and small cell central station 15 (step S106). For example, the sleep control unit 232 may transmit the sleep permission notification when an optical path switching completion notification is obtained from each of the small cell radio station 12 and the small cell central station 15. The optical path switching completion notification is a signal including a content indicating that the optical path switching is completed. By doing this, the small cell radio station 12 and the small cell central station 15 can shift to the sleep state.

In the processing of the step S103, when it is determined that the first switching condition is not satisfied (step S103-NO), the real-time analysis unit 222 judges whether or not there are other small cell central stations 15 which become the processing targets (step S107). Other small cell central stations 15 which become the processing targets are the small cell central stations 15 which are not judged by the first switching condition, for example. When it is determined that there are no other small cell central stations 15 which become the processing targets (step S107-NO), the real-time analysis unit 222 terminates the processing.

On the other hand, when it is determined that there are other small cell central stations 15 which become the processing targets (step S107—YES), the real-time analysis unit 222 selects one small cell central station 15 from other small cell central stations 15 which become the processing targets (step S108). Thereafter, the real-time analysis unit 222 executes the processing of the step S103 again by using the linkage information obtained from the selected small cell central station 15.

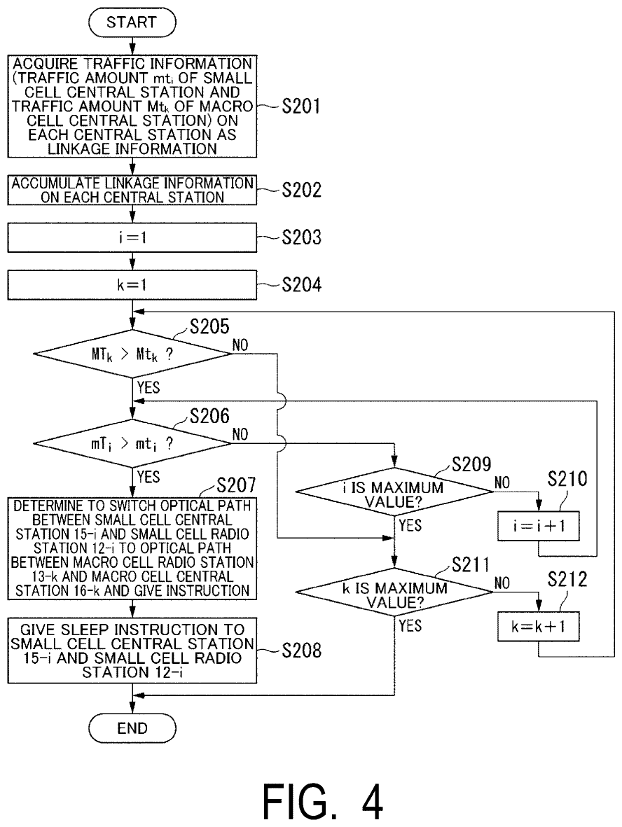

FIG. 4 is a flowchart showing one example of a flow of sleep processing executed by the management control device 20 according to the first embodiment. Note that the processing shown in FIG. 4 will describe the contents in which the processing shown in FIG. 3 is more specifically shown.

The acquisition unit 211 acquires the traffic information indicating a traffic amount mtᵢ of the small cell central station 15-i from the small cell central station 15-i and the traffic information indicating a traffic amount Mtₖ of the macro cell central station 16-k from the macro cell central station 16-k as the linkage information (step S201). i represents the small cell central station 15 which becomes the switching source, for example. When i=1 is satisfied, the small cell central station 15-1 becomes the switching source central station. i is a value of 1≤i≤I. Iis a total number of small cell central stations 15. k represents the macro cell central station 16 which becomes the switching destination, for example. When k=1 is satisfied, the macro cell central station 16-1 becomes the switching destination central station. k is a value of 1≤k≤K. K is a total number of macro cell central stations 16.

The acquisition unit 211 accumulates the acquired linkage information on each central station in the linkage information accumulation unit 221 (step S202). The real-time analysis unit 222 substitutes a value of 1 to the constant i (step S203). The real-time analysis unit 222 substitutes a value of 1 to the constant k (step S204).

The real-time analysis unit 222 judges whether or not a switching determination threshold value MTₖ for the macro cell central station 16-k is larger than the traffic amount Mtₖ of the macro cell central station 16-k on the basis of the linkage information (for example, traffic amount Mtₖ of the macro cell central station 16-k) of the macro cell central station 16-k accumulated in the linkage information accumulation unit 221 (step S205). When the constant k=1 is satisfied, the real-time analysis unit 222 judges whether or not a switching determination threshold value MT₁ for the macro cell central station 16-1 is larger than a traffic amount Mtᵢ of the macro cell central station 16-1.

When it is judged that the switching determination threshold value MTₖ for the macro cell central station 16-k is larger than the traffic amount Mtₖ of the macro cell central station 16-k (step S205—YES), the real-time analysis unit 222 judges whether or not a switching determination threshold value mTᵢ for the small cell central station 15-i is larger than a traffic amount mtᵢ of the small cell central station 15-i (step S206). When the constant i=1 is satisfied, the real-time analysis unit 222 judges whether or not a switching determination threshold value mTᵢ for the small cell central station 15-1 is larger than a traffic amount mtᵢ of the small cell central station 15-1. The conditions indicated in the step S205 and the step S206 are specific examples of the first switching condition.

When it is judged that the switching determination threshold value mTᵢ for the small cell central station 15-i is larger than the traffic amount mtᵢ of the small cell central station 15-i (step S206—YES), the real-time analysis unit 222 judges that the first switching condition is satisfied. In this case, the real-time analysis unit 222 notifies the control unit 23 of the control information including information indicating the small cell central station 15-i which becomes the optical path switching source, information indicating the macro cell central station 16-k which becomes the optical path switching destination, and information indicating the small cell radio station 12-i connected to the small cell central station 15-i and the small cell central station 15-i which become the sleep control targets.

The optical path switching control unit 231 determines the radio station and the central station which become the optical path switching sources, and the radio station and the central station which become the optical path switching destinations on the basis of the control information notified from the real-time analysis unit 222. By doing this, the optical path switching control unit 231 determines to switch the optical path between the small cell central station 15-i and the small cell radio station 12-i to the optical path between the macro cell radio station 13-k and the macro cell central station 16-k. The optical path switching control unit 231 transmits the switching destination information including information indicating the macro cell radio station 13-k and the macro cell central station 16-k which become the determined optical path switching destinations to the transfer device 14. Further, the optical path switching control unit 231 transmits the optical path switching instruction to the small cell radio station 12-i and the small cell central station 15-i which become the determined optical path switching sources (step S207).

The sleep control unit 232 determines the small cell radio station 12-i and the small cell central station 15-i which become the sleep control targets on the basis of the control information notified from the real-time analysis unit 222. The sleep control unit 232 transmits the sleep permission notification to the determined small cell radio station 12-i and small cell central station 15-i (step S208).

In the processing of the step S206, when it is judged that the switching determination threshold value mTᵢ for the small cell central station 15-1 is not larger than the traffic amount mtᵢ of the small cell central station 15-i (step S206—NO), the real-time analysis unit 222 judges that the first switching condition is not satisfied. In this case, the real-time analysis unit 222 judges whether or not the constant i is the maximum value (step S209). When it is judged that the constant i is not the maximum value (step S209—NO), the real-time analysis unit 222 adds a value of 1 to a value of the constant i (step S210). Thereafter, the real-time analysis unit 222 executes the processing of step S206 again.

On the other hand, when it is judged that the constant i is the maximum value (step S209—YES), the real-time analysis unit 222 judges whether or not the constant k is the maximum value (step S211). When it is judged that the constant k is not the maximum value (step S211—NO), the real-time analysis unit 222 adds a value of 1 to a value of the constant k (step S212). Thereafter, the real-time analysis unit 222 executes the processing of step S205 again. On the other hand, when it is judged that the constant k is the maximum value (step S211—YES), the real-time analysis unit 222 terminates the processing.

In the processing of the step S205, when it is judged that the switching determination threshold value MTₖ for the macro cell central station 16-k is not larger than the traffic amount Mtₖ of the macro cell central station 16-k (step S205—NO), the real-time analysis unit 222 performs the processing of the step S211.

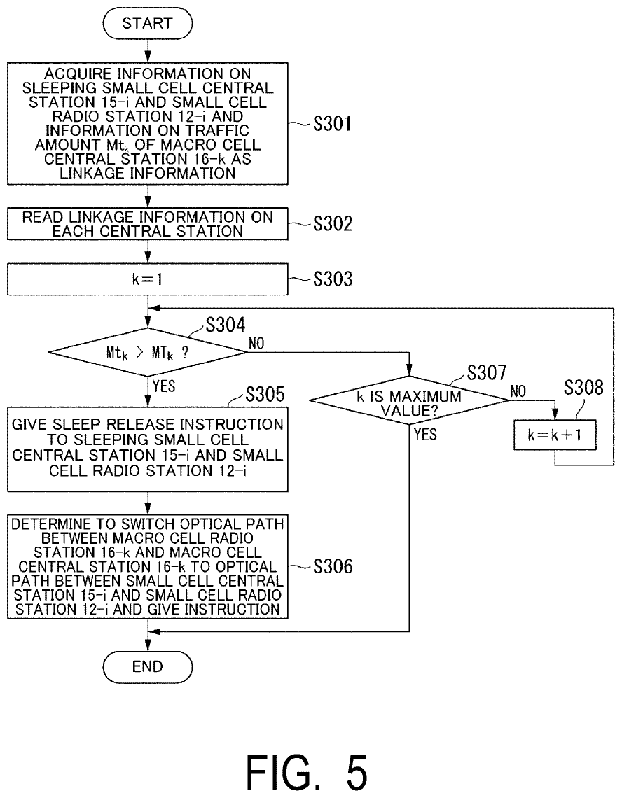

FIG. 5 is a flowchart showing one example of a flow of sleep release processing executed by the management control device 20 according to the first embodiment. The acquisition unit 211 acquires the traffic information indicating the traffic amount Mtₖ of the macro cell central station 16-k from each macro cell central station 16-k as the linkage information, and acquires information indicating the sleeping small cell central station 15-i and small cell radio station 12-i as the linkage information (step S301). The acquisition unit 211 accumulates the traffic information indicating the acquired traffic amount Mtₖ and the information indicating the sleeping small cell central station 15-i and small cell radio station 12-i in the linkage information accumulation unit 221.

The real-time analysis unit 222 reads the linkage information from the linkage information accumulation unit 221 (step S302). The real-time analysis unit 222 substitutes a value of 1 to the constant k (step S303). The real-time analysis unit 222 judges whether or not the traffic amount Mtₖ of the macro cell central station 16-k is larger than the switching determination threshold value MTₖ for the macro cell central station 16-k (step S405). The condition indicated by Mtₖ>MTₖ is a specific example of the first sleep release condition.

When it is judged that the traffic amount Mtₖ of the macro cell central station 16-k is larger than the switching determination threshold value MTₖ for the macro cell central station 16-k (step S405—YES), the real-time analysis unit 222 judges that the first sleep release condition is satisfied. In this case, the real-time analysis unit 222 notifies the control unit 23 of the control information including information indicating the macro cell central station 16-k which becomes the optical path switching source, the small cell central station 15-i which becomes the optical path switching destination, and information indicating the small cell radio station 12-i connected to the small cell central station 15-i and the small cell central station 15-i which become the sleep control targets.

The sleep control unit 232 transmits the sleep release instruction to the sleeping small cell central station 15-i and small cell radio station 12-i on the basis of the control information notified from the real-time analysis unit 222 (step S305). By doing this, the small cell central station 15-i and the small cell radio station 12-i are released from the sleep state.

The optical path switching control unit 231 determines the radio station and the central station which become the optical path switching sources, and the radio station and the central station which become the optical path switching destinations on the basis of the control information notified from the real-time analysis unit 222. By doing this, the optical path switching control unit 231 determines to switch the optical path between the macro cell radio station 13-k and the macro cell central station 16-k to the optical path between the small cell central station 15-i and the small cell radio station 12-i. The optical path switching control unit 231 transmits the switching destination information including information indicating the small cell central station 15-i and the small cell radio station 12-i which become the determined optical path switching destinations to the transfer device 14. Further, the optical path switching control unit 231 transmits the optical path switching instruction to the macro cell radio station 13-k and the macro cell central station 16-k which become the determined optical path switching sources (step S306). Since the connections of the terminals are changed by the optical path switching, the optical path switching control unit 231 may instruct the macro cell central station 16-k to change the connections of the terminals 11.

In the processing of the step S304, when it is judged that the traffic amount Mtₖ of the macro cell central station 16-k is not larger than the switching determination threshold value MTₖ for the macro cell central station 16-k (step S304—NO), the real-time analysis unit 222 judges that the first sleep release condition is not satisfied. In this case, the real-time analysis unit 222 judges whether or not the constant k is the maximum value (step S307).

When it is judged that the constant k is not the maximum value (step S307—NO), the real-time analysis unit 222 adds a value of 1 to a value of the constant k (step S308). Thereafter, the real-time analysis unit 222 executes the processing of step S304 again. On the other hand, when it is judged that the constant k is the maximum value (step S307—YES), the real-time analysis unit 222 terminates the processing.

In the mobile NW system 100 configured as described above, the management control device 20 includes the linkage information collection unit 21 that acquires the linkage information from each of the small cell central station 15 and the macro cell central station 16 at a predetermined period or at arbitrary timing, the analysis unit 22 that determines whether or not the optical path switching is necessary on the basis of the linkage information, the optical path switching control unit 231 that controls the optical path switching between the small cell radio station 12 and the small cell central station 15 when it is determined that the optical path switching is necessary, and the sleep control unit 232 that shifts the small cell radio station 12 and the small cell central station 15 in which the optical path switching is performed to the sleep state after the optical path switching is performed. By doing this, the small cell radio station 12 and the small cell central station 15 which become unconnected can be shifted to the sleep state. Therefore, it is possible to suppress the power consumption.

The management control device 20 collects the traffic amount information as the linkage information, compares the traffic amount indicated by the collected traffic amount information with the threshold value for determining that the optical path switching is necessary, and determines that the optical path switching is necessary when the traffic amount is smaller than the threshold value. By doing this, when the traffic amount is small, it can be determined that the optical path switching is necessary. Therefore, the device with the small traffic amount can be shifted to the sleep state. Therefore, it is possible to suppress the power consumption.

When the traffic amount obtained from the small cell central station 15 is smaller than the threshold value, the management control device 20 controls so as to switch the optical path between the small cell radio station 12 and the small cell central station 15 to the optical path between the macro cell radio station 13 and the macro cell central station 16, and shifts the small cell radio station 12 and the small cell central station 15 to the sleep state after the optical path switching is performed. By doing this, the small cell central station 15 with the small traffic amount can be shifted to the sleep state. Therefore, it is possible to suppress the power consumption.

### Modification Example 1 in First Embodiment

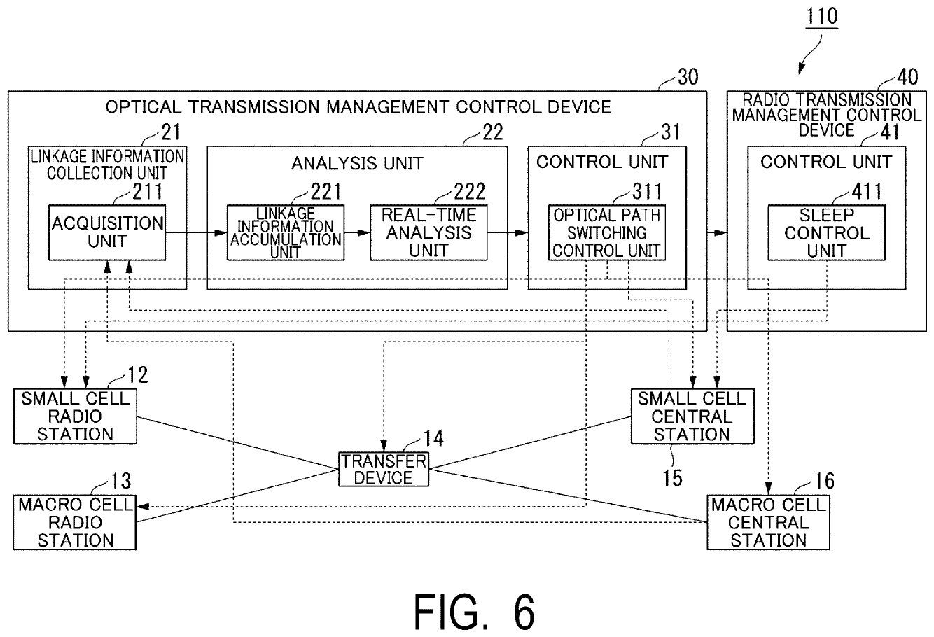

The above-described embodiment shows a configuration in which the management control device 20 performs the optical path switching control processing and the sleep control processing. The optical path switching control processing and the sleep control processing may be performed in different devices. FIG. 6 is a diagram showing a configuration example of a mobile NW system 110 according to a modification example 1 of the first embodiment. The mobile NW system 110 includes one or more small cell radio stations 12, one or more macro cell radio stations 13, a transfer device 14, one or more small cell central stations 15, one or more macro cell central stations 16, an optical transmission management control device 30, and a radio transmission management control device 40. As shown in FIG. 6, the mobile NW system 110 includes the optical transmission management control device 30 and the radio transmission management control device 40 in place of the management control device 20.

The optical transmission management control device 30 controls an optical transmission section. The optical transmission section represents a section in which optical fiber connection is performed. The optical transmission section is a section between the small cell radio station 12 and the transfer device 14, a section between the macro cell radio station 13 and the transfer device 14, a section between the transfer device 14 and the small cell central station 15, and a section between the transfer device 14 and the macro cell central station 16, for example.

The optical transmission management control device 30 includes a linkage information collection unit 21, an analysis unit 22, and a control unit 31. The linkage information collection unit 21 and the analysis unit 22 perform the same processing as that of the linkage information collection unit 21 and the analysis unit 22 included in the management control device 20. The control unit 31 includes an optical path switching control unit 311. The optical path switching control unit 311 performs the processing similar to that of the optical path switching control unit 231 included in the above-described management control device 20.

The radio transmission management control device 40 controls a radio transmission section. The radio transmission section represents a section in which optical fiber connection is performed. The radio transmission section is a section between the terminal 11 and the small cell radio station 12 and a section between the terminal 11 and the macro cell radio station 13, for example. The radio transmission management control device 40 includes a control unit 41. The control unit 41 includes a sleep control unit 411. The sleep control unit 411 performs the processing similar to that of the sleep control unit 232 included in the management control device 20.

The real-time analysis unit 222 of the optical transmission management control device 30 transmits the control information including information indicating the radio station and the central station which become the sleep control targets to the radio transmission management control device 40. The radio transmission management control device 40 causes the radio station and the central station which become the sleep control targets to execute the sleep or release the sleep on the basis of the control information transmitted from the optical transmission management control device 30.

By being configured in this way, different types of processing such as optical path switching and sleep control can be performed by a plurality of devices. By doing this, it is possible to reduce processing to be performed by one device.

### Modification Example 2 in First Embodiment

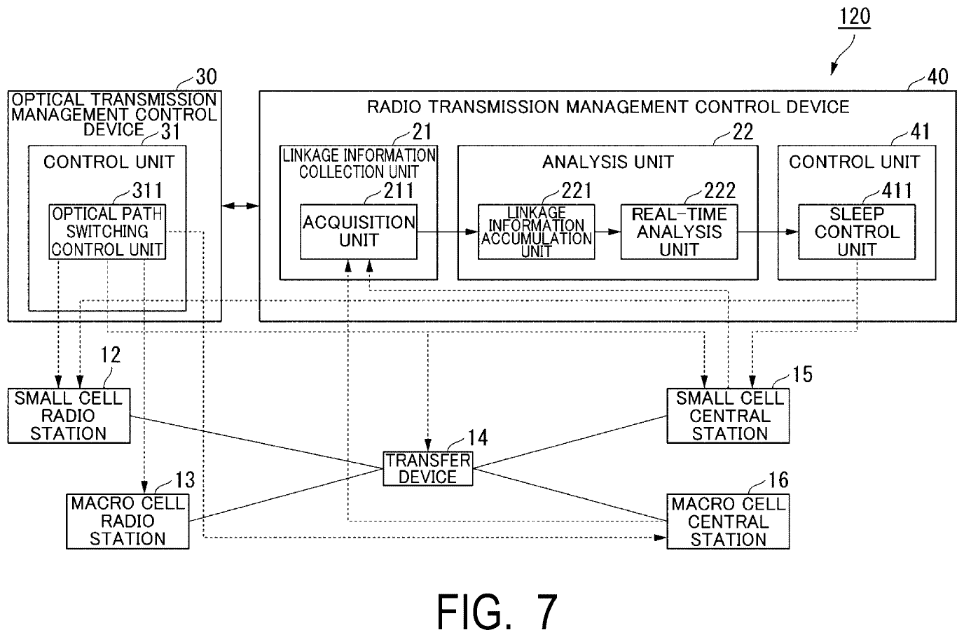

The above-described embodiment shows a configuration in which the management control device 20 performs the optical path switching control processing and the sleep control processing. The optical path switching control processing and the sleep control processing may be performed in different devices. FIG. 7 is a diagram showing a configuration example of a mobile NW system 120 according to a modification example 2 of the first embodiment. The mobile NW system 120 includes one or more small cell radio stations 12, one or more macro cell radio stations 13, a transfer device 14, one or more small cell central stations 15, one or more macro cell central stations 16, an optical transmission management control device 30, and a radio transmission management control device 40. As shown in FIG. 7, the mobile NW system 120 includes the optical transmission management control device 30 and the radio transmission management control device 40 in place of the management control device 20.

The optical transmission management control device 30 controls the optical transmission section. The optical transmission management control device 30 includes a control unit 31. The control unit 31 includes an optical path switching control unit 311. The optical path switching control unit 311 performs the processing similar to that of the optical path switching control unit 231 included in the management control device 20.

The radio transmission management control device 40 controls a radio transmission section. The radio transmission management control device 40 includes a linkage information collection unit 21, an analysis unit 22, and a control unit 41. The linkage information collection unit 21 and the analysis unit 22 perform the processing similar to that of the linkage information collection unit 21 and the analysis unit 22 included in the management control device 20. The control unit 41 includes a sleep control unit 411. The sleep control unit 411 performs the processing similar to that of the sleep control unit 232 included in the management control device 20.

The real-time analysis unit 222 of the radio transmission management control device 40 transmits the control information including information indicating the central station which becomes the optical path switching source and information indicating the central station which becomes the optical path switching destination to the optical transmission management control device 30. The optical transmission management control device 30 performs the optical path switching on the basis of the control information transmitted from the radio transmission management control device 40.

By being configured in this way, different types of processing such as optical path switching and sleep control can be performed by a plurality of devices. By doing this, it is possible to reduce processing to be performed by one device.

### Modification Example 3 in First Embodiment

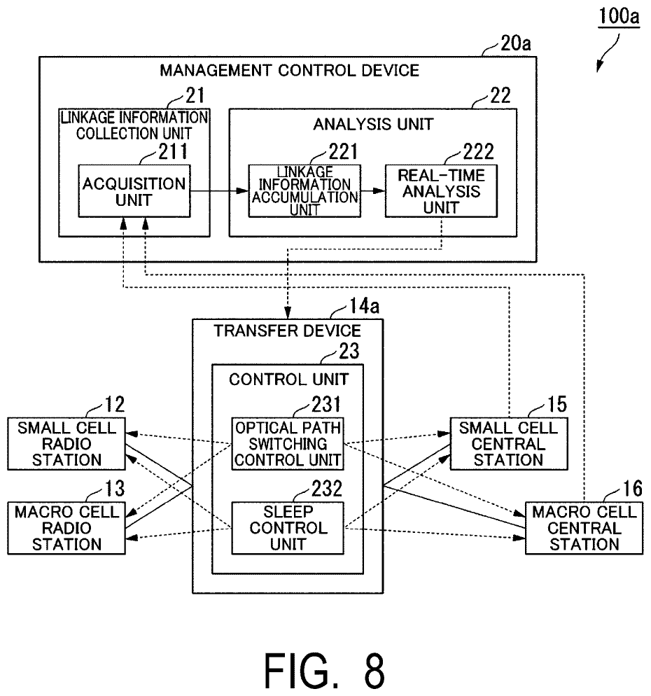

The above-described embodiment shows a configuration in which the management control device 20 performs the optical path switching control processing and the sleep control processing. On the other hand, the transfer device 14 may be configured so as to perform the optical path switching control processing and the sleep control processing. FIG. 8 is a diagram showing a configuration example of a mobile NW system 100a according to a modification example 3 of the first embodiment. The mobile NW system 100a includes one or more small cell radio stations 12, one or more macro cell radio stations 13, a transfer device 14a, one or more small cell central stations 15, one or more macro cell central stations 16, and a management control device 20a.

As shown in FIG. 8, the transfer device 14a includes a control unit 23, and the management control device 20a does not include the control unit 23. The real-time analysis unit 222 of the management control device 20a notifies the transfer device 14a of the control information. Note that the real-time analysis unit 222 may notify the transfer device 14a of the control information only when the optical path switching and the sleep control are performed. The control unit 23 of the transfer device 14a performs the optical path switching control processing and the sleep control processing on the basis of the control information notified from the management control device 20a.

### Second Embodiment

In the first embodiment, the configuration in which the optical path between the small cell radio station 12 and the small cell central station 15 is switched to the optical path between the macro cell radio station 13 and the macro cell central station 16 is described. In a second embodiment, a configuration in which the optical path between the macro cell radio station 13 and the macro cell central station 16 is switched to the optical path between the small cell radio station 12 and the small cell central station 15 will be described. Note that, in the configuration of the second embodiment, it is assumed that a plurality of small cell radio stations 12 are arranged so as to cover a range of the macro cell radio stations 13 without interfering with each other.

### Outline of Second Embodiment

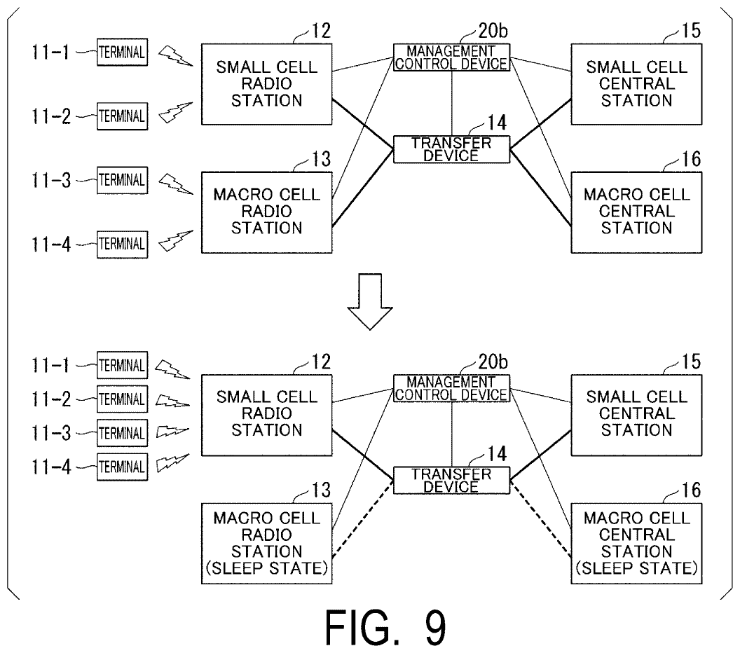

FIG. 9 is a diagram for explaining an outline of processing of a mobile NW system according to the second embodiment. First, an entire configuration of the mobile NW system according to the second embodiment will be described. The mobile NW system according to the second embodiment is one example of the communication system. The mobile NW system according to the second embodiment is 5G, for example. The mobile NW system according to the second embodiment includes one or more small cell radio stations 12, one or more macro cell radio stations 13, a transfer device 14, one or more small cell central stations 15, one or more macro cell central stations 16, and a management control device 20b.

The mobile NW system according to the second embodiment is similar to the first embodiment in terms of the number and the connection relation of devices except for the processing performed by the management control device 20b. Therefore, the following description will focus on differences from the first embodiment. An upper figure in FIG. 9 represents a connection state of the mobile NW system before the optical path switching, and a lower figure in FIG. 9 represents the connection state of the mobile NW system after the optical path switching. The upper figure in FIG. 9 shows an example in which the terminals 11-1 and 11-2 are connected to the small cell radio station 12, the small cell radio station 12 is connected to the small cell central station 15 through the transfer device 14, the terminals 11-3 and 11-4 are connected to the macro cell radio station 13, and the macro cell radio station 13 is connected to the macro cell central station 16 through the transfer device 14.

The management control device 20b judges whether or not the optical path switching control processing is performed on the basis of the linkage information collected from each central station. The management control device 20b compares the switching determination threshold value held in advance with the traffic amount indicated by the traffic information included in the collected linkage information. In the second embodiment, when the traffic amount flowing to the macro cell central station 16 is small, the macro cell central station 16 and the macro cell radio station 13 connected to the macro cell central station 16 are shifted to the sleep state, and the optical path between the macro cell radio station 13 and the macro cell central station 16 is switched to the optical path between the small cell radio station 12 and the small cell central station 15. By doing this, the power consumption in the macro cell central station 16 with a flowing small traffic amount and in the macro cell radio station 13 connected to the macro cell central station 16 can be suppressed.

When the switching determination threshold value is larger than the traffic amount of the macro cell central station 16, the management control device 20b judges that the optical path switching control processing is performed. When the switching determination threshold value is larger than the traffic amount of the macro cell central station 16, it means that the traffic amount flowing to the macro cell central station 16 is small. On the other hand, when the switching determination threshold value is equal to or less than the traffic amount of the macro cell central station 16, the management control device 20b judges that the optical path switching control processing is not performed. When the switching determination threshold value is equal to or less than the traffic amount of the macro cell central station 16, it means that the traffic amount flowing to the macro cell central station 16 is large.

When it is judged that the optical path switching control processing is performed, the management control device 20b transmits information on the optical path switching destination to the transfer device 14, and instructs the optical path switching to the radio station and the central station which become the optical path switching targets. Note that since the connection destination of the terminal 11 is changed by the optical path switching, the management control device 20b may instruct the central station which becomes the optical path switching target to change the connections. The transfer device 14 switches the optical paths between the radio station and the central station in accordance with an instruction from the management control device 20b. The transfer device 14 notifies the management control device 20b of the optical path switching completion after the optical path switching is completed. The radio station and the central station which become the optical path switching targets perform the optical path switching in accordance with the instruction from the management control device 20b.

When the optical path switching control processing is completed, the management control device 20b transmits the sleep permission notification to the radio station and the central station which become the targets to be shifted to the sleep state. By doing this, the radio station and the central station which become the target to be shifted to the sleep state shift to the sleep state.

The lower figure of FIG. 1 shows an example in which the terminals 11-1 to 11-4 are connected to the small cell radio station 12 and the macro cell radio station 13 and the macro cell central station 16 are shifted to the sleep state. In this way, in the mobile NW system according to the second embodiment, the optical path between the macro cell central station 16 with a small traffic amount and the macro cell radio station 13 connected to the macro cell central station 16 is switched to the optical path between the small cell radio station 12 and the small cell central station 15 on the basis of the linkage information collected from each central station. Then, the unused macro cell central station 16 and macro cell radio station 13 connected to the macro cell central station 16 are shifted to the sleep state.

### Detail of Second Embodiment

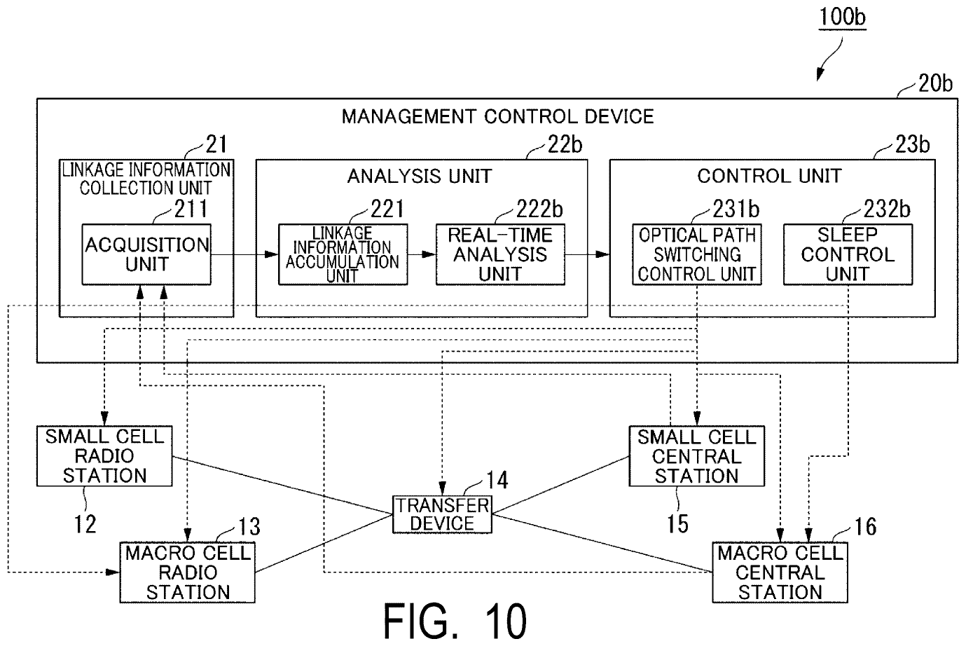

FIG. 10 is a diagram showing a configuration example of a mobile NW system 100b according to the second embodiment. The mobile NW system 100b according to the second embodiment includes one or more small cell radio stations 12, one or more macro cell radio stations 13, a transfer device 14, one or more small cell central stations 15, one or more macro cell central stations 16, and a management control device 20b. In the following description, a case in which the mobile NW system 100b includes one small cell radio station 12, one macro cell radio station 13, one small cell central station 15, and one macro cell central station 16 will be described as an example. Note that since configurations of the small cell radio station 12, the macro cell radio station 13, the transfer device 14, the small cell central station 15, and the macro cell central station 16 are similar to those in the first embodiment, description thereof will be omitted. The management control device 20b includes a linkage information collection unit 21, an analysis unit 22b, and a control unit 23b.

The analysis unit 22b includes a linkage information accumulation unit 221 and a real-time analysis unit 222b. The real-time analysis unit 222b analyzes the communication state between each central station and the terminal 11 on the basis of the linkage information. Specifically, the real-time analysis unit 222b determines whether or not the optical path switching and the sleep control are necessary on the basis of the linkage information.

When determining whether or not the optical path switching and the sleep control are necessary, the real-time analysis unit 222b compares the switching determination threshold value held in advance with the traffic amount indicated by the traffic information included in the collected linkage information. The real-time analysis unit 222b holds the switching determination threshold value for each central station. That is, the real-time analysis unit 222b holds the switching determination threshold value for the small cell central station 15 and the switching determination threshold value for the macro cell central station 16.

Note that when a plurality of small cell central stations 15 is provided, the real-time analysis unit 222b may hold the switching determination threshold values different for each small cell central station 15, or may hold one switching determination threshold value common to all the small cell central stations 15. Similarly, when a plurality of macro cell central stations 16 is provided, the real-time analysis unit 222b may hold the switching determination threshold values different for each macro cell central station 16, or may hold one switching determination threshold value common to all the macro cell central stations 16.

The real-time analysis unit 222b judges whether or not a second switching condition is satisfied as a result of the comparison. The second switching condition is a condition indicating that the optical path switching between the macro cell radio station 13 and the macro cell central station 16 is necessary. The second switching condition is that the switching determination threshold value for the macro cell central station 16 is larger than the traffic amount obtained from the macro cell central station 16, and the switching determination threshold value for the small cell central station 15 is larger than the traffic amount obtained from the small cell central station 15, for example.

When the second switching condition is satisfied, the real-time analysis unit 222b judges that the optical path switching control processing is performed. On the other hand, when the second switching condition is not satisfied, the management control device 20b judges that the optical path switching control processing is not performed. When it is judged that the optical path switching control processing is performed, the real-time analysis unit 222b notifies the control unit 23b of the control information including information indicating the central station which becomes the optical path switching source, information indicating the central station which becomes the optical path switching destination, and information indicating the radio station and the central station which become the sleep control targets.

Here, in the second embodiment, when the second switching condition is satisfied, the central station which becomes the optical path switching source is the macro cell central station 16 in which the switching determination threshold value for the macro cell central station 16 is larger than the traffic amount. In the second embodiment, when the second switching condition is satisfied, the central station which becomes the optical path switching destination is the small cell central station 15 in which the switching determination threshold value for the small cell central station 15 is larger than the traffic amount. In the second embodiment, when the second switching condition is satisfied, the radio station and the central station which become the sleep control targets are the macro cell central station 16 and the macro cell radio station 13 connected to the macro cell central station 16 which become the optical path switching sources. In this way, the real-time analysis unit 222b switches the optical path of the macro cell central station 16 with small flowing traffic to the small cell central station 15 with small flowing traffic.

Further, the real-time analysis unit 222b judges whether or not the second sleep release condition is satisfied as a result of the comparison. The second sleep release condition is a condition indicating that the sleep of the sleeping radio station and central station is released. The second sleep release condition is that the traffic amount of the small cell central station 15 is larger than the switching determination threshold value for the small cell central station 15, for example.

When the second sleep release condition is satisfied, the real-time analysis unit 222b judges that the optical path switching control processing is performed. On the other hand, when the second sleep release condition is not satisfied, the real-time analysis unit 222b judges that the optical path switching control processing is not performed. When it is judged that the optical path switching control processing is performed, the real-time analysis unit 222b notifies the control unit 23b of the control information including information indicating the central station which becomes the optical path switching source, information indicating the central station which becomes the optical path switching destination, and information indicating the radio station and the central station which become the sleep control targets.

Here, in the second embodiment, when the second sleep release condition is satisfied, the central station which becomes the optical path switching source is the small cell central station 15 in which the traffic amount is larger than the switching determination threshold value for the small cell central station 15. In the second embodiment, when the second sleep release condition is satisfied, the central station which becomes the optical path switching destination is the sleeping macro cell central station 16. In the second embodiment, when the second sleep release condition is satisfied, the radio station and the central station which become the sleep control targets are the sleeping macro cell central station 16 and macro cell radio station 13 connected to the macro cell central station 16. By doing this, when traffic flowing to the small cell central station 15 increases after the second switching condition is satisfied and the optical path switching is performed, the real-time analysis unit 222b switches the optical of the small cell central station 15 in which the flowing traffic increases to the macro cell central station 16 in which the sleep release has been performed.

The control unit 23a includes an optical path switching control unit 231b and a sleep control unit 232b. The optical path switching control unit 231b determines the radio station and the central station which become the optical path switching sources and the radio station and the central station which become the optical path switching destinations on the basis of the analysis result of the real-time analysis unit 222b. For example, the optical path switching control unit 231b determines the radio station and the central station which become the optical path switching sources on the basis of information indicating the central station which becomes the optical path switching source included in the control information notified from the real-time analysis unit 222b. For example, the optical path switching control unit 231b determines the radio station and the central station which become the optical path switching destinations on the basis of information indicating the central station which becomes the optical path switching destination included in the control information notified from the real-time analysis unit 222b. The optical path switching control unit 231b holds information on the radio station connected to the central station.

The optical path switching control unit 231b transmits the switching destination information including information indicating the radio station and the central station which become the determined optical path switching destinations to the transfer device 14. By doing this, the optical path switching control unit 231b instructs the optical path switching to the transfer device 14. Further, the optical path switching control unit 231b transmits the optical path switching instruction to the radio station and the central station which become the determined optical path switching sources.

The sleep control unit 232b causes the radio station and the central station which become the sleep control targets to execute the sleep or release the sleep on the basis of the analysis result of the real-time analysis unit 222b.

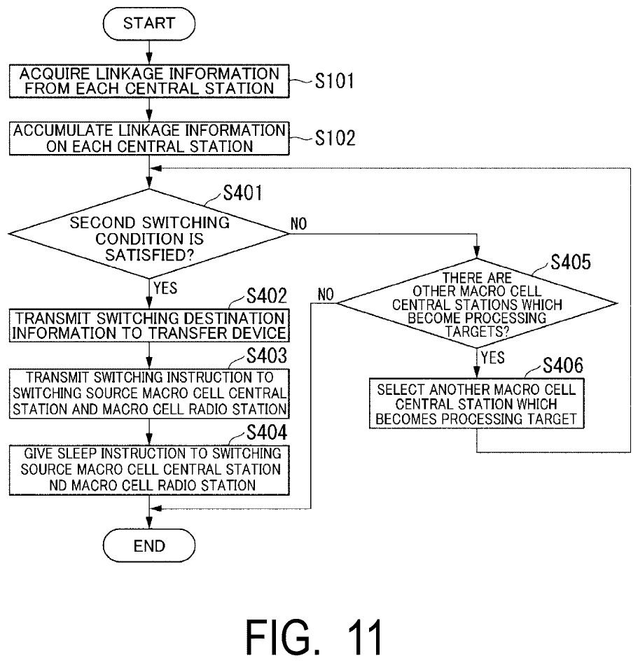

FIG. 11 is a flowchart showing one example of a flow of sleep processing executed by the management control device 20b according to the second embodiment. The flow of the processing in FIG. 11 is repeatedly executed with a predetermined period. In FIG. 11, processing similar to that shown in FIG. 3 is designated by the same reference signs as those in FIG. 3 and description thereof will be omitted.

After processing in the step S102, the real-time analysis unit 222b judges whether or not the second switching condition is satisfied on the basis of the linkage information on each central station accumulated in the linkage information accumulation unit 221 and the switching determination threshold value held in advance (step S401).

When it is judged that the second switching condition is satisfied (step S401—YES), the real-time analysis unit 222b notifies the control unit 23b of the control information. The optical path switching control unit 231b determines the radio station and the central station which become the optical path switching destinations on the basis of the control information notified from the real-time analysis unit 222b. Here, it is assumed that the optical path switching control unit 231b determines the small cell radio station 12 and the small cell central station 15 as the optical path switching destinations. The optical path switching control unit 231b transmits the switching destination information including information indicating the small cell radio station 12 and the small cell central station 15 which become the determined optical path switching destinations to the transfer device 14 (step S402). By doing this, the optical path switching control unit 231b instructs to switch the optical path between the switching source radio station (for example, macro cell radio station 13) and the switching source central station (for example, macro cell central station 16) to the optical path between the small cell radio station 12 and the small cell central station 15.

Further, the optical path switching control unit 231b determines the radio station and the central station which become the optical path switching sources on the basis of the control information notified from the real-time analysis unit 222b. Here, it is assumed that the optical path switching control unit 231b determines the macro cell radio station 13 and the macro cell central station 16 as the optical path switching sources. The optical path switching control unit 231b transmits the optical path switching instruction to the macro cell radio station 13 and the macro cell central station 16 which become the determined optical path switching sources (step S403). By doing this, the optical path switching control unit 231b controls the optical path between the switching source radio station (for example, macro cell radio station 13) and the switching source central station (for example, macro cell central station 16).

The sleep control unit 232b determines the radio station and the central station which become the sleep control targets on the basis of the control information notified from the real-time analysis unit 222b. Here, the sleep control unit 232b determines the macro cell radio station 13 and the macro cell central station 16 as the sleep control targets. The sleep control unit 232b transmits the sleep permission notification to the determined macro cell radio station 13 and macro cell central station 16 (step S404). For example, when the optical path switching completion notification is obtained from each of the macro cell radio station 13 and the macro cell central station 16, the sleep control unit 232b may transmit the sleep permission notification. By doing this, the macro cell radio station 13 and the macro cell central station 16 can be shifted to the sleep state.

In the processing of the step S401, when it is judged that the second switching condition is not satisfied (step S401—NO), the real-time analysis unit 222b judges whether or not there are other macro cell central stations 16 which become the processing targets (step S405). Other macro cell central stations 16 which become the processing targets are the macro cell central stations 16 which are not judged by the second switching condition, for example. When it is judged that there are no other macro cell central stations 16 which become processing targets (step S405—NO), the real-time analysis unit 222b terminates the processing.

On the other hand, when it is judged that there are other macro cell central stations 16 which become the processing targets (step S405—YES), the real-time analysis unit 222b selects one macro cell central station 16 from other macro cell central stations 16 which become the processing targets (step S406). Thereafter, the real-time analysis unit 222b executes the processing of the step S401 again by using the linkage information obtained from the selected macro cell central station 16.

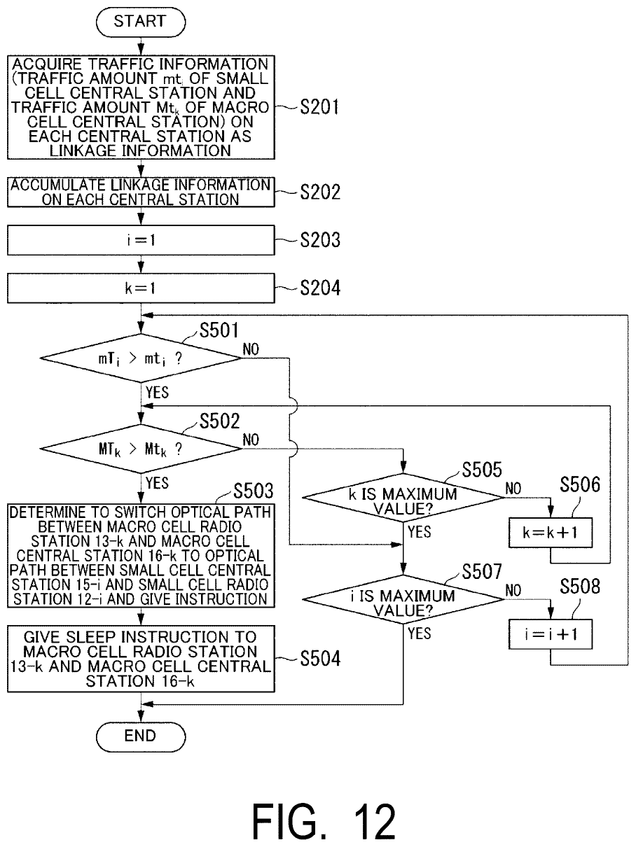

FIG. 12 is a flowchart showing one example of a flow of sleep processing executed by the management control device 20b according to the second embodiment. Note that the processing shown in FIG. 12 will describe the contents in which the processing shown in FIG. 11 is more specifically shown. In FIG. 12, processing similar to that shown in FIG. 4 is designated by the same reference signs as those in FIG. 4 and description thereof will be omitted.

After the processing of the step S204, the real-time analysis unit 222b judges whether or not the switching determination threshold value mTᵢ for the small cell central station 15-i is larger than the traffic amount mtᵢ of the small cell central station 15-i on the basis of the linkage information (for example, traffic amount mtᵢ of the small cell central station 15-i) on the small cell central station 15-i accumulated in the linkage information accumulation unit 221 (step S501). When the constant i=1 is satisfied, the real-time analysis unit 222b judges whether or not the switching determination threshold value mT₁ for the small cell central station 15-1 is larger than the traffic amount mt of the small cell central station 15-1.

When it is judged that the switching determination threshold value mTᵢ for the small cell central station 15-i is larger than the traffic amount mtᵢ of the small cell central station 15-i (step S501—YES), the real-time analysis unit 222b judges whether or not the switching determination threshold value MTₖ for the macro cell central station 16-k is larger than the traffic amount Mtₖ of the macro cell central station 16-k (step S502). When the constant k=1 is satisfied, the real-time analysis unit 222b judges whether or not the switching determination threshold value MT₁ for the macro cell central station 16-1 is larger than the traffic amount Mt₁ of the macro cell central station 16-1. The conditions indicated in the step S501 and the step S502 are specific examples of the second switching condition.

When it is judged that the switching determination threshold value MTₖ for the macro cell central station 16-k is larger than the traffic amount Mtₖ of the macro cell central station 16-k (step S502—YES), the real-time analysis unit 222b judges that the second switching condition is satisfied. In this case, the real-time analysis unit 222b notifies the control unit 23b of the control information including information indicating the macro cell central station 16-k which become the optical path switching source, information indicating the small cell central station 15-i which becomes the optical path switching destination, and information indicating the macro cell radio station 13-k connected to the macro cell central station 16-k and the macro cell central station 16-k which become the sleep control targets.

The optical path switching control unit 231b determines the radio station and the central station which become the optical path switching sources and the radio station and the central station which become the optical path switching destinations on the basis of the control information notified from the real-time analysis unit 222b. By doing this, the optical path switching control unit 231b determines to switch the optical path between the macro cell radio station 13-k and the macro cell central station 16-k to the optical path between the small cell central station 15-i and the small cell radio station 12-i. The optical path switching control unit 231b transmits the switching destination information including information indicating the small cell central station 15-i and the small cell radio station 12-i which become the determined optical path switching destinations to the transfer device 14. Further, the optical path switching control unit 231b transmits the optical path switching instruction to the macro cell radio station 13-k and the macro cell central station 16-k which become the determined optical path switching sources (step S503).

The sleep control unit 232b determines the macro cell radio station 13-k and the macro cell central station 16-k which become the sleep control targets on the basis of the control information notified from the real-time analysis unit 222b. The sleep control unit 232b transmits the sleep permission notification to the determined macro cell radio station 13-k and macro cell central station 16-k (step S504).

In the processing of the step S502, when it is judged that the switching determination threshold value MTₖ for the macro cell central station 16-k is not larger than the traffic amount Mtₖ of the macro cell central station 16-k (step S502—NO), the real-time analysis unit 222b judges that the second switching condition is not satisfied. In this case, the real-time analysis unit 222b judges whether or not the constant k is the maximum value (step S505). When it is judged that the constant k is not the maximum value (step S505—NO), the real-time analysis unit 222b adds a value of 1 to a value of the constant k (step S506). Thereafter, the real-time analysis unit 222b executes the processing of step S502 again.

On the other hand, when it is judged that the constant k is the maximum value (step S506—YES), the real-time analysis unit 222b judges whether or not the constant i is the maximum value (step S507). When it is judged that the constant i is not the maximum value (step S507—NO), the real-time analysis unit 222b adds a value of 1 to a value of the constant i (step S508). Thereafter, the real-time analysis unit 222b executes the processing of step S501 again. On the other hand, when it is judged that the constant i is the maximum value (step S507—YES), the real-time analysis unit 222b terminates the processing.

In the processing of the step S501, when it is judged that the switching determination threshold value mTᵢ for the small cell central station 15-i is not larger than the traffic amount mtᵢ of the small cell central station 15-i (step S501—NO), the real-time analysis unit 222b performs the processing of the step S507.

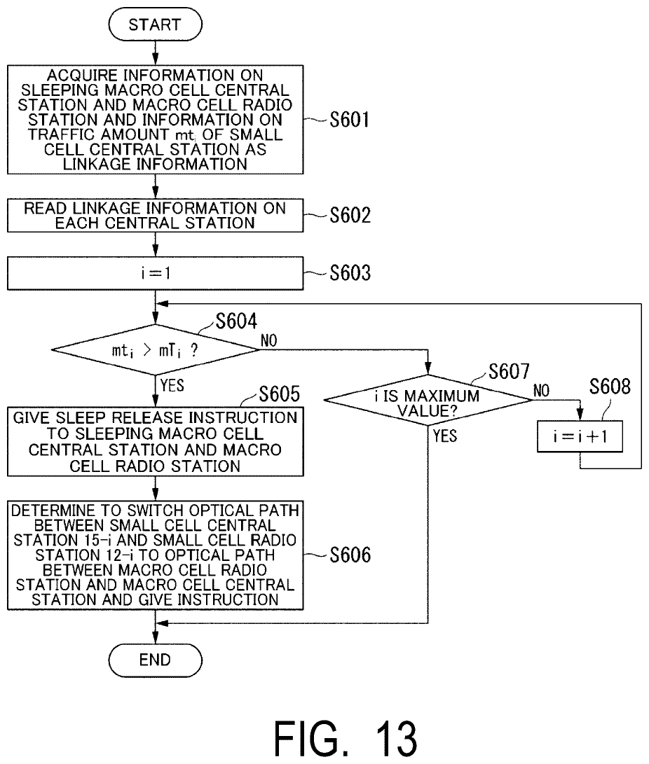

FIG. 13 is a flowchart showing one example of a flow of sleep release processing executed by the management control device 20b according to the second embodiment. The acquisition unit 211 acquires the traffic information indicating the traffic amount mtᵢ of the small cell central station 15-i from each small cell central station 15-i as the linkage information, and acquires information indicating the sleeping macro cell central station 16-k and macro cell radio station 13-k as the linkage information (step S601). The acquisition unit 211 accumulates the traffic information indicating the acquired traffic amount mtᵢ and information indicating the sleeping macro cell central station 16-k and macro cell radio station 13-k in the linkage information accumulation unit 221.

The real-time analysis unit 222b reads the linkage information from the linkage information accumulation unit 221 (step S602). The real-time analysis unit 222b substitutes a value of 1 to the constant i (step S603). The real-time analysis unit 222b judges whether or not the traffic amount mtᵢ of the small cell central station 15-i is larger than the switching determination threshold value mTᵢ for the small cell central station 15-i (step S604). The condition represented by mtᵢ>mTᵢ is a specific example of the second sleep release condition.

When it is judged that the traffic amount mtᵢ of the small cell central station 15-i is larger than the switching determination threshold value mTᵢ for the small cell central station 15-i (step S604—YES), the real-time analysis unit 222b judges that the second sleep release condition is satisfied. In this case, the real-time analysis unit 222b notifies the control unit 23b of the control information including information indicating the small cell central station 15-i which becomes the optical path switching source, the macro cell central station 16-k which becomes the optical path switching destination, and information indicating the macro cell radio station 13-k connected to the macro cell central station 16-k and the macro cell central station 16-k which become the sleep control targets.

The sleep control unit 232b transmits the sleep release instruction to the sleeping macro cell central station 16-k and macro cell radio station 13-k on the basis of the control information notified from the real-time analysis unit 222b (step S605). By doing this, the macro cell central station 16-k and the macro cell radio station 13-k are released from the sleep state.

The optical path switching control unit 231b determines the radio station and the central station which become the optical path switching sources and the radio station and the central station which become the optical path switching destinations on the basis of the control information notified from the real-time analysis unit 222b. By doing this, the optical path switching control unit 231b determines to switch the optical path between the small cell central station 15-i and the small cell radio station 12-i to the optical path between the macro cell radio station 13-k and the macro cell central station 16-k. The optical path switching control unit 231b transmits the switching destination information including information indicating the macro cell radio station 13-k and the macro cell central station 16-k which become the determined optical path switching destinations to the transfer device 14. Further, the optical path switching control unit 231b transmits the optical path switching instruction to the small cell radio station 12-i and the small cell central station 15-i which become the determined optical path switching sources (step S606). Since the connections of the terminals are changed by the optical path switching, the optical path switching control unit 231b may instruct the small cell central station 15-i to change the connections of the terminals 11.

In the processing of the step S604, when it is judged that the traffic amount mtᵢ of the small cell central station 15-i is not larger than the switching determination threshold value mTᵢ for the small cell central station 15-i (step S604—NO), the real-time analysis unit 222b judges that the second sleep release condition is not satisfied. In this case, the real-time analysis unit 222b judges whether or not the constant i is the maximum value (step S607).

When it is judged that the constant i is not the maximum value (step S607—NO), the real-time analysis unit 222b adds a value of 1 to a value of the constant i (step S608). Thereafter, the real-time analysis unit 222b executes the processing of step S604 again. On the other hand, when it is judged that the constant i is the maximum value (step S607—YES), the real-time analysis unit 222b terminates the processing.

In the mobile NW system 100b configured as described above, the management control device 20b includes the linkage information collection unit 21 that acquires the linkage information from each of the small cell central station 15 and the macro cell central station 16 at a predetermined period or at arbitrary timing, the analysis unit 22b that determines whether or not the optical path switching is necessary on the basis of the linkage information, the optical path switching control unit 231b that controls the optical path switching between the macro cell radio station 13 and the macro cell central station 16 when it is determined that the optical path switching is necessary, and the sleep control unit 232b that shifts the macro cell radio station 13 and the macro cell central station 16 in which the optical path switching is performed to the sleep state after the optical path switching is performed. By doing this, the macro cell radio station 13 and the macro cell central station 16 which become unconnected can be shifted to the sleep state. Therefore, it is possible to suppress the power consumption.

When the traffic amount obtained from the macro cell central station 16 is smaller than the threshold value, the management control device 20b controls so as to switch the optical path between the macro cell radio station 13 and the macro cell central station 16 to the optical path between the small cell radio station 12 and the small cell central station 15, and shifts the macro cell radio station 13 and the macro cell central station 16 to the sleep state after the optical path switching is performed. By doing this, the macro cell radio station 13 with the small traffic amount and the macro cell central station 16 can be shifted to the sleep state. Therefore, it is possible to suppress the power consumption.

### Modification Example 1 in Second Embodiment

The mobile NW system 100b may be modified as shown in the modification example 1 in the first embodiment and the modification example 2 in the first embodiment.

### Modification Example 2 in Second Embodiment

The mobile NW system 100b may be configured such that the transfer device 14 performs the optical path switching control processing and the sleep control processing as shown in the modification example 3 in the first embodiment.

### Third Embodiment

In a third embodiment, a configuration including a small cell base station in which a small cell radio station, a small cell distribution station, and an aggregation station are integrated, and a macro cell base station in which a macro cell radio station, a macro cell distribution station, and an aggregation station are integrated will be described.

### Outline of Third Embodiment

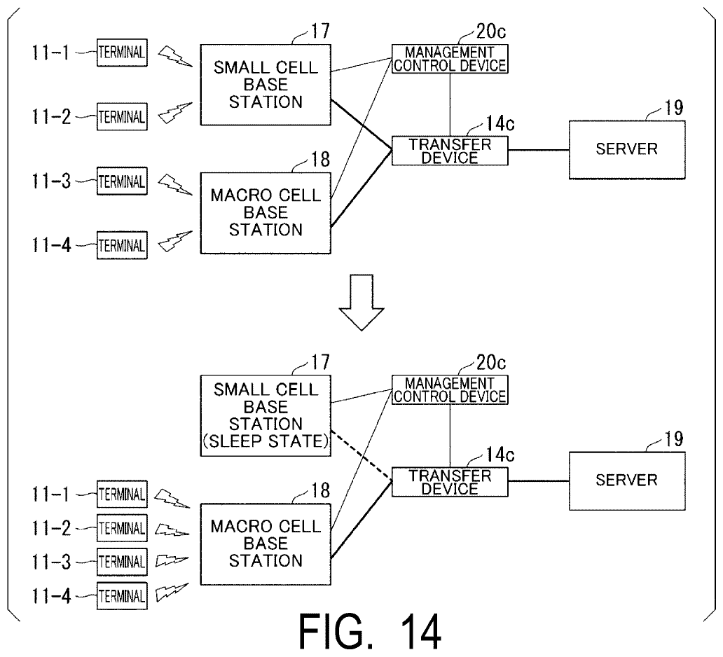

FIG. 14 is a diagram for explaining an outline of processing of a mobile NW system according to the third embodiment. First, an entire configuration of the mobile NW system according to the third embodiment will be described. The mobile NW system according to the third embodiment is one example of the communication system. The mobile NW system according to the third embodiment is 5G, for example. The mobile NW system according to the third embodiment includes a transfer device 14c, one or more small cell base stations 17, one or more macro cell base stations 18, one or more servers 19, and a management control device 20c.

The small cell base station 17 and the transfer device 14c, the macro cell base station 18 and the transfer device 14c, and the transfer device 14c and the server 19 are connected by the optical fibers for transmitting the optical signals. The transfer device 14c and the management control device 20c, the small cell base station 17 and the management control device 20c, and the macro cell base station 18 and the management control device 20c are connected by the optical fibers or the electric lines for transmitting the electric signals.

In an example shown in FIG. 14, the small cell base station 17, the macro cell base station 18, and the server 19 are each one. Note that a plurality of transfer devices 14c may be provided, the following explanation will be given by taking a case of one transfer device as an example. In the following description, in a case where the small cell base station 17 and the macro cell base station 18 are not particularly distinguished, they are described as the base station.

The base station is a device in which the radio station, the distribution station, and the aggregation station are integrated. For example, the small cell base station 17 is a device in which the small cell radio station 12, the small cell central station 15, and the aggregation station are integrated. For example, the macro cell base station 18 is a device in which the macro cell radio station 13, the macro cell central station 16, and the aggregation station are integrated.

The small cell base station 17 transmits the signal transmitted from the terminal 11 to the server 19 through the transfer device 14c. The small cell base station 17 transmits the linkage information to the management control device 20c. The small cell base station 17 transmits the signal received through the transfer device 14c to the terminal 11. The small cell base station 17 shifts to the sleep state in accordance with the sleep instruction transmitted from the management control device 20c. Further, the small cell base station 17 performs the optical path switching in accordance with the optical path switching instruction transmitted from the management control device 20c. When receiving the optical path switching instruction, the small cell base station 17 does not set the optical path with the transfer device 14c. The fact that the optical path is not set in the small cell base station 17 means that the route from the small cell base station 17 to the transfer device 14c is not irradiated with light.

The macro cell base station 18 transmits the signal transmitted from the terminal 11 to the server 19 through the transfer device 14c. The macro cell base station 18 transmits the linkage information to the management control device 20c. The macro cell base station 18 transmits the signal received through the transfer device 14c to the terminal 11.

The transfer device 14c is provided between the base station and the server 19. The transfer device 14c performs the optical path switching in accordance with the optical path switching destination information transmitted from the management control device 20c. The transfer device 14c switches the connections between the base station and the server 19 by switching the optical paths. For example, when receiving the optical path switching destination information transmitted from the management control device 20c, the transfer device 14c instructs the switching so that the optical path is connected between the base station which becomes the optical path switching destination and the server 19.

The linkage information in the third embodiment includes the traffic amount information on each base station, for example. Note that the traffic information is described in DCI or O-RAN CTI, for example. In O-RAN CTI, it is intended to be schedule information.

The management control device 20c acquires the linkage information from each base station. The management control device 20c determines whether or not the optical path switching and the sleep control are necessary on the basis of the acquired linkage information. When it is determined that the optical path switching and the sleep control are necessary, the management control device 20c performs the optical path switching control processing and the sleep control processing.

Next, an outline of processing of the mobile NW system will be described.

An upper figure in FIG. 14 represents a connection state of the mobile NW system before the optical path switching, and a lower figure in FIG. 14 represents the connection state of the mobile NW system after the optical path switching. The upper figure in FIG. 14 shows an example in which the terminals 11-1 and 11-2 are connected to the small cell base station 17, the small cell base station 17 is connected to the server 19 through the transfer device 14c, the terminals 11-3 and 11-4 are connected to the macro cell base station 18, and the macro cell base station 18 is connected to the server 19 through the transfer device 14c.

The management control device 20c judges whether or not to the optical path switching control processing is performed on the basis of the linkage information collected from each base station. The management control device 20c compares the switching determination threshold value held in advance with the traffic amount indicated by the traffic information included in the collected linkage information. In the third embodiment, when the traffic amount flowing to the small cell base station 17 is small, the small cell base station 17 is shifted to the sleep state, and the optical path between the small cell base station 17 and the transfer device 14c is switched to the optical path between the macro cell base station 18 and the transfer device 14c. By doing this, it is possible to suppress the power consumption in the small cell base station 17 with the flowing small traffic amount.

When the switching determination threshold value is larger than the traffic amount of the small cell base station 17, the management control device 20c judges that the optical path switching control processing is performed. When the switching determination threshold value is larger than the traffic amount of the small cell base station 17, it means that the traffic amount flowing to the small cell base station 17 is small. On the other hand, when the switching determination threshold value is equal to or less than the traffic amount of the small cell base station 17, the management control device 20c judges that the optical path switching control processing is not performed. When the switching determination threshold value is equal to or less than the traffic amount of the small cell base station 17, it means that the traffic amount flowing to the small cell base station 17 is large.

When it is judged that the optical path switching control processing is performed, the management control device 20c transmits information on the optical path switching destination to the transfer device 14c, and instructs the optical path switching to the base station which becomes the optical path switching target. Note that since the connection destinations of the terminals 11 are changed by the optical path switching, the management control device 20c may instruct the base station which becomes the optical path switching target to change the connections. The transfer device 14c switches the optical paths of the base station in accordance with the instruction from the management control device 20c. The transfer device 14c notifies the management control device 20c of the optical path switching completion after the optical path switching is completed. The base station which becomes the optical path switching target performs the optical path switching in accordance with the instruction from the management control device 20c.

When the optical path switching control processing is completed, the management control device 20c transmits the sleep permission notification to the base station which becomes the target to be shifted to the sleep state. By doing this, the base station which becomes the target to be shifted to the sleep state shifts to the sleep state.

The lower figure in FIG. 14 shows an example in which the terminals 11-1 to 11-4 are connected to the macro cell base station 18 and the small cell base station 17 is shifted to the sleep state. In this way, in the mobile NW system according to the third embodiment, the optical path between the small cell base station 17 with the small traffic amount and the transfer device 14c is switched to the optical path between the macro cell base station 18 covering a range larger than that of the small cell and the transfer device 14c on the basis of the linkage information collected from each base station. Then, the unused small cell base station 17 is shifted to the sleep state. Hereinafter, a base station which becomes the optical path switching target may be described as a switching source base station, and a base station which becomes the optical path switching destination may be described as a switching destination base station.

### Detail of Third Embodiment

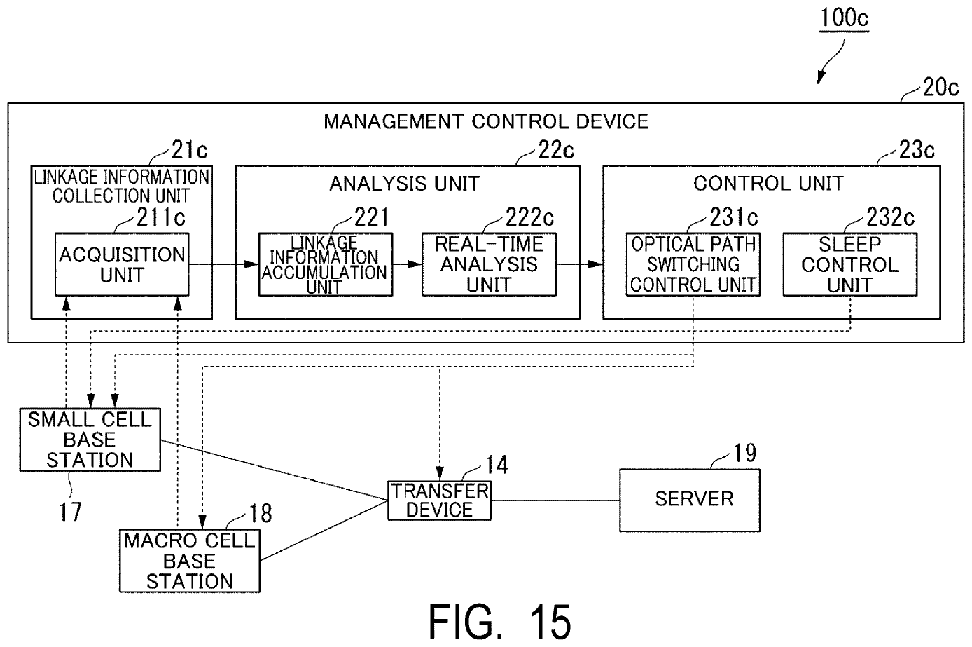

FIG. 15 is a diagram showing a configuration example of a mobile NW system 100c according to a third embodiment. The mobile NW system 100c according to the third embodiment includes a transfer device 14c, one or more small cell base stations 17, one or more macro cell base stations 18, one or more servers 19, and a management control device 20c. In the following description, a case where the mobile NW system 100c includes one small cell base station 17, one macro cell base station 18, and one server 19 will be described. Note that since configurations of the transfer device 14c, the small cell base station 17, the macro cell base station 18, and the server 19 has been described in FIG. 14, the description thereof will be omitted. The management control device 20c includes a linkage information collection unit 21c, an analysis unit 22c, and a control unit 23c.

The linkage information collection unit 21c includes an acquisition unit 211c. The acquisition unit 211c collects the linkage information from each base station at a predetermined period or at arbitrary timing. For example, the acquisition unit 211c collects the traffic information on each base station as the linkage information.

The analysis unit 22c includes a linkage information accumulation unit 221 and a real-time analysis unit 222c. The real-time analysis unit 222c analyzes the communication state between each base station and the terminal 11 on the basis of the linkage information. Specifically, the real-time analysis unit 222c determines whether or not the optical path switching and the sleep control are necessary on the basis of the linkage information.

When determining whether or not the optical path switching and the sleep control are necessary, the real-time analysis unit 222c compares the switching determination threshold value held in advance with the traffic amount indicated by the traffic information included in the collected linkage information. The real-time analysis unit 222c holds the switching determination threshold value for each central station. That is, the real-time analysis unit 222c holds the switching determination threshold value for the small cell base station 17 and the switching determination threshold value for the macro cell base station 18.

Note that when a plurality of small cell base stations 17 is provided, the real-time analysis unit 222c may hold the switching determination threshold values different for each small cell base station 17, or may hold one switching determination threshold value common to all the small cell base stations 17. Similarly, when a plurality of macro cell base stations 18 is provided, the real-time analysis unit 222c may hold the switching determination threshold values different for each macro cell base station 18, or may hold one switching determination threshold value common to all the macro cell base stations 18.

The real-time analysis unit 222c judges whether or not a third switching condition is satisfied as a result of the comparison. The third switching condition is a condition indicating that the optical path switching between the small cell base station 17 and the transfer device 14c is necessary. The third switching condition is that the switching determination threshold value for the small cell base station 17 is larger than the traffic amount obtained from the small cell base station 17, and the switching determination threshold value for the macro cell base station 18 is larger than the traffic amount obtained from the macro cell base station 18, for example.

When the third switching condition is satisfied, the real-time analysis unit 222c judges that the optical path switching control processing is performed. On the other hand, when the third switching condition is not satisfied, the real-time analysis unit 222c judges that the optical path switching control processing is not performed. When it is judged that the optical path switching control processing is performed, the real-time analysis unit 222c notifies the control unit 23c of the control information including information indicating the base station which becomes the optical path switching source, information indicating the base station which becomes the optical path switching destination, and information indicating the base station which becomes the sleep control target.

Here, in the third embodiment, when the third switching condition is satisfied, the base station which becomes the optical path switching source is the small cell base station 17 in which the switching determination threshold value for the small cell base station 17 is larger than the traffic amount. In the third embodiment, when the third switching condition is satisfied, the base station which becomes the optical path switching destination is the macro cell base station 18 in which the switching determination threshold value for the macro cell base station 18 is larger than the traffic amount. In the third embodiment, when the third switching condition is satisfied, the base station which becomes the sleep control target is the small cell base station 17 which becomes the optical path switching source. In this way, the real-time analysis unit 222c switches the optical path of the small cell base station 17 with small flowing traffic to the macro cell base station 18 with small flowing traffic.

Further, the real-time analysis unit 222c judges whether or not the third sleep release condition is satisfied as a result of the comparison. The third sleep release condition is a condition indicating that the sleep of the sleeping base station is released. The third sleep release condition is that the traffic amount of the macro cell base station 18 is larger than the switching determination threshold value for the macro cell base station 18, for example.

When the third sleep release condition is satisfied, the real-time analysis unit 222c judges that the optical path switching control processing is performed. On the other hand, when the third sleep release condition is not satisfied, the real-time analysis unit 222c judges that the optical path switching control processing is not performed. When it is judged that the optical path switching control processing is performed, the real-time analysis unit 222c notifies the control unit 23c of the control information including information indicating the base station which becomes the optical path switching source, information indicating the base station which becomes the optical path switching destination, and information indicating the base station which becomes the sleep control target.

Here, in the third embodiment, when the third sleep release condition is satisfied, the base station which becomes the optical path switching source is the macro cell base station 18 whose traffic amount is larger than the switching determination threshold value for the macro cell base station 18. In the third embodiment, when the third sleep release condition is satisfied, the base station which becomes the optical path switching destination is the sleeping small cell base station 17. In the third embodiment, when the third sleep release condition is satisfied, the base station which becomes the sleep control target is the sleeping small cell base station 17. By doing this, when the traffic flowing to the macro cell base station 18 increases after the third switching condition is satisfied and the optical path switching is performed, the real-time analysis unit 222c switches the optical path of the macro cell base station 18 with large flowing traffic to the small cell base station 17 in which the sleep release has been performed.

The control unit 23c includes an optical path switching control unit 231c and a sleep control unit 232c. The optical path switching control unit 231c determines the base station which becomes the optical path switching source and the base which becomes the optical path switching destination on the basis of the analysis result of the real-time analysis unit 222c. For example, the optical path switching control unit 231c determines the base station which becomes the optical path switching source on the basis of information indicating the base station which becomes the optical path switching source included in the control information notified from the real-time analysis unit 222c. For example, the optical path switching control unit 231c determines the base station which becomes the optical path switching destination on the basis of information indicating the base station which becomes the optical path switching destination included in the control information notified from the real-time analysis unit 222c.

The optical path switching control unit 231c transmits the switching destination information including information indicating the base which becomes the determined optical path switching destination to the transfer device 14c. By doing this, the optical path switching control unit 231c instructs the optical path switching to the transfer device 14c. Further, the optical path switching control unit 231c transmits the optical path switching instruction to the base station which becomes the determined optical path switching source.

The sleep control unit 232c causes the base station which becomes the sleep control target to execute the sleep or release the sleep on the basis of the analysis result of the real-time analysis unit 222c.

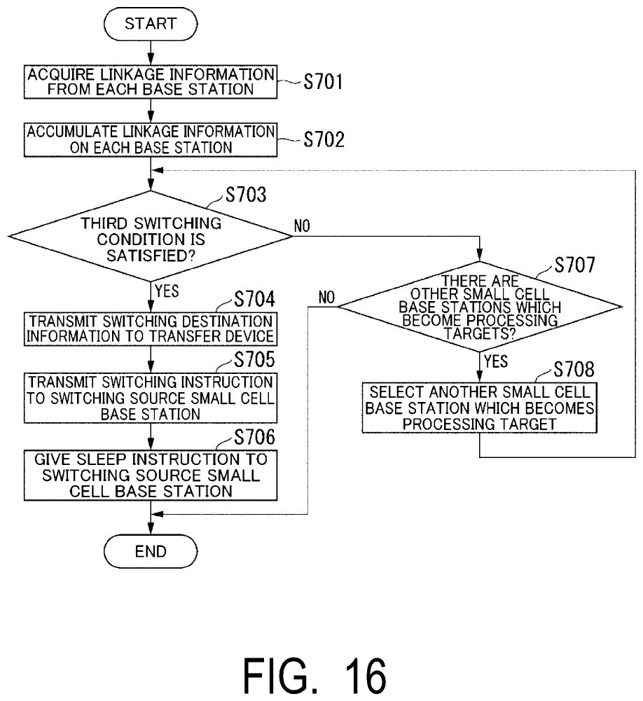

FIG. 16 is a flowchart showing one example of a flow of sleep processing executed by the management control device 20c according to the third embodiment. The flow of the processing in FIG. 16 is repeatedly executed with a predetermined period.

The acquisition unit 211c acquires the linkage information from each base station (Step S701). For example, the acquisition unit 211c acquires the linkage information from each of the small cell base station 17 and the macro cell base station 18. The acquisition unit 211c accumulates the acquired linkage information on each base station in the linkage information accumulation unit 221 (step S702). The real-time analysis unit 222c judges whether or not the third switching condition is satisfied on the basis of the linkage information on each base station accumulated in the linkage information accumulation unit 221 and the switching determination threshold value held in advance (step S703).

When it is judged that the third switching condition is satisfied (step S703—YES), the real-time analysis unit 222c notifies the control unit 23c of the control information. The optical path switching control unit 231c determines the base station which becomes the optical path switching destination on the basis of the control information notified from the real-time analysis unit 222c. Here, it is assumed that the optical path switching control unit 231c determines the macro cell base station 18 as the optical path switching destination. The optical path switching control unit 231c transmits the switching destination information including information indicating the macro cell base station 18 which becomes the determined optical path switching destination to the transfer device 14c (step S704). By doing this, the optical path switching control unit 231c instructs to switch the optical path between the switching source base station (for example, small cell base station 17) and the transfer device 14c to the optical path between the macro cell base station 18 and the transfer device 14c.

Further, the optical path switching control unit 231c determines the base station which becomes the optical path switching source on the basis of the control information notified from the real-time analysis unit 222c. Here, it is assumed that the optical path switching control unit 231c determines the small cell base station 17 as the optical path switching source. The optical path switching control unit 231c transmits the optical path switching instruction to the small cell base station 17 which becomes the determined optical path switching source (step S705). By doing this, the optical path switching control unit 231c controls the optical path between the switching source base station (for example, small cell base station 17) and the transfer device 14c.

The sleep control unit 232c determines the base station which becomes the sleep control target on the basis of the control information notified from the real-time analysis unit 222c. Here, the sleep control unit 232c determines the small cell base station 17 as the sleep control target. The sleep control unit 232c transmits the sleep permission notification to the determined small cell base station 17 (step S706). For example, when the optical path switching completion notification is obtained from the small cell base station 17, the sleep control unit 232c may transmit the sleep permission notification. By doing this, the small cell base station 17 can shift to the sleep state.

In the processing of the step S703, when it is judged that the third switching condition is not satisfied (step S703—NO), the real-time analysis unit 222c judges whether or not there are other small cell base stations 17 which become the processing targets (step S707). Other small cell base stations 17 which become the processing targets are the small cell base stations 17 which have not been judged by the third switching condition, for example. When it is judged that there are no other small cell base stations 17 which become the processing targets (step S707—NO), the real-time analysis unit 222c terminates the processing.

On the other hand, when it is determined that there are other small cell base stations 17 which become the processing targets (step S707—YES), the real-time analysis unit 222c selects one small cell base station 17 from other small cell base stations 17 which become the processing targets (step S708). Thereafter, the real-time analysis unit 222c uses the linkage information obtained from the selected small cell base station 17 to execute the processing of the step S703 again.

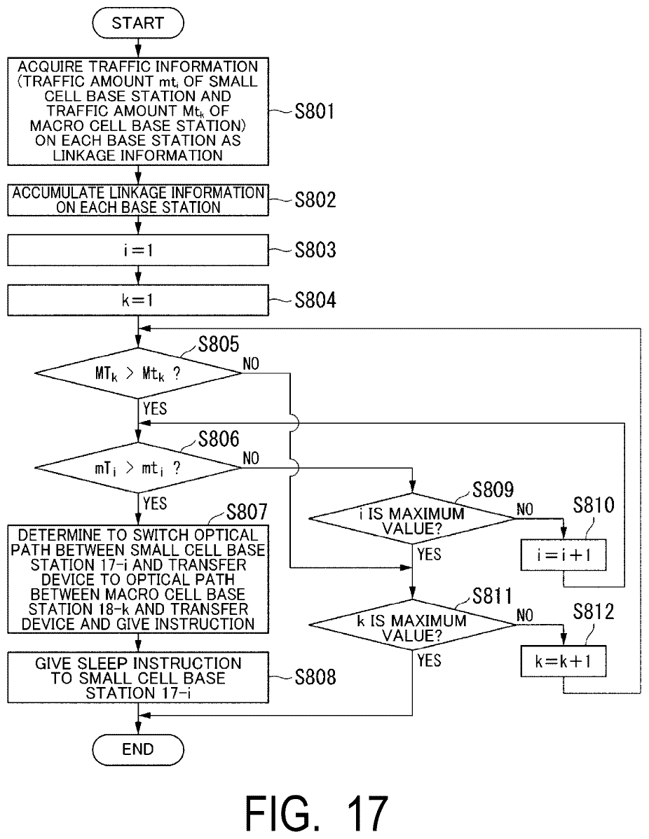

FIG. 17 is a flowchart showing one example of a flow of sleep processing executed by the management control device 20c according to the third embodiment. Note that the processing shown in FIG. 17 will describe the contents in which the processing shown in FIG. 16 is more specifically shown.

The acquisition unit 211c acquires the traffic information indicating the traffic amount mtᵢ of the small cell base station 17-i from the small cell base station 17-i and the traffic information indicating the traffic amount Mtₖ of the macro cell base station 18-k from the macro cell base station 18-k as the linkage information (step S801). In the third embodiment, i represents the small cell base station 17 which becomes the switching source, for example. When i=1 is satisfied, the small cell base station 17-1 becomes the switching source base station. i is a value of 1≤i≤I. In the third embodiment, I is the total number of small cell base stations 17. In the third embodiment, k represents the macro cell base station 18 which becomes the switching destination, for example. When k=1 is satisfied, the macro cell base station 18-1 becomes the switching destination base station. k is a value of 1≤k≤K. In the third embodiment, K is the total number of macro cell base stations 18.

The acquisition unit 211c accumulates the acquired linkage information on each base station in the linkage information accumulation unit 221 (step S802). The real-time analysis unit 222c substitutes a value of 1 to the constant i (step S803). The real-time analysis unit 222c substitutes a value of 1 to the constant k (step S804).

The real-time analysis unit 222c judges whether or not the switching determination threshold value MTₖ for the macro cell base station 18-k is larger than the traffic amount Mtₖ of the macro cell base station 18-k on the basis of the linkage information (for example, traffic amount Mtₖ of the macro cell base station 18-k) on the macro cell base station 18-k accumulated in the linkage information accumulation unit 221 (step S805). When the constant k=1 is satisfied, the real-time analysis unit 222c judges whether or not the switching determination threshold value MT₁ for the macro cell base station 18-1 is larger than the traffic amount Mt₁ of the macro cell base station 18-1.

When it is judged that the switching determination threshold value MTₖ for the macro cell base station 18-k is larger than the traffic amount Mtₖ of the macro cell base station 18-k (step S805—YES), the real-time analysis unit 222c judges whether the switching determination threshold value mTᵢ for the small cell base station 17-i is larger than the traffic amount mtᵢ of the small cell base station 17-i (step S806). When the constant i=1 is satisfied, the real-time analysis unit 222c judges whether or not the switching determination threshold value mT₁ for the small cell base station 17-1 is larger than the traffic amount mtᵢ of the small cell base station 17-1. The conditions indicated in the step S805 and the step S806 are specific examples of the third switching conditions.

When it is judged that the switching determination threshold value mTᵢ for the small cell base station 17-i is larger than the traffic amount mtᵢ of the small cell base station 17-i, the real-time analysis unit 222c judges that the third switching condition is satisfied (step S806—YES). In this case, the real-time analysis unit 222c notifies the control unit 23c of the control information including information indicating the small cell base station 17-i which becomes the optical path switching source, information indicating the macro cell base station 18-k which becomes the optical path switching destination, and information indicating the small cell base station 17 which becomes the sleep control target.

The optical path switching control unit 231c determines the base station which becomes the optical path switching source and the base station which becomes the optical path switching destination on the basis of the control information notified from the real-time analysis unit 222c. By doing this, the optical path switching control unit 231c determines to switch the optical path between the small cell base station 17-i and the transfer device 14c to the optical path between the macro cell base station 18-k and the transfer device 14c. The optical path switching control unit 231c transmits the switching destination information including information indicating the macro cell base station 18-k which becomes the determined optical path switching destination to the transfer device 14c. Further, the optical path switching control unit 231c transmits the optical path switching instruction to the small cell base station 17-i which becomes the determined optical path switching source (step S807).

The sleep control unit 232c determines the small cell base station 17-i which becomes the sleep control target on the basis of the control information notified from the real-time analysis unit 222c. The sleep control unit 232c transmits the sleep permission notification to the determined small cell base station 17-i (step S808).

In the processing of the step S806, when it is judged that the switching determination threshold value mTᵢ for the small cell base station 17-1 is not larger than the traffic amount mtᵢ of the small cell base station 17-i (step S806—NO), the real-time analysis unit 222c judges that the third switching condition is not satisfied. In this case, the real-time analysis unit 222c judges whether or not the constant i is the maximum value (step S809). When it is judged that the constant i is not the maximum value (step S809—NO), the real-time analysis unit 222c adds a value of 1 to a value of the constant i (step S810). Thereafter, the real-time analysis unit 222c executes the processing of step S206 again.

On the other hand, when it is judged that the constant i is the maximum value (step S809—YES), the real-time analysis unit 222c judges whether or not the constant k is the maximum value (step S811). When it is determined that the constant k is not the maximum value (step S811—NO), the real-time analysis unit 222c adds a value of 1 to a value of the constant k (step S812). Thereafter, the real-time analysis unit 222c executes the processing of step S805 again. On the other hand, when it is judged that the constant k is the maximum value (step S811—YES), the real-time analysis unit 222c terminates the processing.

In the processing of the step S805, when it is judged that the switching determination threshold value MTₖ for the macro cell base station 18-k is not larger than the traffic amount Mtₖ of the macro cell base station 18-k (step S805—NO), the real-time analysis unit 222c performs the processing of the step S811.

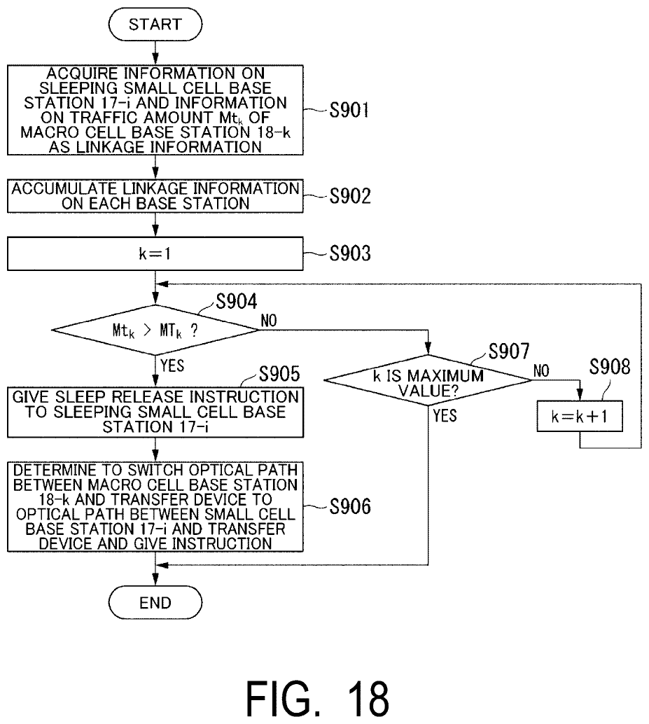

FIG. 18 is a flowchart showing one example of a flow of sleep release processing executed by the management control device 20c according to the third embodiment. The acquisition unit 211c acquires the traffic information indicating the traffic amount Mtₖ of the macro cell base station 18-k from each macro cell base station 18-k as the linkage information, and acquires information indicating the sleeping small cell base station 17-i as the linkage information (step S901). The acquisition unit 211c accumulates the traffic information indicating the acquired traffic amount Mtₖ and information indicating the sleeping small cell base station 17-i in the linkage information accumulation unit 221.

The real-time analysis unit 222c reads the linkage information from the linkage information accumulation unit 221 (step S902). The real-time analysis unit 222c substitutes a value of 1 to the constant k (step S903). The real-time analysis unit 222c judges whether or not the traffic amount Mtₖ of the macro cell base station 18-k is larger than the switching determination threshold value MTₖ for the macro cell base station 18-k (step S905). The condition indicated by Mtₖ>MTK is a specific example of the third sleep release condition.

When it is judged that the traffic amount Mtₖ of the macro cell base station 18-k is larger than the switching determination threshold value MTₖ for the macro cell base station 18-k (step S905—YES), the real-time analysis unit 222c judges that the third sleep release condition is satisfied. In this case, the real-time analysis unit 222c notifies the control unit 23c of the control information including information indicating the macro cell base station 18-k which becomes the optical path switching source, the small cell base station 17-i which becomes the optical path switching destination, and information indicating the small cell base station 17-i which becomes the sleep control target.

The sleep control unit 232c transmits the sleep release instruction to the sleeping small cell base station 17-i on the basis of the control information notified from the real-time analysis unit 222c (step S905). By doing this, the small cell base station 17-i is released from the sleep state.

The optical path switching control unit 231c determines the base station which becomes the optical path switching source and the base station which becomes the optical path switching destination on the basis of the control information notified from the real-time analysis unit 222c. By doing this, the optical path switching control unit 231c determines to switch the optical path between the macro cell base station 18-k and the transfer device 14c to the optical path between the small cell base station 17-i and the transfer device 14c. The optical path switching control unit 231c transmits the switching destination information including information indicating the small cell base station 17-i which becomes the determined optical path switching destination to the transfer device 14c. Further, the optical path switching control unit 231c transmits the optical path switching instruction to the macro cell base station 18-k which becomes the determined optical path switching source (step S906). Since the connections of the terminals are changed by the optical path switching, the optical path switching control unit 231c may instruct the macro cell base station 18-k to change the connections of the terminals 11.

In the processing of the step S904, when it is judged that the traffic amount Mtₖ of the macro cell base station 18-k is not larger than the switching determination threshold value MTₖ for the macro cell base station 18-k (step S904—NO), the real-time analysis unit 222c judges that the third sleep release condition is not satisfied. In this case, the real-time analysis unit 222c judges whether or not the constant k is the maximum value (step S907).

When it is determined that the constant k is not the maximum value (step S907—NO), the real-time analysis unit 222c adds a value of 1 to a value of the constant k (step S908). Thereafter, the real-time analysis unit 222c executes the processing of the step S904 again. On the other hand, when it is judged that the constant k is the maximum value (step S907—YES), the real-time analysis unit 222c terminates the processing.

According to the mobile NW system 100c configured as described above, the management control device 20c includes the linkage information collection unit 21c that acquires the linkage information from each of the small cell base station 17 and the macro cell base station 18 at a predetermined period or at arbitrary timing, the analysis unit 22c that determines whether or not the optical path switching is necessary on the basis of the linkage information, the optical path switching control unit 231c that controls the optical path switching of the small cell base station 17 when it is determined that the optical path switching is necessary, and the sleep control unit 232c that shifts the small cell base station 17 in which the optical path switching is performed to the sleep state after the optical path switching is performed. By doing this, the unconnected small cell base station 17 can be shifted to the sleep state. Therefore, it is possible to suppress the power consumption.

When the traffic amount obtained from the small cell base station 17 is smaller than the threshold value, the management control device 20c controls so as to switch the optical path of the small cell base station 17 to the optical path of the macro cell base station 18, and shifts the small cell base station 17 to the sleep state after the optical path switching is performed. By doing this, the small cell base station 17 with the small traffic amount can be shifted to the sleep state. Therefore, it is possible to suppress the power consumption.

### Modification Example 1 in Third Embodiment

The mobile NW system 100c may be modified as shown in the modification example 1 in the first embodiment and the modification example 2 in the first embodiment.

### Modification Example 2 in Third Embodiment

In the mobile NW system 100c, the transfer device 14c may be configured so as to perform the optical path switching control processing and the sleep control processing as shown in the modification example 3 in the first embodiment.

### Fourth Embodiment

In the third embodiment, the configuration in which the optical path between the small cell base station 17 and the transfer device 14c is switched to the optical path between the macro cell base station 18 and the transfer device 14c is described. In a fourth embodiment, a configuration in which the optical path between the macro cell base station 18 and the transfer device 14c is switched to the optical path between the small cell base station 17 and the transfer device 14c will be described. Note that in the configuration of the fourth embodiment, it is assumed that a plurality of small cell base stations 17 is arranged so as to cover the range of the macro cell base station 18 without interfering with each other.

### Outline of Fourth Embodiment

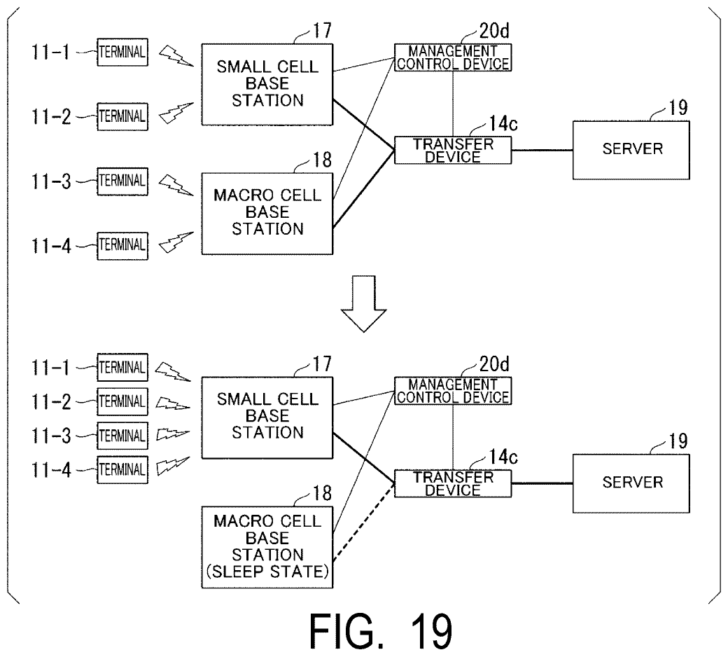

FIG. 19 is a diagram for explaining an outline of processing of a mobile NW system according to the fourth embodiment. First, an entire configuration of the mobile NW system according to the fourth embodiment will be described. The mobile NW system according to the fourth embodiment is one example of the communication system. The mobile NW system is 5G, for example. The mobile NW system according to the fourth embodiment includes a transfer device 14c, one or more small cell base stations 17, one or more macro cell base stations 18, one or more servers 19, and a management control device 20d.

The mobile NW system according to the fourth embodiment is similar to that of the third embodiment in terms of the number of the devices and the connection relation of each device except for the processing performed by the management control device 20d. Therefore, the following description will focus on differences from the third embodiment. An upper figure in FIG. 19 represents a connection state of the mobile NW system before the optical path switching, and a lower figure in FIG. 19 represents the connection state of the mobile NW system after the optical path switching. The upper figure in FIG. 19 shows an example in which the terminals 11-1 and 11-2 are connected to the small cell base station 17, the small cell base station 17 is connected to the server 19 through the transfer device 14c, the terminals 11-3 and 11-4 are connected to the macro cell base station 18, and the macro cell base station 18 is connected to the server 19 through the transfer device 14c.

The management control device 20d judges whether or not the optical path switching control processing is performed on the basis of the linkage information collected from each base station. The management control device 20d compares the switching determination threshold value held in advance with the traffic amount indicated by the traffic information included in the collected linkage information. In the fourth embodiment, when the traffic amount flowing to the macro cell base station 18 is small, the macro cell base station 18 is shifted to the sleep state, and the optical path between the macro cell base station 18 and the transfer device 14c is switched to the optical path between the small cell base station 17 and the transfer device 14c. By doing this, it is possible to suppress the power consumption in the macro cell base station 18 with small flowing traffic amount.

When the switching determination threshold value is larger than the traffic amount of the macro cell base station 18, the management control device 20d judges that the optical path switching control processing is performed. When the switching determination threshold value is larger than the traffic amount of the macro cell base station 18, it means that the traffic amount flowing to the macro cell base station 18 is small. On the other hand, when the switching determination threshold value is equal to or less than the traffic amount of the macro cell base station 18, the management control device 20d judges that the optical path switching control processing is not performed. When the switching determination threshold value is equal to or less than the traffic amount of the macro cell base station 18, it means that the traffic amount flowing to the macro cell base station 18 is large.

When it is judged that the optical path switching control processing is performed, the management control device 20d transmits information on the optical path switching destination to the transfer device 14c, and instructs the optical path switching to the base station which becomes the optical path switching target. Note that since the connection destinations of the terminals 11 are changed by the optical path switching, the management control device 20d may instruct the base station which becomes the optical path switching target to change the connections. The transfer device 14c switches the optical paths between the base station and the transfer device 14c in accordance with the instruction from the management control device 20d. The transfer device 14c notifies the management control device 20d of the optical path switching completion after the optical path switching is completed. The base station which becomes the optical path switching target performs the optical path switching in accordance with the instruction from the management control device 20d.

When the optical path switching control processing is completed, the management control device 20d transmits the sleep permission notification to the base station which becomes the target to be shifted to the sleep state. By doing this, the base station which becomes the target to be shifted to the sleep state shifts to the sleep state.

The lower figure in FIG. 19 shows an example in which the terminals 11-1 to 11-4 are connected to the small cell base station 17 and the macro cell base station 18 is shifted to the sleep state. In this way, in the mobile NW system in the fourth embodiment, the optical path between the macro cell base station 18 with the small traffic amount and the transfer device 14c is switched to the optical path between the small cell base station 17 and the transfer device 14c on the basis of the linkage information collected from each base station. Then, the unused macro cell base station 18 is shifted to the sleep state.

### Detail of Fourth Embodiment

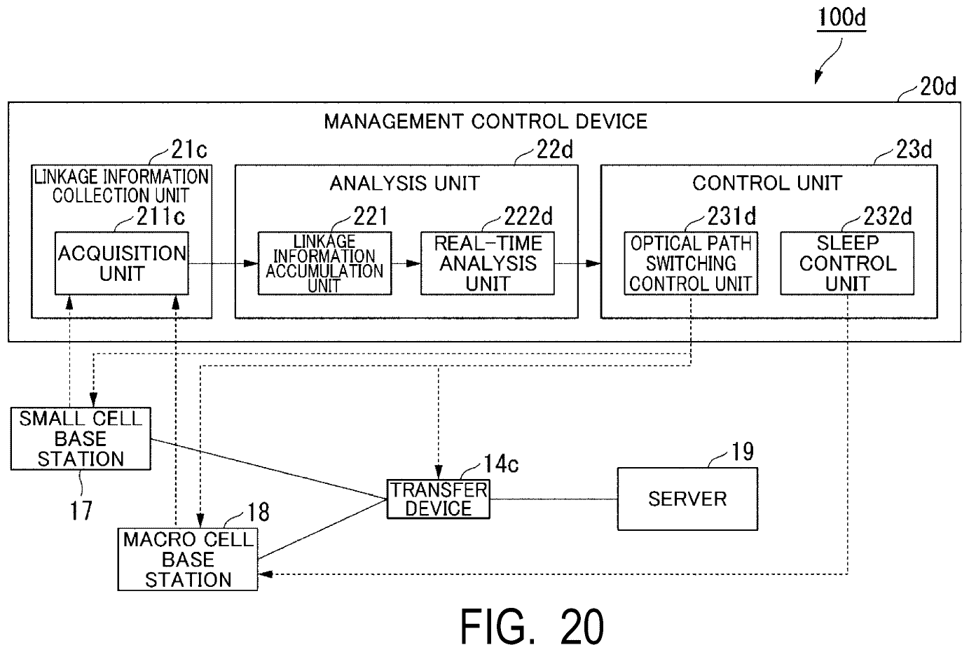

FIG. 20 is a diagram showing a configuration example of a mobile NW system 100d according to the fourth embodiment. The mobile NW system 100d in the fourth embodiment includes a transfer device 14c, one or more small cell base stations 17, one or more macro cell base stations 18, one or more servers 19, and a management control device 20d. In the following description, a case where the mobile NW system 100d includes one small cell base station 17, one macro cell base station 18, and one server 19 will be described. Note that since configurations of the small cell base station 17, the macro cell base station 18, the transfer device 14c, and the server 19 are similar to those of the third embodiment, description thereof will be omitted. The management control device 20d includes a linkage information collection unit 21c, an analysis unit 22d, and a control unit 23d.

The analysis unit 22d includes a linkage information accumulation unit 221 and a real-time analysis unit 222d. The real-time analysis unit 222d analyzes the communication state between each base station and the terminal 11 on the basis of the linkage information. Specifically, the real-time analysis unit 222d determines whether or not the optical path switching and the sleep control are necessary on the basis of the linkage information.

When determining whether or not the optical path switching and the sleep control are necessary, the real-time analysis unit 222d compares the switching determination threshold value held in advance with the traffic amount indicated by the traffic information included in the collected linkage information. The real-time analysis unit 222d holds the switching determination threshold value for each base station. That is, the real-time analysis unit 222d holds the switching determination threshold value for the small cell base station 17 and the switching determination threshold value for the macro cell base station 18.

Note that when a plurality of small cell base stations 17 is provided, the real-time analysis unit 222d may hold the switching determination threshold values different for each small cell base station 17, or may hold one switching determination threshold value common to all the small cell base stations 17. Similarly, when a plurality of macro cell base stations 18 is provided, the real-time analysis unit 222d may hold the switching determination threshold values different for each macro cell base station 18, or may hold one switching determination threshold value common to all the macro cell base stations 18.

The real-time analysis unit 222d judges whether or not a fourth switching condition is satisfied as a result of the comparison. The fourth switching condition is a condition indicating that the optical path switching between the macro cell base station 18 and the transfer device 14c is necessary. The fourth switching condition is that the switching determination threshold value for the macro cell base station 18 is larger than the traffic amount obtained from the macro cell base station 18, and the switching determination threshold value for the small cell base station 17 is larger than the traffic amount obtained from the small cell base station 17.

When the fourth switching condition is satisfied, the real-time analysis unit 222d judges that the optical path switching control processing is performed. On the other hand, when the fourth switching condition is not satisfied, the real-time analysis unit 222d judges that the optical path switching control processing is not performed. When it is judged that the optical path switching control processing is performed, the real-time analysis unit 222d notifies the control unit 23d of the control information including information indicating the base station which becomes the optical path switching source, information indicating the base station which becomes the optical path switching destination, and information indicating the base station which becomes the sleep control target.

Here, in the fourth embodiment, when the fourth switching condition is satisfied, the base station which becomes the optical path switching source is the macro cell base station 18 in which the switching determination threshold value for the macro cell base station 18 is larger than the traffic amount. In the fourth embodiment, when the fourth switching condition is satisfied, the base station which becomes the optical path switching destination is the small cell base station 17 in which the switching determination threshold value for the small cell base station 17 is larger than the traffic amount. In the fourth embodiment, when the fourth switching condition is satisfied, the base station which becomes the sleep control target is the macro cell base station 18 which becomes the optical path switching source. In this way, the real-time analysis unit 222d switches the optical path of the macro cell base station 18 with small flowing traffic to the small cell base station 17 with small flowing traffic.

Further, the real-time analysis unit 222d judges whether or not the fourth sleep release condition is satisfied as a result of the comparison. The fourth sleep release condition is a condition indicating that the sleep of the sleeping base station is released. The fourth sleep release condition is that the traffic amount of the small cell base station 17 is larger than the switching determination threshold value for the small cell base station 17, for example.

When the fourth sleep release condition is satisfied, the real-time analysis unit 222d judges that the optical path switching control processing is performed. On the other hand, when the fourth sleep release condition is not satisfied, the real-time analysis unit 222d judges that the optical path switching control processing is not performed. When it is judged that the optical path switching control processing is performed, the real-time analysis unit 222d notifies the control unit 23d of the control information including information indicating the base station which becomes the optical path switching source, information indicating the base station which becomes the optical path switching destination, and information indicating the base station which becomes the sleep control target.

Here, in the fourth embodiment, when the fourth sleep release condition is satisfied, the base station which becomes the optical path switching source is the small cell base station 17 whose traffic amount is larger than the switching determination threshold value for the small cell base station 17. In the fourth embodiment, when the fourth sleep release condition is satisfied, the base station which becomes the optical path switching destination is the sleeping macro cell base station 18. In the fourth embodiment, when the fourth sleep release condition is satisfied, the base station which becomes the sleep control target is the sleeping macro cell base station 18. By doing this, when the traffic flowing to the small cell base station 17 increases after the fourth switching condition is satisfied and the optical path switching is performed, the real-time analysis unit 222d switches the optical path of the small cell base station 17 with large flowing traffic to the macro cell base station 18 in which the sleep release has been performed.

The control unit 23d includes an optical path switching control unit 231d and a sleep control unit 232d. The optical path switching control unit 231d determines the base station which becomes the optical path switching source and the base station which becomes the optical path switching destination on the basis of the analysis result of the real-time analysis unit 222d. For example, the optical path switching control unit 231d determines the base station which becomes the optical path switching source on the basis of information indicating the base station which becomes the optical path switching source included in the control information notified from the real-time analysis unit 222d. For example, the optical path switching control unit 231d determines the base station which becomes the optical path switching destination on the basis of information indicating the base station which becomes the optical path switching destination included in the control information notified from the real-time analysis unit 222d.

The optical path switching control unit 231d transmits the switching destination information including information indicating the base station which becomes the determined optical path switching destination to the transfer device 14c. By doing this, the optical path switching control unit 231d instructs the optical path switching to the transfer device 14c. Further, the optical path switching control unit 231d transmits the optical path switching instruction to the base station which becomes the optical path switching source.

The sleep control unit 232d causes the base station which becomes the sleep control target to execute the sleep or release the sleep on the basis of the analysis result of the real-time analysis unit 222d.

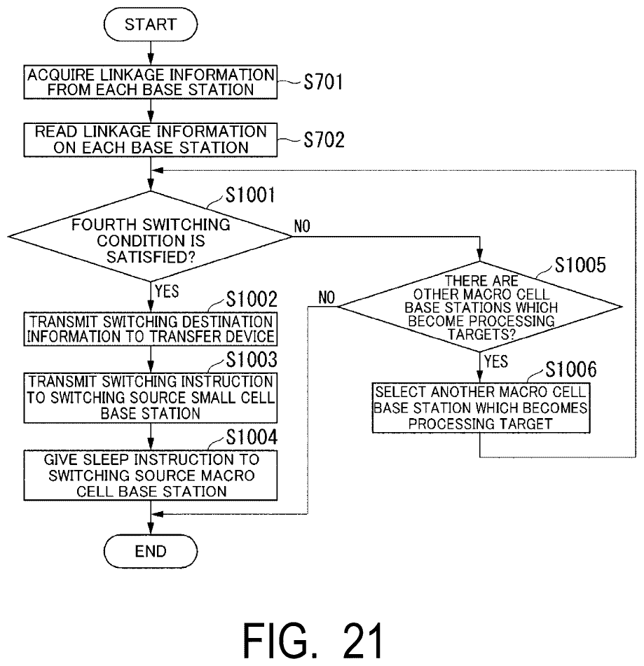

FIG. 21 is a flowchart showing one example of a flow of sleep processing executed by the management control device 20d according to the fourth embodiment. The flow of the processing in FIG. 21 is repeatedly executed with a predetermined period. In FIG. 21, processing similar to that shown in FIG. 16 is designated by the same reference signs as those in FIG. 16 and description thereof will be omitted.

After the processing of the step S702, the real-time analysis unit 222d judges whether or not the fourth switching condition is satisfied on the basis of the linkage information on each base station accumulated in the linkage information accumulation unit 221 and the switching determination threshold value held in advance (step S1001).

When it is judged that the fourth switching condition is satisfied (step S1001—YES), the real-time analysis unit 222d notifies the control unit 23d of the control information. The optical path switching control unit 231d determines the base station which becomes the optical path switching destination on the basis of the control information notified from the real-time analysis unit 222d. Here, it is assumed that the optical path switching control unit 231d determines the small cell base station 17 as the optical path switching destination. The optical path switching control unit 231d transmits the switching destination information including information indicating the small cell base station 17 which becomes to the determined optical path switching destination to the transfer device 14c (step S1002). By doing this, the optical path switching control unit 231d instructs to switch the optical path between the switching source base station (for example, macro cell base station 18) and the transfer device 14c to the optical path between the small cell base station 17 and the transfer device 14c.

Further, the optical path switching control unit 231d determines the base station which becomes the optical path switching source on the basis of the control information notified from the real-time analysis unit 222d. Here, it is assumed that the optical path switching control unit 231d determines the macro cell base station 18 as the optical path switching source. The optical path switching control unit 231d transmits the optical path switching instruction to the macro cell base station 18 which becomes the determined optical path switching source (step S1003). By doing this, the optical path switching control unit 231d controls the optical path between the macro cell base station 18 and the transfer device 14c.

The sleep control unit 232d determines the base station which becomes the sleep control target on the basis of the control information notified from the real-time analysis unit 222d. Here, the sleep control unit 232d determines the macro cell base station 18 as the sleep control target. The sleep control unit 232d transmits the sleep permission notification to the determined macro cell base station 18 (step S1004). For example, when the optical path switching completion notification is obtained from the macro cell base station 18, the sleep control unit 232d may transmit the sleep permission notification. By doing this, the macro cell base station 18 can be shifted to the sleep state.

In the processing of the step S1001, when it is judged that the fourth switching condition is not satisfied (step S1001—NO), the real-time analysis unit 222d judges whether or not there are other macro cell base stations 18 which become the processing targets (step S1005). Other macro cell base stations 18 which become the processing targets are the macro cell base stations 18 which are not judged by the fourth switching condition, for example. When it is judged that there are no other macro cell base stations 18 which become the processing targets (step S1005—NO), the real-time analysis unit 222d terminates the processing.

On the other hand, when it is judged that there are other macro cell base stations 18 which become the processing targets (step S1005—YES), the real-time analysis unit 222d selects one macro cell base station 18 from other macro cell base stations 18 which become the processing targets (step S1006). Thereafter, the real-time analysis unit 222d executes the processing of the step S1001 again by using the linkage information obtained from the selected macro cell base station 18.

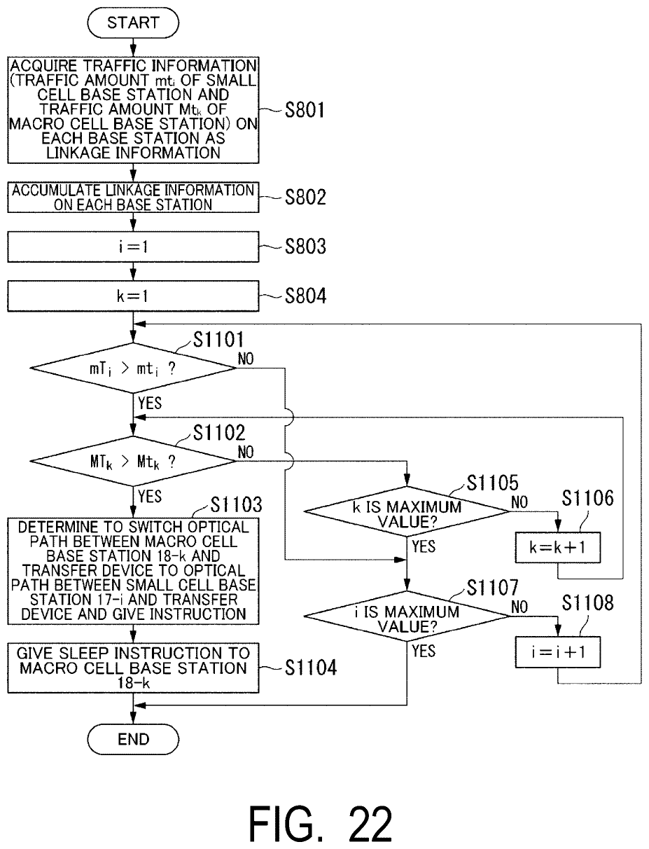

FIG. 22 is a flowchart showing one example of a flow of sleep processing executed by the management control device 20d according to the fourth embodiment. Note that the processing shown in FIG. 22 will describe the contents in which the processing shown in FIG. 21 is more specifically shown. In FIG. 22, processing similar to that shown in FIG. 17 is designated by the same reference signs as those in FIG. 17 and description thereof will be omitted.

After the processing of the step S804, the real-time analysis unit 222d judges that the switching determination threshold value mTᵢ for the small cell base station 17-i is larger than the traffic amount mtᵢ of the small cell base station 17-i on the basis of the linkage information (for example, traffic amount mtᵢ of the small cell base station 17-i) on the small cell base station 17-i accumulated in the linkage information accumulation unit 221 (step S1101). When the constant i=1 is satisfied, the real-time analysis unit 222d judges whether or not the switching determination threshold value mTᵢ for the small cell base station 17-1 is larger than the traffic amount mtᵢ of the small cell base station 17-1.

When it is judged that the switching determination threshold value mTᵢ for the small cell base station 17-i is larger than the traffic amount mtᵢ of the small cell base station 17-i (step S1101—YES), the real-time analysis unit 222d judges whether or not the switching determination threshold value MTₖ for the macro cell base station 18-k is larger than the traffic amount Mtₖ of the macro cell base station 18-k (step S1102). When the constant k=1 is satisfied, the real-time analysis unit 222d judges whether or not the switching determination threshold value MT₁ for the macro cell base station 18-1 is larger than the traffic amount Mt₁ of the macro cell base station 18-1. The conditions shown in the step S1101 and the step S1102 are specific examples of the fourth switching condition.

When it is judged that the switching determination threshold value MTₖ for the macro cell base station 18-k is larger than the traffic amount Mtₖ of the macro cell base station 18-k (step S1102—YES), the real-time analysis unit 222d judges that the fourth switching condition is satisfied. In this case, the real-time analysis unit 222d notifies the control unit 23d of the control information including information indicating the macro cell base station 18-k which becomes the optical path switching source, information indicating the small cell base station 17-i which becomes the optical path switching destination, and information indicating the macro cell base station 18-k which becomes the sleep control target.

The optical path switching control unit 231d determines the base station which becomes the optical path switching source and the base station which becomes the optical path switching destination on the basis of the control information notified from the real-time analysis unit 222d. By doing this, the optical path switching control unit 231d determines to switch the optical path between the macro cell base station 18-k and the transfer device 14c to the optical path between the small cell base station 17-i and the transfer device 14c. The optical path switching control unit 231d transmits the switching destination information including information indicating the small cell base station 17-i which becomes the determined optical path switching destination to the transfer device 14c. Further, the optical path switching control unit 231d transmits the optical path switching instruction to the small cell base station 17 which becomes the determined optical path switching source (step S1103).

The sleep control unit 232d determines the macro cell base station 18-k which becomes the sleep control target on the basis of the control information notified from the real-time analysis unit 222d. The sleep control unit 232d transmits the sleep permission notification to the determined macro cell base station 18-k (step S1104).

In the processing of the step S1102, when it is judged that the switching determination threshold value MTₖ for the macro cell base station 18-k is not larger than the traffic amount Mtₖ of the macro cell base station 18-k (step S1102—NO), the real-time analysis unit 222d judges that the fourth switching condition is not satisfied. In this case, the real-time analysis unit 222d judges whether or not the constant k is the maximum value (step S1105). When it is judged that the constant k is not the maximum value (step S1105—NO), the real-time analysis unit 222d adds a value of 1 to a value of the constant k (step S1106). Thereafter, the real-time analysis unit 222d executes the processing of the step S1102 again.

On the other hand, when it is judged that the constant k is the maximum value (step S1106—YES), the real-time analysis unit 222d judges whether or not the constant i is the maximum value (step S1107). When it is judged that the constant i is not the maximum value (step S1107—NO), the real-time analysis unit 222d adds a value of 1 to a value of the constant i (step S1108). Thereafter, the real-time analysis unit 222d executes the processing of the step S1101 again. On the other hand, when it is judged that the constant i is the maximum value (step S1107—YES), the real-time analysis unit 222d terminates the processing.

In the processing of the step S1101, when it is judged that the switching determination threshold value mTᵢ for the small cell base station 17-i is not larger than the traffic amount mtᵢ of the small cell base station 17-i (step S1101—NO), the real-time analysis unit 222d performs the processing of the step S1107.

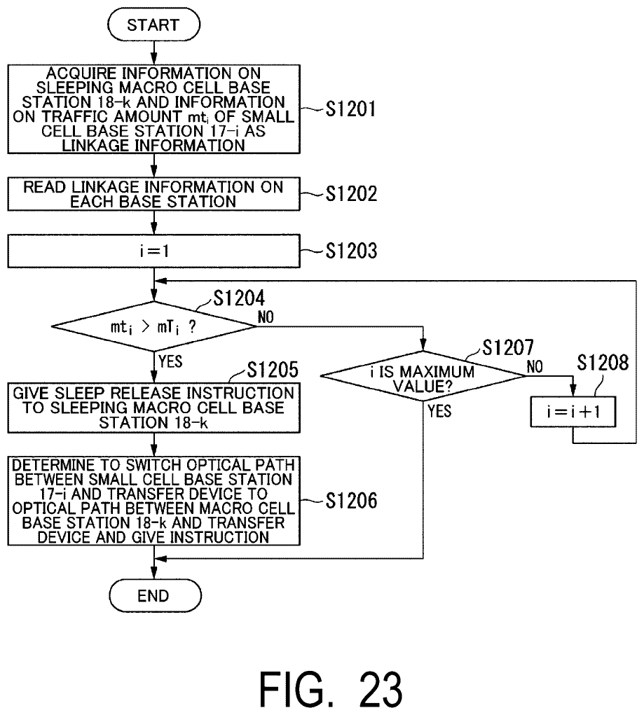

FIG. 23 is a flowchart showing one example of a flow of sleep release processing executed by the management control device 20d according to the fourth embodiment. The acquisition unit 211 acquires the traffic information indicating the traffic amount mtᵢ of the small cell central station 15-i from each small cell central station 15-i as the linkage information, and acquires information indicating the sleeping macro cell central station 16-k and macro cell radio station 13-k as the linkage information (step S1201). The acquisition unit 211 accumulates the traffic information indicating the acquired traffic amount mtᵢ and information indicating the sleeping macro cell central station 16-k and macro cell radio station 13-k in the linkage information accumulation unit 221.

The real-time analysis unit 222d reads the linkage information from the linkage information accumulation unit 221 (step S1202). The real-time analysis unit 222d substitutes a value of 1 to the constant i (step S1203). The real-time analysis unit 222d judges whether or not the traffic amount mtᵢ of the small cell central station 15-i is larger than the switching determination threshold value mTᵢ for the small cell central station 15-i (step S1204). The condition indicated by mtᵢ>mTᵢ is a specific example of the second sleep release condition.

When it is judged that the traffic amount mtᵢ of the small cell central station 15-i is larger than the switching determination threshold value mTᵢ for the small cell central station 15-i (step S1204—YES), the real-time analysis unit 222d judges that the second sleep release condition is satisfied. In this case, the real-time analysis unit 222d notifies the control unit 23d of the control information including information indicating the small cell central station 15-i which becomes the optical path switching source, the macro cell central station 16-k which becomes the optical path switching destination, and information indicating the macro cell radio station 13-k connected to the macro cell central station 16-k and the macro cell central station 16-k which become the sleep control targets.

The sleep control unit 232d transmits the sleep release instruction to the sleeping macro cell central station 16-k and macro cell radio station 13-k on the basis of the control information notified from the real-time analysis unit 222d (step S1205). By doing this, the macro cell central station 16-k and the macro cell radio station 13-k are released from the sleep state.

The optical path switching control unit 231d determines the radio station and the central station which become the optical path switching sources and the radio station and the central station which become the optical path switching destinations on the basis of the control information notified from the real-time analysis unit 222d. By doing this, the optical path switching control unit 231d determines to switch the optical path between the small cell central station 15-i and the small cell radio station 12-i to the optical path between the macro cell radio station 13-k and the macro cell central station 16-k. The optical path switching control unit 231d transmits the switching destination information including information indicating the macro cell radio station 13-k and the macro cell central station 16-k which become the determined optical path switching destinations to the transfer device 14c. Further, the optical path switching control unit 231d transmits the optical path switching instruction to the small cell radio station 12-i and the small cell central station 15-i which become the determined optical path switching sources (step S1206). Since the connections of the terminals are changed by the optical path switching, the optical path switching control unit 231d may instruct the small cell central station 15-i to change the connections of the terminals 11.

In the processing of the step S1204, when it is judged that the traffic amount mtᵢ of the small cell base station 17-i is not larger than the switching determination threshold value mTᵢ for the small cell base station 17-i (step S1204—NO), the real-time analysis unit 222d judges that the fourth sleep release condition is not satisfied. In this case, the real-time analysis unit 222d judges whether or not the constant i is the maximum value (step S1207).

When it is judged that the constant i is not the maximum value (step S1207—NO), the real-time analysis unit 222d adds a value of 1 to a value of the constant i (step S1208). Thereafter, the real-time analysis unit 222d executes the processing of the step S604 again. On the other hand, when it is judged that the constant i is the maximum value (step S1207—YES), the real-time analysis unit 222d terminates the processing.

According to the mobile NW system 100d configured as described above, the management control device 20d includes the linkage information collection unit 21c that acquires the linkage information from each of the small cell base station 17 and the macro cell base station 18 at a predetermined period or at arbitrary timing, the analysis unit 22d that determines whether or not the optical path switching is necessary on the basis of the linkage information, the optical path switching control unit 231d that controls the optical path switching of the macro cell base station 18 when it is determined that the optical path switching is necessary, and the sleep control unit 232d that shifts the macro cell base station 18 in which the optical path switching is performed to the sleep state after the optical path switching is performed. By doing this, the unconnected macro cell base station 18 can be shifted to the sleep state. Therefore, it is possible to suppress the power consumption.

When the traffic amount obtained from the macro cell base station 18 is smaller than the threshold value, the management control device 20d controls so as to switch the optical path of the macro cell base station 18 to the optical path of the small cell base station 17, and shifts the macro cell base station 18 to the sleep state after the optical path switching is performed. By doing this, the macro cell base station 18 with small traffic amount can be shifted to the sleep state. Therefore, it is possible to suppress the power consumption.

### Modification Example 1 in Fourth Embodiment

The mobile NW system 100d may be modified as shown in the modification example 1 in the first embodiment and the modification example 2 in the first embodiment.

### Modification Example 2 in Fourth Embodiment

In the mobile NW system 100d, the transfer device 14c may be configured so as to perform the optical path switching control processing and the sleep control processing as shown in the modification example 3 in the first embodiment.

### Modification Example 1 Common to First Embodiment to Fourth Embodiment

Although the above-described embodiments have been described on the assumption that the communication area of the small cell is formed in the communication area of the macro cell, the communication area other than the small cell may be formed in the communication area of the macro cell. The communication area other than the small cell is a communication area in a range smaller than the communication area of the macro cell such as a communication area of a femtocell or a communication area of a picocell, for example.

### Modification Example 2 Common to First Embodiment to Fourth embodiment

In each embodiment shown in the first embodiment to fourth embodiment, after the optical path switching is completed in FIG. 3 to FIG. 5, FIG. 11 to FIG. 13, FIG. 16 to FIG. 18, and FIG. 21 to FIG. 23, the configuration is shown in which the radio station (for example, switching source radio station) and the central station (for example, switching source central station) which become the sleep target are shifted to the sleep. Specifically, after the optical path switching is completed (for example, after the optical path switching instruction is transmitted), the configuration is shown in which the management control devices 20, 20b, 20c, and 20d and the transfer device 14a shift the radio station (for example, switching source radio station) and the central station (for example, switching source central station) which become the sleep targets to the sleep.

On the other hand, the mobile NW systems 100, 100a, 100b, 100c, and 100d in FIG. 3 to FIG. 5, FIG. 11 to FIG. 13, FIG. 16 to FIG. 18, and FIG. 21 to FIG. 23 may be configured to perform the optical path switching after the radio station (for example, switching source radio station) and the central station (for example, switching source central station) which become the sleep targets are shifted to the sleep (for example, after the sleep instruction is transmitted). In such a configuration, the management control devices 20, 20b, 20c, and 20d and the transfer device 14a execute the optical path switching after the radio station (for example, switching source radio station) and the central station (for example, switching source central station) which become the sleep targets are shifted to the sleep (for example, after the sleep instruction is transmitted).

Note that, similarly, the mobile NW systems 110 and 120 may be configured to perform the optical path switching after the radio station (for example, switching source radio station) and the central station (for example, switching source central station) which become the sleep targets are shifted to the sleep (for example, after the sleep instruction is transmitted). In the mobile NW systems 110 and 120, a device (for example, optical transmission management control device 30) that performs the optical path switching control processing is different from a device (for example, radio transmission management control device 40) that performs the sleep control processing.

Therefore, after shifting the radio station (for example, switching source radio station) and the central station (for example, switching source central station) which become the sleep targets to the sleep (for example, after the sleep instruction is transmitted), the radio transmission management control device 40 notifies the optical transmission management control device 30 of the sleep instruction transmission, and after receiving the notification from the radio transmission management control device 40, the optical transmission management control device 30 executes the optical path switching.

### Fifth Embodiment

In the first embodiment to fourth embodiment, the optical path switching is judged by using the traffic amount information on each central station as the linkage information. However, it is also assumed that if the optical path switching is judged only by the traffic amount, communication quality is lowered after the terminal switches the connections, which may result in the occurrence of delay. Therefore, in the fifth embodiment, a configuration in which the optical path switching is judged by including information on the communication quality of the terminal connected to the central station in addition to the traffic amount information will be described.

### Outline of Fifth Embodiment

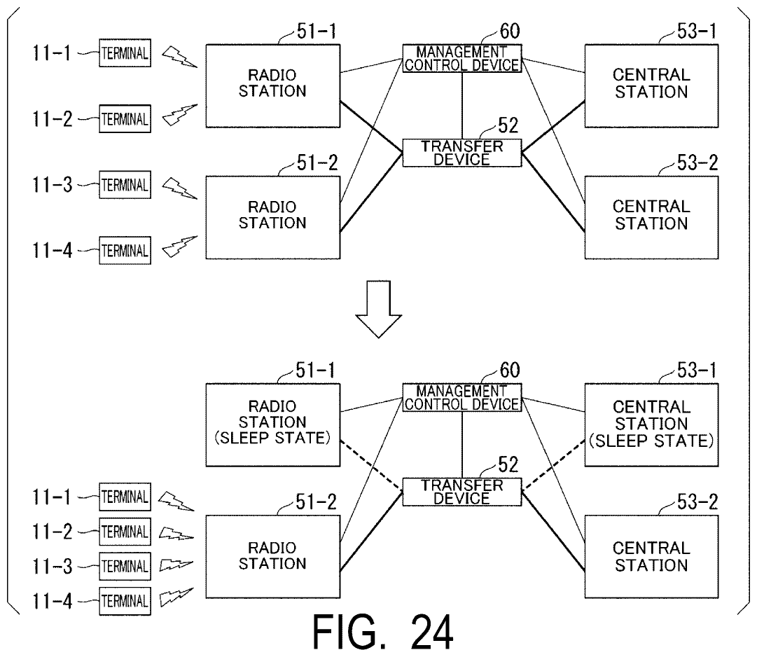

FIG. 24 is a diagram for explaining an outline of processing of a mobile NW system according to the fifth embodiment. First, an entire configuration of the mobile NW system according to the fifth embodiment will be described. The mobile NW system according to the fifth embodiment is one example of the communication system. The mobile NW system according to the fifth embodiment is 5G, for example. The mobile NW system according to the fifth embodiment includes a plurality of radio stations 51-1 and 51-2, a transfer device 52, a plurality of central stations 53-1 and 53-2, and a management control device 60.

The plurality of radio stations 51-1 and 51-2 and the transfer device 52, and the transfer device 52 and the plurality of central stations 53-1 and 53-2 are connected by the optical fibers for transmitting the optical signals. The transfer device 52 and the management control device 60, the plurality of central stations 53-1 and 53-2 and the management control device 60, and the plurality of central stations 53-1 and 53-2 and the management control device 60 are connected by the optical fibers or the electric lines for transmitting the electric signals.

In an example shown in FIG. 24, two radio stations 51 and two central stations 53 are provided, but the number of radio stations 51 and the central stations 53 is not particularly limited. Note that although a plurality of transfer devices 52 may be provided, the following description will be given by taking one transfer device as an example. The radio station 51 is a small cell radio station and a macro cell radio station similar to those in the first embodiment to fourth embodiment, and the central station 53 is a small cell central station and a macro cell central station similar to those in the first embodiment to fourth embodiment. For example, the radio station 51-1 may be a small cell radio station, the radio station 51-2 may be a macro cell radio station, the central station 53-1 may be a small cell central station, and the central station 53-2 may be a macro cell central station, and the above may be reversed.

The radio station 51-1 is connected to the central station 53-1 through the transfer device 52. The radio station 51-2 is connected to the central station 53-2 through the transfer device 52. In FIG. 24, it is assumed that the radio station 51-1 is the small cell radio station, the radio station 51-2 is the macro cell radio station, the central station 53-1 is the small cell central station, and the central station 53-2 is the macro cell central station.

The radio station 51-1 is the radio station installed in a communication area formed by the radio station 51-2. The radio station 51-1 forms a smaller range communication area than that of the communication area formed by the radio station 51-2. For example, the radius of the communication area formed by the radio station 51-1 is several meters to several hundred meters. The radio station 51-1 includes one or more antennas and performs radio communication with the terminal 11 located in the communication area. For example, the radio station 51-1 receives the signal transmitted from the terminal 11, and transmits the received signal to the central station 53-1 connected through the transfer device 52. The radio station 51-1 transmits the signal received through the transfer device 52 to the terminal 11.

The radio station 51-1 is the RU in the 5G communication standard, for example. When the radio station 51-1 includes a plurality of antennas, the radio station 51-1 may perform the radio communication with the terminal 11 by beam forming. The radio station 51-1 shifts to the sleep state in accordance with the sleep instruction transmitted from the management control device 60. The radio station 51-1 releases the sleep state in accordance with the sleep release instruction transmitted from the management control device 60. Further, the radio station 51-1 performs the optical path switching in accordance with the optical path switching instruction transmitted from the management control device 60. When receiving the optical path switching start instruction after receiving the optical path switching instruction, the radio station 51-1 stops the setting of the optical path with the transfer device 52.

The radio station 51-2 is a radio station which forms a larger range communication area than that of the communication area formed by the radio station 51-1. For example, the radius of the communication area formed by the radio station 51-2 is several hundred meters to several kilometers. The radio station 51-2 includes one or more antennas and performs the radio communication with the terminal 11 located in the communication area. For example, the radio station 51-2 receives the signal transmitted from the terminal 11, and transmits the received signal to the central station 53-2 connected through the transfer device 52. The radio station 51-2 transmits the signal received through the transfer device 52 to the terminal 11. The radio station 51-2 is the RU in the 5G communication standard, for example.

The radio station 51-2 shifts to the sleep state in accordance with the sleep instruction transmitted from the management control device 60. The radio station 51-2 releases the sleep state in accordance with the sleep release instruction transmitted from the management control device 60. Further, the radio station 51-2 performs the optical path switching in accordance with the optical path switching instruction transmitted from the management control device 60. When receiving the optical path switching start instruction after receiving the optical path switching instruction, the macro cell radio station 13 stops the optical path setting with the transfer device 52.

The transfer device 52 is provided between the radio station 51 and the central station 53. The transfer device 52 performs the optical path switching in accordance with the switching destination information transmitted from the management control device 60. The transfer device 52 switches the connections between the radio station 51 and the central station 53 by switching the optical paths. For example, when receiving the optical path switching destination information transmitted from the management control device 60, the transfer device 52 instructs the switching so that the optical paths are connected between the switching destination radio station and the switching destination central station.

The central station 53-1 receives upstream signals transmitted by the radio station 51-1 through the transfer device 52. The central station 53-1 transmits downstream signals to the radio station 51-1 through the transfer device 52. The central station 53-1 shifts to the sleep state in accordance with the sleep instruction transmitted from the management control device 60. The central station 53-1 releases the sleep state in accordance with the sleep release instruction transmitted from the management control device 60. The central station 53-1 is a DU in the 5G communication standard, for example. The central station 53-1 transmits the linkage information to the management control device 60.

The linkage information according to the fifth embodiment includes the traffic information on each central station 53 and information (hereinafter referred to as “communication quality information”) on communication quality of the terminal 11 connected to each central station 53, for example. Note that the traffic information is described in DCI or O-RAN CTI, for example. In O-RAN CTI, it is intended to be schedule information. The traffic information may be replaced by the number of active terminals, the number of RRC connections, and the usage rate of physical resource blocks. The communication quality information includes MCS (Modulation and Coding Scheme), RSRP (Reference Signal Received Power), RSRQ (Reference Signal Received Quality), SINR (Signal-to-Noise Ratio), packet delay, and the like, for example. Further, the central station 53-1 performs the optical path switching in accordance with the optical path switching instruction transmitted from the management control device 60. When receiving the optical path switching start instruction after receiving the optical path switching instruction, the central station 53-1 stops the setting of the optical path with the transfer device 52.

The central station 53-2 receives upstream signals transmitted by the radio station 51-2 through the transfer device 52. The central station 53-2 transmits downstream signals to the radio station 51-2 through the transfer device 52. The central station 53-2 shifts to the sleep state in accordance with the sleep instruction transmitted from the management control device 60. The central station 53-2 releases the sleep state in accordance with the sleep release instruction transmitted from the management control device 60. The central station 53-2 is the DU in the 5G communication standard, for example. The central station 53-2 transmits the linkage information to the management control device 60.

Further, the central station 53-2 performs the optical path switching in accordance with the optical path switching instruction transmitted from the management control device 60. When receiving the optical path switching start instruction after receiving the optical path switching instruction, the central station 53-2 stops the setting of the optical path with the transfer device 52.

The management control device 60 is a device that manages an entire mobile NW system 200. The management control device 60 acquires the linkage information from each central station 53. The management control device 60 determines whether or not the optical path switching and the sleep control are necessary on the basis of the acquired linkage information. When it is determined that the optical path switching and the sleep control are necessary, the management control device 60 performs the optical path switching control processing and the sleep control processing.

Next, an outline of processing of the mobile NW system will be described.

An upper figure in FIG. 24 represents a connection state of the mobile NW system before the optical path switching, and a lower figure in FIG. 24 represents the connection state of the mobile NW system after the optical path switching. The upper figure in FIG. 24 shows an example in which the terminals 11-1 and 11-2 are connected to the radio station 51-1, the radio station 51-1 is connected to the central station 53-1 through the transfer device 52, the terminals 11-3 and 11-4 are connected to the radio station 51-2, and the radio station 51-2 is connected to the central station 53-2 through the transfer device 52. In FIG. 24, it is assumed that the radio station 51-1 is the switching source radio station, the radio station 51-2 is the switching destination radio station, the central station 53-1 is the switching source central station, and the central station 53-2 is the switching destination central station.

The management control device 60 judges whether or not the optical path switching control processing is performed on the basis of the linkage information collected from each central station 53. In an example shown in FIG. 24, the management control device 60 judges whether or not the optical path between the radio station 51-1 and the central station 53-1 is switched to between the radio station 51-2 and the central station 53-2. The management control device 60 compares the switching determination threshold value with the traffic amount indicated by the traffic information included in the collected linkage information. Further, the management control device 60 compares the switching determination threshold value with the value based on the communication quality information included in the collected linkage information.

Note that the switching determination threshold value compared with the traffic amount is different from the switching determination threshold value compared with the value indicated by the communication quality information. Hereinafter, the switching determination threshold value to be compared with the traffic amount is described as a traffic threshold value, and the switching determination threshold value to be compared with the value indicated by the communication quality information is described as a communication quality threshold value. The traffic threshold value and the communication quality threshold value may be different for each central station 53, may be calculated from the linkage information, or may be held in advance by the management control device 60.

The management control device 60 according to the fifth embodiment calculates the total value of the traffic amount of the switching source central station (central station 53-1) and the traffic amount of the switching destination central station (central station 53-2), and compares the calculated total value of the traffic amounts with the traffic threshold value of the switching destination central station (central station 53-2). Then, when the total value of the traffic amounts is smaller than the traffic threshold value of the switching destination central station (central station 53-2), the management control device 60 performs the comparison based on the communication quality information. Note that the management control device 60 may compare the traffic amount after comparing the communication quality.

The comparison based on the communication quality information according to the fifth embodiment is performed by comparing the communication quality (hereinafter referred to as “post-switching communication quality”) when the connection of the terminal 11 connected to the switching source central station is switched to the switching destination central station with the communication quality threshold value of the switching destination central station, for example. The value of the post-switching communication quality according to the fifth embodiment is calculated as follows.

### (Calculation Method 1 of Value of Post-switching Communication Quality)

The management control device 60 acquires position information on the switching destination central station, position information on the terminal 11 connected to the switching destination central station, position information on the terminal 11 connected to the switching source central station, and information (for example, MCS) on the communication quality on the terminal 11 connected to the switching source central station. Note that the position information may be included in the linkage information or may be requested from the management control device 60 to each central station. The management control device 60 calculates a distance (for example, first distance) between the terminal 11 connected to the switching destination central station and the switching destination central station, and a distance (for example, second distance) between the terminal 11 connected to the switching source central station and the switching destination central station on the basis of the position information. The management control device 60 compares the first distance with the second distance, and calculates the value (value of MCS) of the post-switching communication quality when the terminal 11 connected to the switching source central station is connected to the switching destination central station.

### (Calculation Method 2 of Value of Post-switching Communication Quality)

The management control device 60 acquires reception power of the switching destination central station, reception power of the terminal 11 connected to the switching destination central station, reception power of the terminal 11 connected to the switching source central station, and information (for example, MCS) on the communication quality of the terminal 11 connected to the switching source central station. Note that the reception power may be included in the linkage information or may be requested from the management control device 60 to each central station. The management control device 60 compares the reception power of the terminal 11 connected to the switching destination central station, the reception power of the switching destination central station, and the reception power of the terminal 11 connected to the switching source central station, and calculates the value (value of MCS) of the post-switching communication quality when the terminal 11 connected to the switching source central station is connected to the switching destination central station.

As a result of the comparison, when the total value of the traffic amounts is smaller than the traffic threshold value of the switching destination central station (central station 53-2) and the value indicated by the communication quality information indicates that the communication quality is good in the comparison with the communication quality threshold value, the management control device 60 according to the fifth embodiment judges that the optical path switching control processing is performed. When the total value of the traffic amounts is smaller than the traffic threshold value of the switching destination central station (central station 53-2), it means that the processing is possible even if the terminals 11 connected to the switching source central station (central station 53-1) are aggregated to the switching destination central station (central station 53-2).

When it indicates that the communication quality is good, it means that the communication quality of the terminal 11 is not deteriorated and the delay is not increased even if the terminals 11 connected to the switching source central station (central station 53-1) are aggregated to the switching destination central station (central station 53-2). Note that the communication quality may be good when the value is higher or the communication quality may be good when the value is lower depending on the information to be used. Then, a condition indicating that the communication quality is good is determined in accordance with the information used as the communication quality.

For example, when the communication quality is a packet delay, the higher the value is, the larger the delay is. Therefore, when the value (for example, value of delay) indicated by the communication quality information is larger than the communication quality threshold value, it is assumed that the communication quality is not good. Therefore, when the communication quality is packet delay, a value indicated by the communication quality information that is smaller than the communication quality threshold value indicates that the communication quality is good.

When the total value of the traffic amounts is higher than the traffic threshold value of the switching destination central station (central station 53-2), or when the value based on the communication quality information indicates that the communication quality is bad in the comparison with the communication quality threshold value, the management control device 60 judges that the optical path switching control processing is not performed. When the total value of the traffic amounts is higher than the traffic threshold value of the switching destination central station (central station 53-2) and the terminals 11 connected to the switching source central station (central station 53-1) are aggregated to the switching destination central station (central station 53-2), it means that the traffic amount flowing to the switching destination central station (central station 53-2) is large and the possibility of processing is disabled. When the communication quality is bad, it means that the communication quality of the terminal 11 is deteriorated and the delay is increased when the terminals 11 connected to the switching source central station (central station 53-1) are aggregated to the switching destination central station (central station 53-2).

When it is judged that the optical path switching control processing is performed, the management control device 60 transmits information on the optical path switching destination to the transfer device 52, and instructs the optical path switching to the radio station 51 and the central station 53 which become the optical path switching targets. Note that since the connection destinations of the terminals 11 are changed by the optical path switching, the management control device 60 may instruct the central station 53 which becomes the optical path switching target to change the connections. The transfer device 52 switches the optical paths between the radio station 51 and the central station 53 in accordance with the instruction from the management control device 60. The transfer device 52 notifies the management control device 60 of the optical path switching completion after the optical path switching is completed. The radio station and the central station which become the optical path switching targets perform the optical path switching in accordance with the instruction from the management control device 60.

When the optical path switching control processing is completed, the management control device 60 transmits the sleep permission notification to the radio station 51 and the central station 53 which become the targets to be shifted to the sleep state. By doing this, the radio station 51 and the central station 53 which become the targets to be shifted to the sleep state shift to the sleep state. Note that in the above-mentioned description, the configuration has been described, in which the management control device 60 performs the sleep control processing after the optical path switching control processing is completed, as an example, but the management control device 60 may perform the optical path switching control processing after the sleep control processing is completed. In the following description, a configuration will be described, in which the sleep control processing is performed after the optical path switching control processing is completed, as an example.

The lower figure in FIG. 24 shows an example in which the terminals 11-1 to 11-4 are connected to the radio station 51-2, and the radio station 51-1 and the central station 53-1 shift to the sleep state. By doing this, in the mobile NW system according to the fifth embodiment, the optical paths between the radio station 51 and the central station 53 are switched on the basis of the linkage information collected from each central station 53. Then, the radio station 51-1 connected to the unused central station 53-1 and the unused central station 53-1 are shifted to the sleep state.

### Detail of Fifth Embodiment

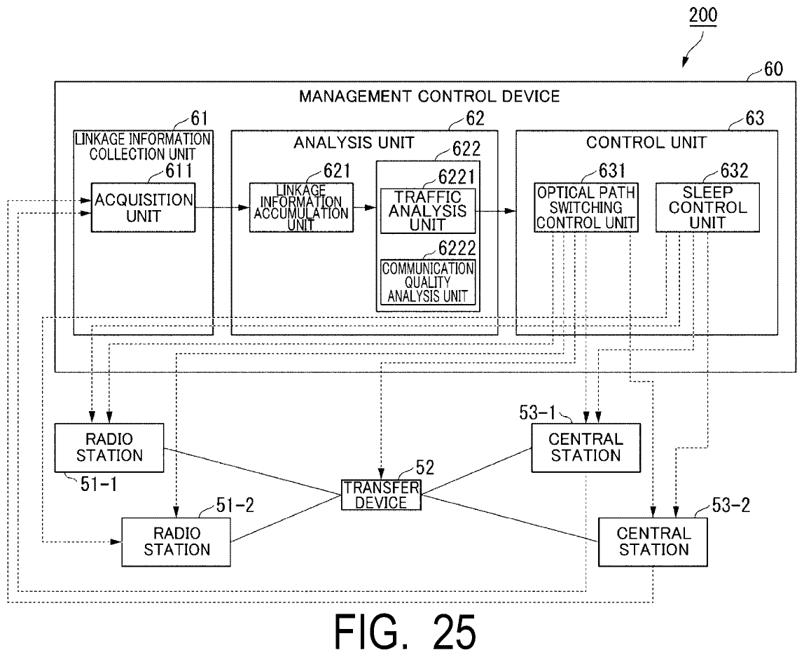

FIG. 25 is a diagram showing a configuration example of the mobile NW system 200 according to the fifth embodiment. The mobile NW system 200 according to the fifth embodiment includes a plurality of radio stations 51-1 and 51-2, a transfer device 52, a plurality of central stations 53-1 and 53-2, and a management control device 60. The following description will be given by taking two radio stations 51 and two central stations 53 in the mobile NW system 200 as an example.

The radio station 51 and the central station 53 are one aspect of a first base station and a second base station. For example, when the radio station 51-1 and the central station 53-1 are the first base station, the radio station 51-2 and the central station 53-2 are the second base station, and when the radio station 51-1 and the central station 53-1 are the second base station, the radio station 51-2 and the central station 53-2 are the first base station. In the present invention, the optical path switching and the sleep control of any one of a set of a small cell radio station and a small cell central station or a set of a macro cell radio station and a macro cell central station are performed.

Therefore, when the switching source radio station and the switching source central station are the small cell radio station and the small cell central station, the switching destination radio station and the switching destination central station become the macro cell radio station and the macro cell central station, and when the switching source radio station and the switching source central station are the macro cell radio station and the macro cell central station, the switching destination radio station and the switching destination central station become the small cell radio station and the small cell central station. Note that since the configuration of the radio station 51 and the central station 53 has been described with reference to FIG. 24, the description thereof will be omitted.

The management control device 60 includes a linkage information collection unit 61, an analysis unit 62, and a control unit 63. The linkage information collection unit 61 includes an acquisition unit 611. The acquisition unit 611 collects the linkage information from each central station 53 at a predetermined period or at arbitrary timing. For example, the acquisition unit 611 collects the traffic information and the communication quality information on each central station as the linkage information.

The analysis unit 62 includes a linkage information accumulation unit 621 and a real-time analysis unit 622. The linkage information accumulation unit 621 records the collected linkage information in a predetermined storage device. The real-time analysis unit 622 analyzes the communication state between each central station 53 and the terminal 11 on the basis of the linkage information. Specifically, the real-time analysis unit 622 determines whether or not the optical path switching and the sleep control are necessary on the basis of the linkage information.

The real-time analysis unit 622 includes a traffic analysis unit 6221 and a communication quality analysis unit 6222. The traffic analysis unit 6221 compares the traffic threshold value with the traffic amount indicated by the traffic information included in the collected linkage information. The traffic analysis unit 6221 holds the traffic threshold value for each central station 53. That is, the traffic analysis unit 6221 holds the traffic threshold value for the central station 53-1 and the traffic threshold value for the central station 53-2.

The communication quality analysis unit 6222 compares the communication quality threshold value with the value indicated by the communication quality information included in the collected linkage information. The communication quality analysis unit 6222 holds the communication quality threshold value for each central station 53. That is, the communication quality analysis unit 6222 holds the communication quality threshold value for the central station 53-1 and the communication quality threshold value for the central station 53-2.

Note that when a plurality of central stations 53 is provided, the real-time analysis unit 622 may hold the traffic threshold values and the communication quality threshold values different for each central station 53, or may hold one traffic threshold value and communication quality threshold value common to all central stations 53.

The real-time analysis unit 622 judges whether or not a fifth switching condition is satisfied as a result of the comparison. The fifth switching condition is a condition indicating that the optical path switching between the switching source radio station and the switching source central station is necessary. The fifth switching condition is that the total value of the traffic amounts of the switching source central station and the traffic amount of the switching destination central station is smaller than the traffic threshold value of the switching destination central station, and the value of the post-switching communication quality shows that the communication quality is good in the comparison with the communication quality threshold value of the switching destination central station. In other words, the fifth switching condition is that the traffic threshold value of the switching destination central station is equal to or greater than the total value, and the value of the post-switching communication quality shows that the communication quality is good in the comparison with the communication quality threshold value of the switching destination central station.

When the fifth switching condition is satisfied, the real-time analysis unit 622 judges that optical path switching control processing is performed. On the other hand, when the fifth switching condition is not satisfied, the management control device 60 judges that the optical path switching control processing is not performed. When it is judges that the optical path switching control processing is performed, the real-time analysis unit 622 notifies the control unit 63 of the control information including information indicating the central station (switching source central station) which becomes the optical path switching source, information indicating the central station (switching destination central station) which becomes the optical path switching destination, and information indicating the radio station 51 and the central station 53 which become the sleep control targets. The radio station 51 and the central station 53 which become the sleep control targets when shifting to the sleep are the radio station 51 connected to the switching source central station and the switching source central station.

Further, the real-time analysis unit 622 judges whether or not the fifth sleep release condition is satisfied as a result of the comparison. The fifth sleep release condition is a condition indicating that the sleep of the sleeping radio station 51 and central station 53 is released. The fifth sleep release condition is either when the traffic amount of the non-sleeping central station 53 is larger than the traffic threshold value for the non-sleeping central station 53 or when the communication quality of the terminal 11 connected to the non-sleeping central station 53 does not satisfy the communication quality threshold value, for example.

When the traffic amount of the non-sleeping central station 53 is larger than the traffic threshold value for the non-sleeping central station 53, it means that the traffic amount flowing to the non-sleeping central station 53 is large. When the communication quality of the terminal 11 connected to the non-sleeping central station 53 does not satisfy the communication quality threshold value, it means that the communication quality of the terminal 11 connected to the non-sleeping central station 53 is bad.

When the fifth sleep release condition is satisfied, the real-time analysis unit 622 judges that the optical path switching control processing is performed. On the other hand, when the fifth sleep release condition is not satisfied, the real-time analysis unit 622 judges that the optical path switching control processing is not performed. When it is judges that the optical path switching control processing is performed, the real-time analysis unit 622 notifies the control unit 63 of the control information including information indicating the central station (switching source central station) which becomes the optical path switching source, information indicating the central station (switching destination central station) which becomes the optical path switching destination, and information indicating the radio station 51 and the central station 53 which become the sleep control targets. The radio station 51 and the central station 53 which become the sleep control targets when releasing the sleep are the radio station 51 connected to the switching destination central station and the switching destination central station.

The control unit 63 includes an optical path switching control unit 631 and a sleep control unit 632. The optical path switching control unit 631 determines the radio station 51 and the central station 53 which become the optical path switching sources, and the radio station 51 and the central station 53 which become the optical path switching destinations on the basis of the analysis result of the real-time analysis unit 622. For example, the optical path switching control unit 631 determines the radio station 51 and the central station 53 which become the optical path switching sources on the basis of information indicating the central station 53 which becomes the optical path switching source included in the control information notified from the real-time analysis unit 622. For example, the optical path switching control unit 631 determines the radio station 51 and the central station 53 which become the optical path switching destinations on the basis of information indicating the central station 53 which becomes the optical path switching destination included in the control information notified from the real-time analysis unit 622. The optical path switching control unit 631 holds information on the radio station 51 connected to the central station 53.

The optical path switching control unit 631 transmits the switching destination information including information indicating the radio station 51 and the central station 53 which become the determined optical path switching destinations to the transfer device 52. By doing this, the optical path switching control unit 631 instructs the optical path switching to the transfer device 52.

Further, the optical path switching control unit 631 transmits the optical path switching instruction to the radio station 51 and the central station 53 which become the determined optical path switching sources.

The sleep control unit 632 causes the radio station 51 and the central station 53 which become the sleep control targets to execute the sleep or release the sleep on the basis of the analysis result of the real-time analysis unit 622.

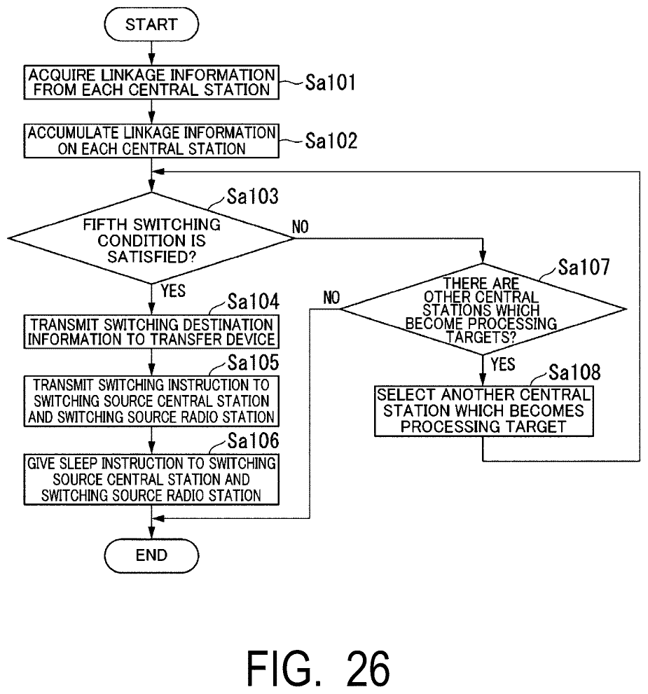

FIG. 26 is a flowchart showing one example of a flow of sleep processing executed by the management control device 60 according to the fifth embodiment. The flow of the processing in FIG. 26 is repeatedly executed with a predetermined period. Here, it is assumed that the switching source radio station and the switching source central station are the small cell radio station and the small cell central station. Therefore, the switching destination radio station and the switching destination central station become the macro cell radio station and the macro cell central station.

The acquisition unit 611 acquires the linkage information from each central station 53 (step Sa101). For example, the acquisition unit 611 acquires the linkage information from each of the central stations 53-1 and 53-2. The acquisition unit 611 collects the linkage information at arbitrary timing or at every unit time. The same applies to other embodiments. The unit time herein refers to slot length, sub-frame length, frame length, 1 millisecond, 1 second, 1 minute, and the like, for example. The acquisition unit 611 accumulates the acquired linkage information on each central station 53 in the linkage information accumulation unit 621 (step Sa102). The real-time analysis unit 622 judges whether or not the fifth switching condition is satisfied on the basis of the linkage information on each central station accumulated in the linkage information accumulation unit 621 and the switching determination threshold value (for example, traffic amount threshold value and communication quality threshold value) (step Sa103).

As an example, when the switching source central station is the central station 53-1 and the switching destination central station is the central station 53-2, the traffic analysis unit 6221 first calculates the total value of the traffic amounts of the central station 53-1 and the traffic amount of the central station 53-2. Next, the traffic analysis unit 6221 compares the calculated total value with the traffic threshold value for the central station 53-2. Here, when the total value is equal to or more than the traffic threshold value for the central station 53-2, the traffic analysis unit 6221 judges that the fifth switching condition is not satisfied.

On the other hand, when the total value is less than the traffic threshold value for the central station 53-2, the traffic analysis unit 6221 notifies the communication quality analysis unit 6222 that the condition related to the traffic is satisfied. The communication quality analysis unit 6222 compares the value of the post-switching communication quality when the connection of the terminal 11 connected to the central station 53-1 is switched to the central station 53-2 with the communication quality threshold value for the central station 53-2. Here, when the post-switching communication quality indicates that the communication quality is bad in the comparison with the communication quality threshold value for the central station 53-2, the communication quality analysis unit 6222 judges that the fifth switching condition is not satisfied. On the other hand, when the post-switching communication quality indicates that the communication quality is good in the comparison with the communication quality threshold value for the central station 53-2, the communication quality analysis unit 6222 judges that the fifth switching condition is satisfied.

Note that although the comparison by the communication quality is performed after the comparison by the traffic is performed in this case, the comparison by the traffic may be performed after the comparison by the communication quality is performed. Even in this case, when the post-switching communication quality indicates that the communication quality is good in the comparison with the communication quality threshold value for the central station 53-2 and the total value is less than the traffic threshold value for the central station 53-2, the real-time analysis unit 622 judges that the fifth switching condition is satisfied.

When it is judged that the fifth switching condition is satisfied (step Sa103—YES), the real-time analysis unit 622 notifies the control unit 63 of the control information. The optical path switching control unit 631 determines the radio station 51 and the central station 53 which become the optical path switching destinations on the basis of the control information notified from the real-time analysis unit 622. Here, it is assumed that the optical path switching control unit 631 determines the radio station 51-2 and the central station 53-2 as the optical path switching destinations. The optical path switching control unit 631 transmits the switching destination information including information indicating the radio station 51-2 and the central station 53-2 which become the determined optical path switching destinations to the transfer device 52 (step Sa104). By doing this, the optical path switching control unit 631 instructs to switch the optical path between the switching source radio station (for example, radio station 51-1) and the switching source central station (for example, central station 53-2) to the optical path between the radio station 51-2 and the central station 53-2.

Further, the optical path switching control unit 631 determines the radio station 51 and the central station 53 which become the optical path switching sources on the basis of the control information notified from the real-time analysis unit 622. Here, it is assumed that the optical path switching control unit 631 determines the radio station 51-1 and the central station 53-1 as the optical path switching sources. The optical path switching control unit 631 transmits the optical path switching instruction to the radio station 51-1 and the central station 53-1 which become the determined optical path switching sources (step Sa105). By doing this, the optical path switching control unit 631 controls the optical path between the switching source radio station (for example, radio station 51-1) and the switching source central station (for example, central station 53-1).

The sleep control unit 632 determines the radio station 51 and the central station 53 which become the sleep control targets on the basis of the control information notified from the real-time analysis unit 622. Here, the sleep control unit 632 determines the radio station 51-1 and the central station 53-1 as the sleep control targets. The sleep control unit 632 transmits the sleep permission notification to the determined radio station 51-1 and central station 53-1 (step Sa106). For example, when the optical path switching completion notification is obtained from each of the radio station 51-1 and the central station 53-1, the sleep control unit 632 may transmit the sleep permission notification. By doing this, the radio station 51-1 and the central station 53-1 can shift to the sleep state.

In the processing of the step Sa103, when it is judged that the fifth switching condition is not satisfied (step Sa103—NO), the real-time analysis unit 622 judges whether or not there are other central stations 53 which become the processing targets (step Sa107). Other central stations 53 which become the processing targets are the central stations 53 which are not judged by the fifth switching condition, for example. When it is judged that there are no other central stations 53 which become the processing targets (step Sa107—NO), the real-time analysis unit 622 terminates the processing.

On the other hand, when it is judged that there are other central stations 53 which become the processing targets (step Sa107—YES), the real-time analysis unit 622 selects one central station 53 from other central stations 53 which become the processing targets (step Sa108). Thereafter, the real-time analysis unit 622 executes the processing of the step Sa103 again by using the linkage information obtained from the selected central station 53.

In the above-mentioned example, a case has been described, in which the switching source radio station and the switching source central station are the small cell radio station and the small cell central station, but the similar processing may be performed even if the switching source radio station and the switching source central station are the macro cell radio station and the macro cell central station.

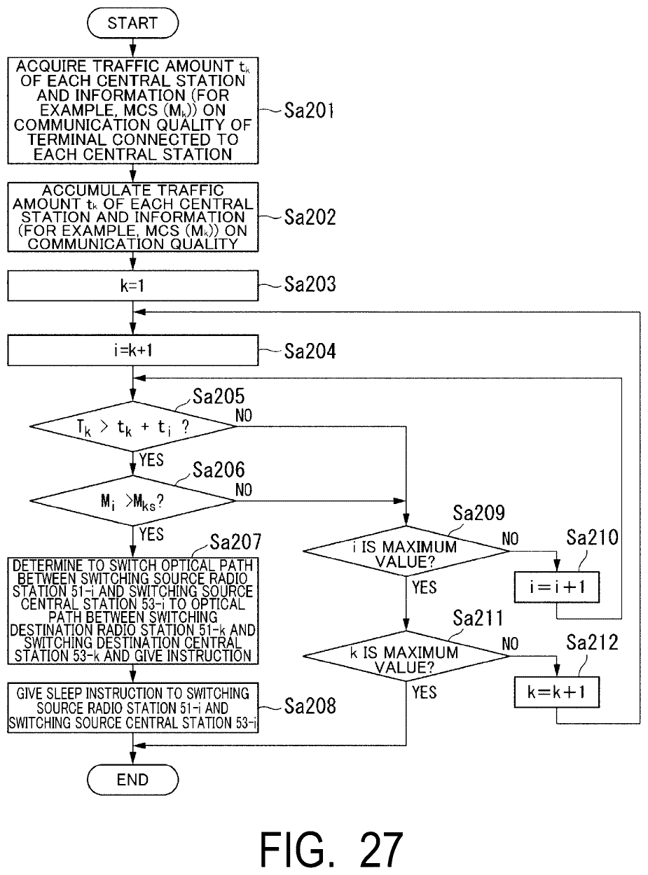

FIG. 27 is a flowchart showing one example of a flow of sleep processing executed by the management control device 60 according to the fifth embodiment. Note that the processing shown in FIG. 27 is the contents in which the processing shown in FIG. 26 is specifically shown, and a case in which there is one terminal 11 connected to each central station 53 will be described.

The acquisition unit 611 acquires the traffic information indicating the traffic amount tₖ of each central station 53 and information (Mₖ) on the communication quality of the terminal 11 connected to each central station 53 as the linkage information (step Sa201). The acquisition unit 611 accumulates the acquired linkage information on each central station 53 in the linkage information accumulation unit 621 (step Sa202). The real-time analysis unit 622 substitutes a value of 1 to the constant k (step Sa203). The real-time analysis unit 622 substitutes a value of (k+1) to the constant i (step Sa204).

The traffic analysis unit 6221 judges whether or not the traffic threshold value Tₖ for the central station 53-k is larger than the total value of the traffic amount tₖ of the central station 53-k and the traffic amount tᵢ of the central station 53-i on the basis of the linkage information (for example, traffic amount tₖ of the central station 53-k) on the central station 53-k, the linkage information (for example, traffic amount tᵢ of the central station 53-i) on the central station 53-i, and the traffic threshold value Tₖ for the central station 53-k accumulated in the linkage information accumulation unit 621 (step Sa205). When the constant k=1 is satisfied, the traffic analysis unit 6221 judges whether or not the traffic threshold value T₁ for the central station 53-1 is larger than the total value of the traffic amount tᵢ of the central station 53-1 and the traffic amount t₂ of the central station 53-2.

When the traffic analysis unit 6221 judges that the traffic threshold value Tₖ for the central station 53-k is larger than the total value of the traffic amount tₖ of the central station 53-k and the traffic amount tᵢ of the central station 53-i (step Sa205—YES), the traffic analysis unit 6221 notifies the communication quality analysis unit 6222 that the condition related to the traffic is satisfied. When receiving the notification from the traffic analysis unit 6221, the communication quality analysis unit 6222 calculates the post-switching communication quality Mᵢ when the terminal 11 connected to the central station 53-i changes the connection to the central station 53-k. For example, the communication quality analysis unit 6222 calculates the post-switching communication quality Mᵢ by using either of the calculation methods of (calculation method 1 of value of post-switching communication quality) or (calculation method 2 of value of post-switching communication quality) described above.

Here, a method of calculating the post-switching communication quality Mᵢ by using (calculation method 1 of value of post-switching communication quality) will be described as an example. First, the communication quality analysis unit 6222 calculates a distance (for example, first distance) between the terminal 11 connected to the switching destination central station (for example, central station 53-k) and the switching destination central station, and a distance (for example, second distance) between the terminal 11 connected to the switching source central station (for example, central station 53-i) and the switching destination central station on the basis of each position information. Note that the position information on each central station 53 and the position information on the terminal 11 connected to each central station 53 may be acquired at the timing of the step Sa201, for example. When the calculated first distance is represented by Lᵢ and the calculated second distance is represented by Lₖ herein, the communication quality analysis unit 6222 calculates the post-switching communication quality Mᵢ on the basis of the following Equation (1). In the Equation (1), Mₖ represents information (for example, MCS) on the communication quality of the terminal 11 connected to the switching destination central station.

$${M}_{i} = {M}_{k} \times ( {L}_{i} / {L}_{k} ) \qquad Equation ( 1 )$$

Note that in the above-mentioned description, although the method of calculating the first distance Lᵢ and the second distance Lₖ on the basis of the distance between the terminal 11 and the central station 53 has been described, the first distance Lᵢ and the second distance Lₖ may be calculated on the basis of the distance between the terminal 11 and the radio station 51. In this case, the communication quality analysis unit 6222 calculates a distance (for example, first distance Lᵢ) between the terminal 11 (for example, terminal 11 connected to the radio station 51-k connected to the switching destination central station) connected to the switching destination central station (for example, central station 53-k) and the radio station 51-k connected to the switching destination central station and a distance (for example, second distance Lₖ) between the terminal 11 (for example, terminal 11 connected to the radio station 51-i connected to the switching source central station) connected to the switching source central station (for example, central station 53-i) and the radio station 51-k connected to the switching destination central station on the basis of each position information. Note that the position information on each radio station 51 and the position information on the terminal 11 connected to each radio station 51 may be acquired at the timing of the step Sa201, for example.

The communication quality analysis unit 6222 judges whether or not the calculated value of the post-switching communication quality Mᵢ is higher than the communication quality threshold value Mₖₛ for the central station 53-k (step Sa206). For example, the communication quality analysis unit 6222 judges whether or not the post-switching communication quality M₂ is better than the communication quality threshold value Mᵢₛ for the central station 53-1 in the communication quality. The conditions indicated by the step Sa205 and the step Sa206 are specific examples of the fifth switching condition.

Although the judgement is performed herein by judging whether or not the value of the post-switching communication quality Mᵢ is higher than the communication quality threshold value Mₖₛ for the central station 53-k, as mentioned above, a smaller value may provide better communication quality depending on the communication quality information. Therefore, when the communication quality indicating that the smaller value indicates the better communication quality is used, the communication quality analysis unit 6222 judges whether or not the calculated value of the post-switching communication quality Mᵢ is smaller than the communication quality threshold value Mₖₛ for the central station 53-k. In the following description, it is assumed that the communication quality is better when the value of the post-switching communication quality Mᵢ is higher than the communication quality threshold value Mₖₛ for the central station 53-k.

When it is judged that the calculated value of the post-switching communication quality Mᵢ is higher than the communication quality threshold value Mₖₛ for the central station 53-k (step Sa206—YES), the communication quality analysis unit 6222 judges that the fifth switching condition is satisfied. In this case, the real-time analysis unit 622 notifies the control unit 63 of the control information including information indicating the central station 53-i which becomes the optical path switching source, information indicating the central station 53-k which becomes the optical path switching destination, and information indicating the radio station 51-i connected to the central station 53-i and the central station 53-i which become the sleep control targets.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-i and the central station 53-i to the optical path between the radio station 51-k and the central station 53-k. The optical path switching control unit 631 transmits the switching destination information including information indicating the radio station 51-k and the central station 53-k which become the determined optical path switching destinations to the transfer device 52. Further, the optical path switching control unit 631 transmits the optical path switching instruction to the radio station 51-i and the central station 53-i which become the determined optical path switching sources (step Sa207).

The sleep control unit 632 determines the radio station 51-i and the central station 53-i which become the sleep control targets on the basis of the control information notified from the real-time analysis unit 622. The sleep control unit 632 transmits the sleep permission notification to the determined radio station 51-i and central station 53-i (step Sa208).

In the processing of the step Sa206, when it is judged that the value of the calculated post-switching communication quality Mᵢ is not higher than the communication quality threshold value Mₖₛ for the central station 53-k (step Sa206—NO), the real-time analysis unit 622 judges that the fifth switching condition is not satisfied. In this case, the real-time analysis unit 622 judges whether or not the constant i is the maximum value (step Sa209). When it is judged that the constant i is not the maximum value (step Sa209—NO), the real-time analysis unit 622 adds a value of 1 to a value of the constant i (step Sa210). Thereafter, the real-time analysis unit 622 executes the processing of the step Sa205 again.

On the other hand, when it is judged that the constant i is the maximum value (step Sa209—YES), the real-time analysis unit 622 judges whether or not the constant k is the maximum value (step Sa211). When it is judged that the constant k is not the maximum value (step Sa211—NO), the real-time analysis unit 622 adds a value of 1 to a value of the constant k (step Sa212). Thereafter, the real-time analysis unit 622 executes the processing of the step Sa205 again. On the other hand, when it is judged that the constant k is the maximum value (step Sa211—YES), the real-time analysis unit 622 terminates the processing.

In the processing of the step Sa205, when it is judged that the traffic threshold value Tₖ for the central station 53-k is equal to or less than the total value of the traffic amount tₖ of the central station 53-k and the traffic amount tᵢ of the central station 53-i (step Sa205—NO), the real-time analysis unit 622 performs the processing of the step Sa209.

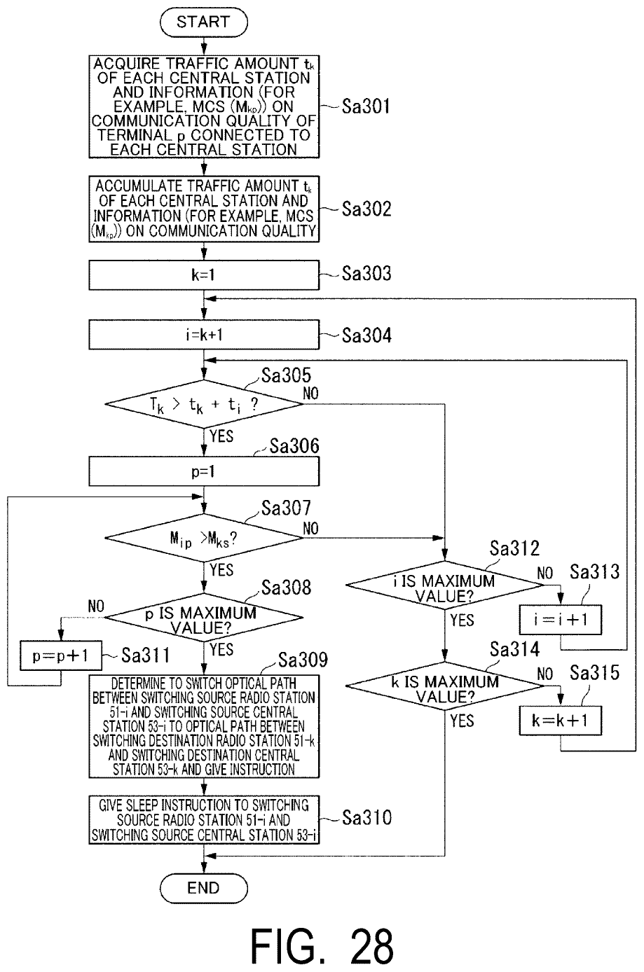

FIG. 28 is a flowchart showing one example of a flow of sleep processing executed by the management control device 60 according to the fifth embodiment. Note that the processing shown in FIG. 28 is the contents in which the processing shown in FIG. 26 is more specifically indicated, and a case in which there is a plurality of terminals 11 connected to each central station 53 will be described.

The acquisition unit 611 acquires the traffic information indicating the traffic amount tₖ of each central station 53 and information (Mₖₚ) on the communication quality of the terminal 11 connected to each central station 53 as the linkage information (step Sa301). Here, p represents the number of terminals 11 connected to the switching source central station. The acquisition unit 611 accumulates the acquired linkage information on each central station 53 in the linkage information accumulation unit 621 (step Sa302). The real-time analysis unit 622 substitutes a value of 1 to the constant k (step Sa303). The real-time analysis unit 622 substitutes a value of (k+1) to the constant i (step Sa304).

The traffic analysis unit 6221 judges whether or not the traffic threshold value Tₖ for the central station 53-k is larger than the total value of the traffic amount tₖ of the central station 53-k and the traffic amount tᵢ of the central station 53-i on the basis of the linkage information (for example, traffic amount tₖ of the central station 53-k) on the central station 53-k, the linkage information (for example, traffic amount tᵢ of the central station 53-i) on the central station 53-i, and the traffic threshold value Tₖ for the central station 53-k accumulated in the linkage information accumulation unit 621 (step Sa305). When the constant k=1 is satisfied, the traffic analysis unit 6221 judges whether or not the traffic threshold value T₁ for the central station 53-1 is larger than the total value of the traffic amount tᵢ of the central station 53-1 and the traffic amount t₂ of the central station 53-2.

When the traffic analysis unit 6221 judges that the traffic threshold value Tₖ for the central station 53-k is larger than the total value of the traffic amount tₖ of the central station 53-k and the traffic amount tᵢ of the central station 53-i (step Sa305—YES), the traffic analysis unit 6221 notifies the communication quality analysis unit 6222 that the condition related to traffic is satisfied. The communication quality analysis unit 6222 substitutes a value of 1 to the constant p (step Sa306).

Thereafter, the communication quality analysis unit 6222 calculates the post-switching communication quality Mᵢₚ when the terminal 11-p connected to the central station 53-i changes the connections to the central station 53-k. For example, the communication quality analysis unit 6222 calculates the post-switching communication quality Mᵢₚ by using either of the calculation methods of (calculation method 1 of value of post-switching communication quality) or (calculation method 2 of value of post-switching communication quality) described above.

As one example, a method for calculating the post-switching communication quality Mᵢ₁ by setting p=1 and using (calculation method 1 of value of post-switching communication quality) will be described. First, the communication quality analysis unit 6222 calculates a distance (for example, first distance) between the terminal 11-1 connected to the switching destination central station (for example, central station 53-k) and the switching destination central station, and a distance (for example, second distance) between the terminal 11-1 connected to the switching source central station (for example, central station 53-i) and the switching destination central station on the basis of each position information. Note that the position information on each central station 53 and the position information on the terminal 11-1 connected to each central station 53 may be acquired at the timing of the step Sa301, for example. When the calculated first distance is represented by Lil and the calculated second distance is represented by Lₖ₁ herein, the communication quality analysis unit 6222 calculates the post-switching communication quality Mᵢ on the basis of the following Equation (2). In the Equation (2), Mₖ₁ represents information (for example, MCS) on the communication quality of the terminal 11-1 connected to the switching destination central station. Note that in the case of p=2, . . . . P (P is the maximum value), the first distance Lᵢₚ and the second distance Lₖₚ are similarly calculated on the basis of the Equation (2′). The Equation (2′) is a generalization of the Equation (2).

$${M}_{i 1} = {M}_{k 1} \times ( {L}_{i 1} / {L}_{k 1} ) \qquad Equation ( 2 )$$

$${M}_{i p} = {M}_{k p} \times ( {L}_{i p} / {L}_{k p} ) \qquad Equation ( 2 ' )$$

Note that in the above-mentioned description, the method of calculating the first distance Lᵢₚ and the second distance Lₖₚ on the basis of the distance between the terminal 11-p and the central station 53 has been described, but the first distance Lᵢ and the second distance Lₖ₁ may be calculated on the basis of the distance between the terminal 11-p and the radio station 51. In this case, the communication quality analysis unit 6222 calculate the distance (for example, first distance Lᵢₚ) between the terminal 11-p (for example, terminal 11-p connected to the radio station 51-k connected to the switching destination central station) connected to the switching destination central station (for example, central station 53-k) and the radio station 51-k connected to the switching destination central station and the distance (for example, second distance Lₖₚ) between the terminal 11-p (for example, terminal 11-p connected to the radio station 51-i connected to the switching source central station) connected to the switching source central station (for example, central station 53-i) and the radio station 51-k connected to the switching destination central station on the basis of each position information. Note that the position information on each radio station 51 and the position information on the terminal 11-p connected to each radio station 51 may be acquired at the timing of the step Sa301, for example.

The communication quality analysis unit 6222 judges whether or not the calculated value of the post-switching communication quality Mᵢₚ is higher than the communication quality threshold value Mₖₛ for the central station 53-k (step Sa307). The conditions indicated by the step Sa305 and the step Sa307 are also specific examples of the fifth switching condition.

Although the judgement is performed by judging whether or not the value of the post-switching communication quality Mᵢₚ is higher than the communication quality threshold value Mₖₛ for the central station 53-k herein, as mentioned above, a smaller value may provide better communication quality depending on the communication quality information. Therefore, when the communication quality indicating that the smaller value indicates the better communication quality is used, the communication quality analysis unit 6222 judges whether or not the calculated value of the post-switching communication quality Mᵢₚ is smaller than the communication quality threshold value Mₖₛ for the central station 53-k. In the following description, it is assumed that the communication quality is better when the value of the post-switching communication quality Mᵢₚ is higher than the communication quality threshold value Mₖₛ for the central station 53-k.

When the communication quality analysis unit 6222 judges that the calculated value of the post-switching communication quality Mᵢₚ is higher than the communication quality threshold value Mₖₛ for the central station 53-k (step Sa307—YES), the communication quality analysis unit 6222 judges whether or not the constant p is the maximum value (step Sa308). When it is judged that the constant p is the maximum value (step Sa308—YES), the communication quality analysis unit 6222 judges that the fifth switching condition is satisfied. By doing this, when all the terminals 11 connected to the switching source central station are connected to the switching destination central station, the communication quality analysis unit 6222 judges whether or not the communication quality of all the terminals 11 is deteriorated. Then, when all the terminals 11 connected to the switching source central station are connected to the switching destination central station and the communication quality is not deteriorated in all the terminals 11, the communication quality analysis unit 6222 judges that the fifth switching condition is satisfied. That is, if even one of the terminals 11 connected to the switching source central station deteriorates the communication quality, the fifth switching condition is not satisfied.

When it is judged that the fifth switching condition is satisfied, the real-time analysis unit 622 notifies the control unit 63 of the control information including information indicating the central station 53-i which becomes the optical path switching source, information indicating the central station 53-k which becomes the optical path switching destination, and information indicating the radio station 51-i connected to the central station 53-i and the central station 53-i which become the sleep control targets.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-i and the central station 53-i to the optical path between the radio station 51-k and the central station 53-k. The optical path switching control unit 631 transmits the switching destination information including information indicating the radio station 51-k and the central station 53-k which become the determined optical path switching destinations to the transfer device 52. Further, the optical path switching control unit 631 transmits the optical path switching instruction to the radio station 51-i and the central station 53-i which become the determined optical path switching sources (step Sa309).

The sleep control unit 632 determines the radio station 51-i and the central station 53-i which become the sleep control targets on the basis of the control information notified from the real-time analysis unit 622. The sleep control unit 632 transmits the sleep permission notification to the determined radio station 51-i and central station 53-i (step Sa310).

In the processing of the step Sa308, when it is judged that the constant p is not the maximum value (step Sa308—NO), the real-time analysis unit 622 adds a value of 1 to a value of the constant p (step Sa311). Thereafter, the real-time analysis unit 622 executes the processing of the step Sa307 again.

In the processing of the step Sa307, when it is judged that the calculated value of the post-switching communication quality Mᵢₚ is not higher than the communication quality threshold value Mₖₛ for the central station 53-k (step Sa307—NO), the real-time analysis unit 622 judges that the fifth switching condition is not satisfied. In this case, the real-time analysis unit 622 judges whether or not the constant i is the maximum value (step Sa312). When it is judged that the constant i is not the maximum value (step Sa312—NO), the real-time analysis unit 622 adds a value of 1 to a value of the constant i (step Sa313). Thereafter, the real-time analysis unit 622 executes the processing of the step Sa305 again.

On the other hand, when it is judged that the constant i is the maximum value (step Sa312—YES), the real-time analysis unit 622 judges whether or not the constant k is the maximum value (step Sa314). When it is judged that the constant k is not the maximum value (step Sa314—NO), the real-time analysis unit 622 adds a value of 1 to a value of the constant k (step Sa315). Thereafter, the real-time analysis unit 622 executes the processing of the step Sa304 again. On the other hand, when it is judged that the constant k is the maximum value (step Sa314—YES), the real-time analysis unit 622 terminates the processing.

In the processing of the step Sa305, when it is judged that the traffic threshold value Tₖ for the central station 53-k is equal to or less than the total value of the traffic amount tₖ of the central station 53-k and the traffic amount tᵢ of the central station 53-i (step Sa305—NO), the real-time analysis unit 622 performs the processing of the step Sa312.

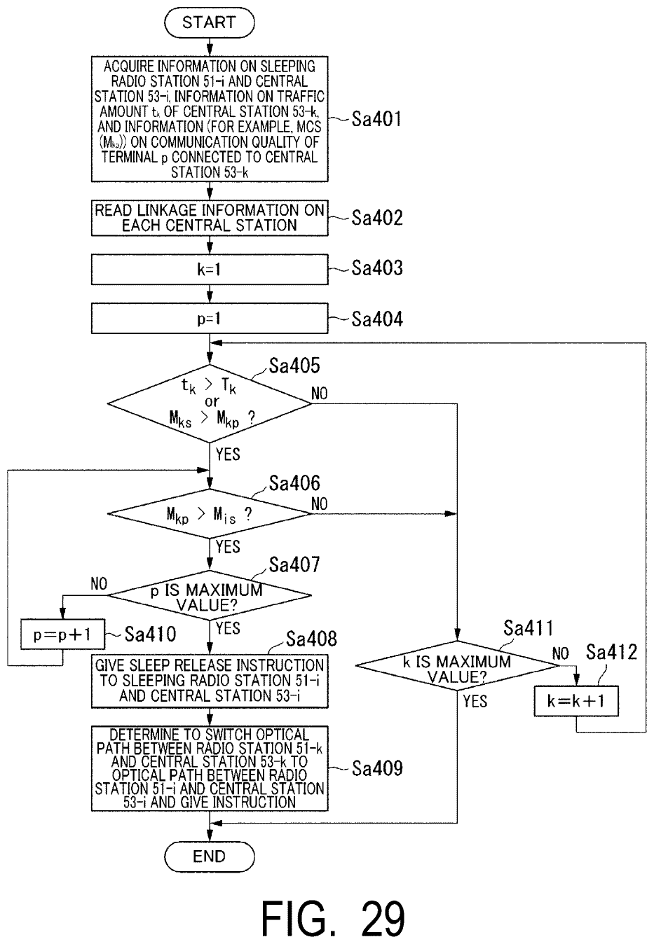

FIG. 29 is a flowchart showing one example of a flow of sleep release processing executed by the management control device 60 according to the fifth embodiment. The acquisition unit 611 acquires the traffic information indicating the traffic amount tₖ of each central station 53-k, information indicating the sleeping radio station 51-i and central station 53-i, and the communication quality information on the terminal 11-p connected to the central station 53-k as the linkage information (step Sa401). The acquisition unit 611 accumulates the acquired traffic information, information indicating the sleeping radio station 51-i and central station 53-i, and communication quality information in the linkage information accumulation unit 621.

The real-time analysis unit 622 reads the linkage information from the linkage information accumulation unit 621 (step Sa402). The real-time analysis unit 622 substitutes a value of 1 to the constant k (step Sa403). The real-time analysis unit 622 substitutes a value of 1 to the constant p (step Sa404). The traffic analysis unit 6221 compares the traffic amount tₖ of the central station 53-k with the traffic threshold value Tₖ for the central station 53-k. The communication quality analysis unit 6222 compares the communication quality value Mₖₚ of the terminal 11-p connected to the central station 53-k with the communication quality threshold value Mₖₛ for the central station 53-k.

The real-time analysis unit 622 judges whether or not the traffic amount tₖ of the central station 53-k is larger than the traffic threshold value Tₖ for the central station 53-k or the communication quality value Mₖₚ of the terminal 11-p connected to the central station 53-k is worse than the communication quality value Mₖₛ for the central station 53-k (step Sa405). In this case, when the communication quality value is lower than the communication quality threshold value Mₖₛ for the central station 53-k, it is assumed that the communication quality is bad. The condition represented by tₖ>Tₖ or Mₖₛ>Mₖₚ is a specific example of the fifth sleep release condition.

When the traffic amount tₖ of the central station 53-k is larger than the traffic threshold value Tₖ for the central station 53-k or the communication quality value Mₖₚ of the terminal 11-p connected to the central station 53-k is worse than the communication quality threshold value Mₖₛ for the central station 53-k (step Sa405—YES), the real-time analysis unit 622 judges that the fifth sleep release condition is satisfied. In this way, when either of the case where the traffic amount flowing to the central station 53-k is large or the case where the communication quality of the terminal 11-p connected to the central station 53-k is bad is satisfied, the real-time analysis unit 622 judges that the fifth sleep release condition is satisfied.

When the real-time analysis unit 622 judges that the fifth sleep release condition is satisfied (step Sa405—YES), the real-time analysis unit 622 calculates the post-switching communication quality Mₖₚ when the terminal 11-p connected to the central station 53-k changes the connections to the central station 53-i. The real-time analysis unit 622 judges whether or not the calculated value of the post-switching communication quality Mₖₚ is higher than the communication quality threshold value Mᵢₛ for the central station 53-i (step Sa406).

Although the judgement is performed by judging whether or not the value of the post-switching communication quality Mₖₚ is higher than the communication quality threshold value Mᵢₛ for the central station 53-i herein, as mentioned above, a smaller value may provide better communication quality depending on the communication quality information. Therefore, when the communication quality indicating that the smaller value indicates the better communication quality is used, the real-time analysis unit 622 should judge whether or not the calculated value of the post-switching communication quality Mₖₚ is smaller than the communication quality threshold value Mᵢₛ for the central station 53-i. In the following description, it is assumed that the communication quality is better when the value of the post-switching communication quality Mₖₚ is higher than the communication quality threshold value Mᵢₛ for the central station 53-i.

When the real-time analysis unit 622 judges that the calculated value of the post-switching communication quality Mₖₚ is higher than the communication quality threshold value Mᵢₛ for the central station 53-i (step Sa406—YES), the real-time analysis unit 622 judges whether or not the constant p is the maximum value (step Sa407). When the real-time analysis unit 622 judges that the constant p is the maximum value (step Sa407—YES), the real-time analysis unit 622 notifies the control unit 63 of the control information including information indicating the central station 53-k which becomes the optical path switching source, the central station 53-i which becomes the optical path switching destination, and information indicating the radio station 51-i connected to the central station 53-i and the central station 53-i which become the sleep control targets.

The sleep control unit 632 transmits the sleep release instruction to the sleeping radio station 51-i and central station 53-i on the basis of the control information notified from the real-time analysis unit 622 (step Sa408). By doing this, the radio station 51-i and the central station 53-i are released from the sleep state.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-k and the central station 53-k to the optical path between the radio station 51-i and the central station 53-i. The optical path switching control unit 631 transmits the switching destination information including information indicating the radio station 51-i and the central station 53-i which become the determined optical path switching destinations to the transfer device 52. Further, the optical path switching control unit 631 transmits the optical path switching instruction to the radio station 51-k and the central station 53-k which become the determined optical path switching sources (step Sa409). Since the connections of the terminals are changed by the optical path switching, the optical path switching control unit 631 may instruct the central station 53-k to change the connections of the terminals 11.

In the processing of the step Sa407, when it is judged that the constant p is not the maximum value (step Sa407—NO), the real-time analysis unit 622 adds a value of 1 to a value of the constant p (step Sa410). Thereafter, the real-time analysis unit 622 executes the processing of the step Sa406 again.

In the processing of the step Sa406, when the real-time analysis unit 622 judges that the calculated value of the post-switching communication quality Mₖₚ is lower than the communication quality threshold value Mᵢₛ for the central station 53-i (step Sa406—NO), the real-time analysis unit 622 judges whether or not the constant k is the maximum value (step Sa411).

When it is judged that the constant k is not the maximum value (step Sa411—NO), the real-time analysis unit 622 adds a value of 1 to a value of the constant k (step Sa412). Thereafter, the real-time analysis unit 622 executes the processing of the step Sa405 again. On the other hand, when it is judged that the constant k is the maximum value (step Sa411—YES), the real-time analysis unit 622 terminates the processing.

When the real-time analysis unit 622 judges that the fifth sleep release condition is not satisfied (step Sa405—NO), the real-time analysis unit 622 executes the processing after the step Sa411.

According to the mobile NW system 200 configured as described above, the management control device 60 includes the linkage information collection unit 61 that acquires the linkage information including information on the communication quality of the terminal 11 connected to each central station in addition to the traffic amount from each central station 53 at a predetermined period or at arbitrary timing, the analysis unit 62 that determines whether or not the optical path switching is necessary on the basis of the linkage information, the optical path switching control unit 631 that controls the optical path switching when it is determined that the optical path switching is necessary, and the sleep control unit 632 that shifts the radio station 51 and the central station 53 in which the optical path switching has been performed to the sleep state after the optical path switching is performed. The management control device 60 judges whether or not the optical path switching is necessary in consideration of not only the traffic amount but also the communication quality of the terminal 11 after the connection switching. In this way, the communication quality of the terminal 11 after the connection switching can be guaranteed. Therefore, it is possible to suppress the power consumption while satisfying the delay requirement.

### Sixth Embodiment

In a sixth embodiment, a configuration including the base station in which the radio station, the distribution station, and the aggregation station are integrated will be described.

### Outline of Sixth Embodiment

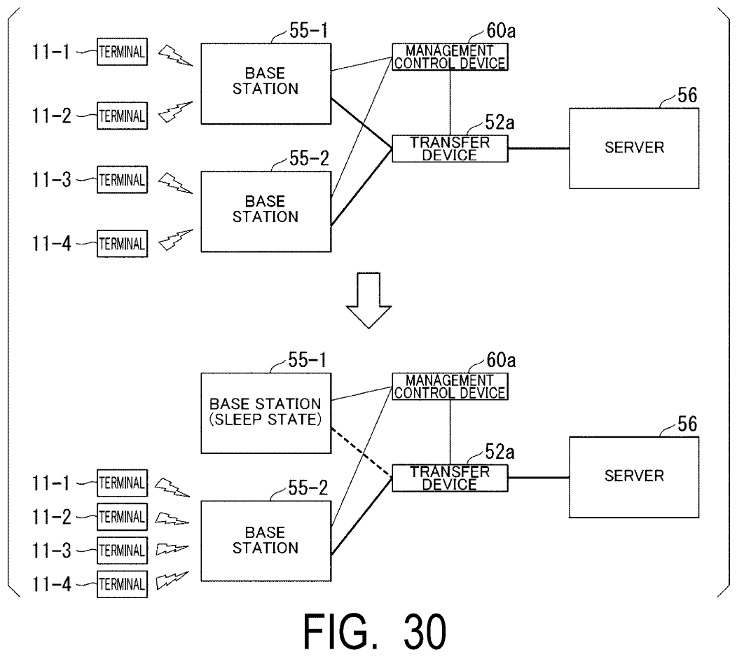

FIG. 30 is a diagram for explaining an outline of processing of a mobile NW system according to the sixth embodiment. First, an entire configuration of the mobile NW system according to the sixth embodiment will be described. The mobile NW system according to the sixth embodiment is one example of the communication system. The mobile NW system according to the sixth embodiment is 5G, for example. The mobile NW system according to the sixth embodiment includes a transfer device 52a, a plurality of base stations 55-1 and 55-2, one or more servers 56, and a management control device 60a.

The base stations 55-1 and 55-2 and the transfer device 52a, and the transfer device 52a and the server 56 are connected by the optical fibers for transmitting optical signals. The transfer device 52a and the management control device 60a, and the base stations 55-1 and 55-2 and the management control device 60a are connected by the optical fibers or the electric lines for transmitting the electric signals.

In an example shown in FIG. 30, the base stations 55 are two and the server 56 is one. The number of base stations 55 and server 56 is not particularly limited. Note that a plurality of transfer devices 52a may be provided, the following explanation will be given by taking a case of one transfer device as an example. The base station 55 is a small cell base station and a macro cell base station similar to the first embodiment to the fourth embodiment. For example, the base station 55-1 may be a small cell base station, and the base station 55-2 may be a macro cell base station, and the above may be reversed.

The base station 55 is a device in which the radio station, the distribution station, and the aggregation station are integrated. For example, the base station 55, which is a small cell base station, is a device in which the small cell radio station, the small cell central station, and the aggregation station are integrated. For example, the base station 55, which is a macro cell base station, is a device in which the macro cell radio station, the macro cell central station, and the aggregation station are integrated. In FIG. 30, it is assumed that the base station 55-1 is the small cell base station and the base station 55-2 is the macro cell base station.

The base station 55-1 is a base station installed in a communication area formed by the base station 55-2. The base station 55-1 forms a smaller range communication area than a communication area formed by the base station 55-2. The base station 55-1 includes one or more antennas, and performs the radio communication with the terminal 11 located in the communication area. For example, the base station 55-1 transmits the signal transmitted from the terminal 11 to the server 56 through the transfer device 52a. The base station 55-1 transmits the linkage information to the management control device 60a. The base station 55-1 transmits the signal received through the transfer device 52a to the terminal 11.

When the base station 55-1 includes a plurality of antennas, the base station 55-1 may perform the radio communication with the terminal 11 by beam forming. The base station 55-1 shifts to the sleep state in accordance with the sleep instruction transmitted from the management control device 60a. The base station 55-1 releases the sleep state in accordance with the sleep release instruction transmitted from the management control device 60a. Further, the base station 55-1 performs the optical path switching in accordance with the optical path switching instruction transmitted from the management control device 60a. When receiving the optical path switching instruction, the base station 55-1 does not set the optical path with the transfer device 52a.

The base station 55-2 is a base station that forms a larger range communication area than a communication area formed by the base station 55-1. The base station 55-2 includes one or more antennas, and performs the radio communication with the terminal 11 located in the communication area. For example, the base station 55-2 transmits the signal transmitted from the terminal 11 to the server 56 through the transfer device 52a. The base station 55-2 transmits the linkage information to the management control device 60a. The base station 55-2 transmits the signal received through the transfer device 52a to the terminal 11.

When the base station 55-2 includes the plurality of antennas, the base station 55-2 may perform the radio communication with the terminal 11 by beam forming. The base station 55-2 shifts to the sleep state in accordance with the sleep instruction transmitted from the management control device 60a. The base station 55-2 releases the sleep state in accordance with the sleep release instruction transmitted from the management control device 60a. Further, the base station 55-2 performs the optical path switching in accordance with the optical path switching instruction transmitted from the management control device 60a. When receiving the optical path switching instruction, the base station 55-2 does not set the optical path with the transfer device 52a.

The transfer device 52a is provided between the base station 55 and the server 56. The transfer device 52a performs the optical path switching in accordance with the optical path switching destination information transmitted from the management control device 60a. The transfer device 52a switches the connections between the base station 55 and the server 56 by switching the optical paths. For example, when receiving the optical path switching destination information transmitted from the management control device 60a, the transfer device 52a instructs the switching so that the optical path is connected between the base station 55 and the server 56 which become the optical path switching destinations.

The linkage information according to the sixth embodiment includes the traffic information on each base station 55 and information (hereinafter referred to as “communication quality information”) on the communication quality of the terminal 11 connected to each base station 55, for example. Note that the traffic information and the communication quality information are similar to those in the fifth embodiment. Further, the base station 55-1 performs the optical path switching in accordance with the optical path switching instruction transmitted from the management control device 60a. When receiving the optical path switching start instruction after receiving the optical path switching instruction, the base station 55-1 stops the setting of the optical path with the transfer device 52a.

The management control device 60a is a device that manages an entire mobile NW system 200a. The management control device 60a acquires the linkage information from each base station 55. The management control device 60a determines whether or not the optical path switching and the sleep control are necessary on the basis of the acquired linkage information. When it is determined that the optical path switching and the sleep control are necessary, the management control device 60a performs the optical path switching control processing and the sleep control processing.

Next, an outline of processing of the mobile NW system will be described.

An upper figure in FIG. 30 represents a connection state of the mobile NW system before the optical path switching, and a lower figure in FIG. 30 represents the connection state of the mobile NW system after the optical path switching. In the upper diagram of FIG. 30, the terminals 11-1 and 11-2 are connected to the base station 55-1, the base station 55-1 is connected to the server 56 through the transfer device 52a, the terminals 11-3 and 11-4 are connected to the base station 55-2, and the base station 55-2 is connected to the server 56 through the transfer device 52a.

The management control device 60a judges whether or not the optical path switching control processing is performed on the basis of the linkage information collected from each base station 55. In an example of FIG. 30, the management control device 60a judges whether or not the optical path between the base station 55-1 and the transfer device 52a is switched to between the base station 55-2 and the transfer device 52a. The management control device 60a compares the traffic threshold value with the traffic amount indicated by the traffic information included in the collected linkage information. Further, the management control device 60a compares the communication quality threshold value with the value based on the communication quality information included in the collected linkage information. The traffic threshold value and the communication quality threshold value may be different for each base station 55, may be calculated from the linkage information, or may be held in advance by the management control device 60a.

The management control device 60a according to the sixth embodiment calculates the total value of the traffic amount of the switching source base station (base station 55-1) and the traffic amount of the switching destination base station (base station 55-2), and compares the total value of the calculated traffic amounts with the traffic threshold value of the switching destination base station (base station 55-2). Then, when the total value of the traffic amounts is smaller than the traffic threshold value of the switching destination base station (base station 55-2), the management control device 60a performs the comparison based on the communication quality information. The management control device 60a may compare the traffic amount after comparing the communication quality.

The comparison based on the communication quality information according to the sixth embodiment is performed by comparing the value of the post-switching communication quality, which is communication quality when the terminal 11 connected to the switching source base station switches connections to the switching destination base station, with the communication quality threshold value of the switching destination base station, for example. The value of the post-switching communication quality according to the sixth embodiment is calculated as follows.

### (Calculation Method 1 of Value of Post-switching Communication Quality)

The management control device 60a acquires the position information on the switching destination base station, the position information on the terminal 11 connected to the switching destination base station, the position information on the terminal 11 connected to the switching source base station, and information (for example, MCS) on the communication quality of the terminal 11 connected to the switching source base station. Note that the position information may be included in the linkage information or may be requested from the management control device 60a to each base station 55. The management control device 60a calculates a distance (for example, first distance) between the terminal 11 connected to the switching destination base station and the switching destination base station, and a distance (for example, second distance) between the terminal 11 connected to the switching source base station and the switching destination base station on the basis of the position information. The management control device 60a compares the first distance with the second distance, and calculates the value (value of MCS) of the post-switching communication quality when the terminal 11 connected to the switching source base station is connected to the switching destination base station.

### (Calculation Method 2 of Value of Post-switching Communication Quality)

The management control device 60a acquires reception power of the switching destination base station, reception power of the terminal 11 connected to the switching destination base station, reception power of the terminal 11 connected to the switching source base station, and information (for example, MCS) on the communication quality of the terminal 11 connected to the switching source base station. Note that the reception power may be included in the linkage information or may be requested from the management control device 60a to each base station 55. The management control device 60a compares the reception power of the terminal 11 connected to the switching destination base station, the reception power of the switching destination base station, and the reception power of the terminal 11 connected to the switching source base station, and calculates the value (value of MCS) of the post-switching communication quality when the terminal 11 connected to the switching source base station is connected to the switching destination base station.

When the total value of the traffic amounts is smaller than the traffic threshold value of the switching destination base station (base station 55-2) and the value indicated by the communication quality information indicates that the communication quality is good in the comparison with the communication quality threshold value as a result of the above-mentioned comparison, the management control device 60a according to the sixth embodiment judges that the optical path switching control processing is performed. When the total value of the traffic amounts is smaller than the traffic threshold value of the switching destination base station (base station 55-2), it means that the processing is possible even if the terminals 11 connected to the switching source base station (base station 55-1) are aggregated to the switching destination base station (base station 55-2).

When the total value of the traffic amounts is higher than the traffic threshold value of the switching destination base station (base station 55-2) or the value based on the communication quality information indicates that the communication quality is bad in the comparison with the communication quality threshold value, the management control device 60a judges that the optical path switching control processing is not performed. When the total value of the traffic amounts is higher than the traffic threshold value of the switching destination base station (base station 55-2) and the terminals 11 connected to the switching source base station (base station 55-1) are aggregated to the switching destination base station (base station 55-2), the traffic amount flowing to the switching destination base station (base station 55-2) is large and the possibility of processing is disabled. When it is indicated that the communication quality is bad, it means that the communication quality of the terminal 11 is deteriorated and the delay is increased when the terminals 11 connected to the switching source base station (base station 55-1) are aggregated to the switching destination base station (base station 55-2).

When it is judged that the optical path switching control processing is performed, the management control device 60a transmits information on the optical path switching destination to the transfer device 52a, and instructs the optical path switching to the base station 55 which becomes the optical path switching target. Note that since the connection destinations of the terminals 11 are changed by the optical path switching, the management control device 60a may instruct the base station 55 which becomes the optical path switching target to change the connections. The transfer device 52a switches the optical paths of the base station 55 in accordance with the instruction from the management control device 60a. The transfer device 52a notifies the management control device 60a of the optical path switching completion after the optical path switching is completed. The base station which becomes the optical path switching target performs the optical path switching in accordance with the instruction from the management control device 60a.

When the optical path switching control processing is completed, the management control device 60a transmits the sleep permission notification to the base station 55 which become the target to be shifted to the sleep state. By doing this, the base station 55 which becomes the target to be shifted to the sleep state shifts to the sleep state. In the above-mentioned description, the configuration has been described, in which the management control device 60a performs the sleep control processing after the optical path switching control processing is completed, but the management control device 60a may perform the optical path switching control processing after the sleep control processing is completed. In the following description, a configuration will be described, in which the sleep control processing is performed after the optical path switching control processing is completed, as an example.

The lower figure in FIG. 30 shows an example in which the terminals 11-1 to 11-4 are connected to the base station 55-2 and the base station 55-1 is shifted to the sleep state. By doing this, in the mobile NW system according to the sixth embodiment, the optical paths are switched on the basis of the linkage information collected from each base station 55. Then, the unused base station 55-1 is shifted to the sleep state.

### Detail of Sixth Embodiment

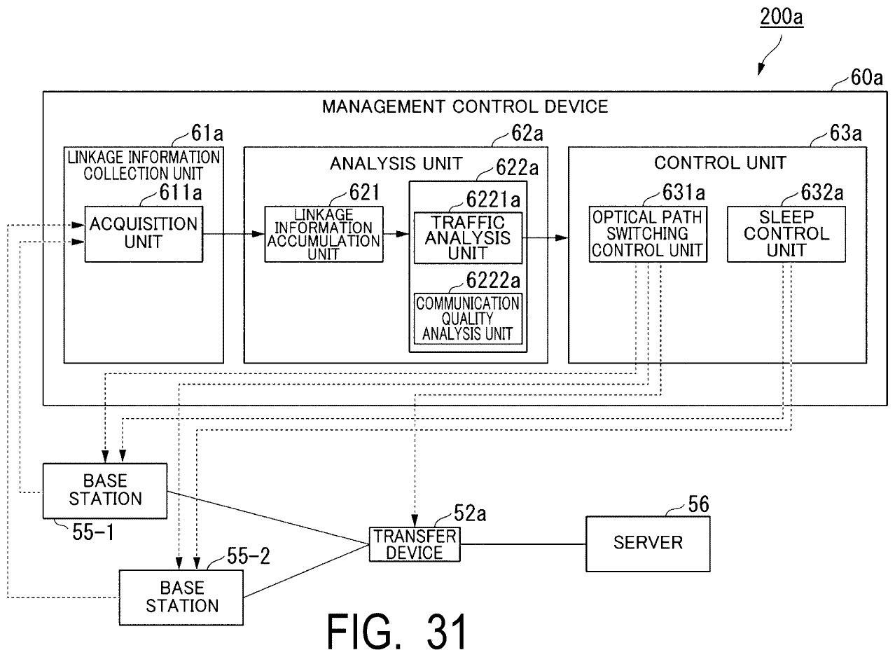

FIG. 31 is a diagram showing a configuration example of a mobile NW system 200a according to the sixth embodiment. The mobile NW system 200a according to the sixth embodiment includes a transfer device 52a, a plurality of base stations 55-1 and 55-2, one or more servers 56, and a management control device 60a. In the following description, a case in which the mobile NW system 200a includes two base stations 55 and one server 56 will be described as an example.

The base station 55 is one aspect of a first base station and a second base station. For example, when the base station 55-1 is the first base station, the base station 55-2 is the second base station, and when the base station 55-1 is the second base station, the base station 55-2 is the first base station. In the present invention, the optical path switching and the sleep control of either a small cell base station or a macro cell base station are performed.

Therefore, when the switching source base station is a small cell base station, the switching destination base station becomes a macro cell base station, and when the switching source base station is a macro cell base station, the switching destination base station becomes a small cell base station. Note that since the configuration of the base station 55 has been described in FIG. 30, description thereof will be omitted.

The management control device 60a includes a linkage information collection unit 61a, an analysis unit 62a, and a control unit 63a. An acquisition unit 611a collects the linkage information from each base station 55 at a predetermined period or at arbitrary timing. For example, the acquisition unit 611a collects the traffic information and the communication quality information on each base station 55 as the linkage information.

The analysis unit 62a includes a linkage information accumulation unit 621 and a real-time analysis unit 622a. The linkage information accumulation unit 621 records the collected linkage information in a predetermined storage device. The real-time analysis unit 622a analyzes the communication state between each base station 55 and the terminal 11 on the basis of the linkage information. Specifically, the real-time analysis unit 622a judges whether or not the optical path switching and the sleep control are necessary on the basis of the linkage information.

The real-time analysis unit 622a includes a traffic analysis unit 6221a and a communication quality analysis unit 6222a. The traffic analysis unit 6221a compares the traffic threshold value with the traffic amount indicated by the traffic information included in the collected linkage information. The traffic analysis unit 6221a holds the traffic threshold value for each base station 55. That is, the traffic analysis unit 6221a holds the traffic threshold value for the base station 55-1 and the traffic threshold value for the base station 55-2.

The communication quality analysis unit 6222a compares the communication quality threshold value with the value indicated by the communication quality information included in the collected linkage information. The communication quality analysis unit 6222a holds the communication quality threshold value for each base station 55. That is, the communication quality analysis unit 6222a holds the communication quality threshold value for the base station 55-1 and the communication quality threshold value for the base station 55-2.

Note that when a plurality of base stations 55 is provided, the real-time analysis unit 622a may hold the traffic threshold values and the communication quality threshold values different for each base station 55, or may hold one traffic threshold value and communication quality threshold value common to all the base stations 55.

The real-time analysis unit 622a judges whether or not a sixth switching condition is satisfied as a result of the comparison. The sixth switching condition is a condition indicating that the optical path switching between the switching source base station and the switching source base station is necessary. The sixth switching condition is that the total value of the traffic amount of the switching source base station and the traffic amount of the switching destination base station is smaller than the traffic threshold value of the switching destination base station, and the value of the post-switching communication quality is good in the comparison with the communication quality threshold value of the switching destination base station. In other words, the sixth switching condition is that the traffic threshold value of the switching destination base station is equal to or greater than the total value, and the value of the post-switching communication quality is good in the comparison with the communication quality threshold value of the switching destination base station.

When the sixth switching condition is satisfied, the real-time analysis unit 622a judges that the optical path switching control processing is performed. On the other hand, when the sixth switching condition is not satisfied, the management control device 60a judges that the optical path switching control processing is not performed. When it is judged that the optical path switching control processing is performed, the real-time analysis unit 622a notifies the control unit 63a of the control information including information indicating the base station (switching source base station) which becomes the optical path switching source, information indicating the base station (switching destination base station) which becomes the optical path switching destination, and information indicating the base station 55 which becomes the sleep control target. When shifting to the sleep, the base station 55 which becomes the sleep control target is the switching source base station.

Further, the real-time analysis unit 622a judges whether or not a sixth sleep release condition is satisfied as a result of the comparison. The sixth sleep release condition is a condition indicating that the sleep of the sleeping base station 55 is released. The sixth sleep release condition is either when the traffic amount of the non-sleeping base station 55 is larger than the traffic threshold value for the non-sleeping base station 55 or when the communication quality of the terminal 11 connected to the non-sleeping base station 55 does not satisfy the communication quality threshold value, for example.

When the traffic amount of the non-sleeping base station 55 is larger than the traffic threshold value for the non-sleeping base station 55, it means that the traffic amount flowing to the non-sleeping base station 55 is large. When the communication quality of the terminal 11 connected to the non-sleeping base station 55 does not satisfy the communication quality threshold value, it means that the communication quality of the terminal 11 connected to the non-sleeping base station 55 is bad.

When the sixth sleep release condition is satisfied, the real-time analysis unit 622a judges that the optical path switching control processing is performed. On the other hand, when the sixth sleep release condition is not satisfied, the real-time analysis unit 622a judges that the optical path switching control processing is not performed. When it is judged that the optical path switching control processing is performed, the real-time analysis unit 622a notifies the control unit 63a of the control information including information indicating the base station (switching source base station) which becomes the optical path switching source, information indicating the base station (switching destination base station) which becomes the optical path switching destination, and information indicating the base station 55 which becomes the sleep control target. When releasing the sleep, the base station 55 which becomes the sleep control target is the switching destination base station.

The control unit 63a includes an optical path switching control unit 631a and a sleep control unit 632a. The optical path switching control unit 631a determines the base station 55 which becomes the optical path switching source and the base station 55 which becomes the optical path switching destination on the basis of the analysis result of the real-time analysis unit 622a. For example, the optical path switching control unit 631a determines the base station 55 which becomes the optical path switching source on the basis of information indicating the base station 55 which becomes the optical path switching source included in the control information notified from the real-time analysis unit 622a. For example, the optical path switching control unit 631a determines the base station 55 which becomes the optical path switching destination on the basis of information indicating the base station 55 which becomes the optical path switching destination included in the control information notified from the real-time analysis unit 622a. The optical path switching control unit 631a holds information on the base station 55.

The optical path switching control unit 631a transmits the switching destination information including information indicating the base station 55 which becomes the determined optical path switching destination to the transfer device 52a. By doing this, the optical path switching control unit 631a instructs the optical path switching to the transfer device 52a. Further, the optical path switching control unit 631a transmits the optical path switching instruction to the base station 55 which becomes the determined optical path switching source.

The sleep control unit 632a causes the base station 55 which becomes the sleep control target to execute the sleep or release the sleep on the basis of the analysis result of the real-time analysis unit 622a.

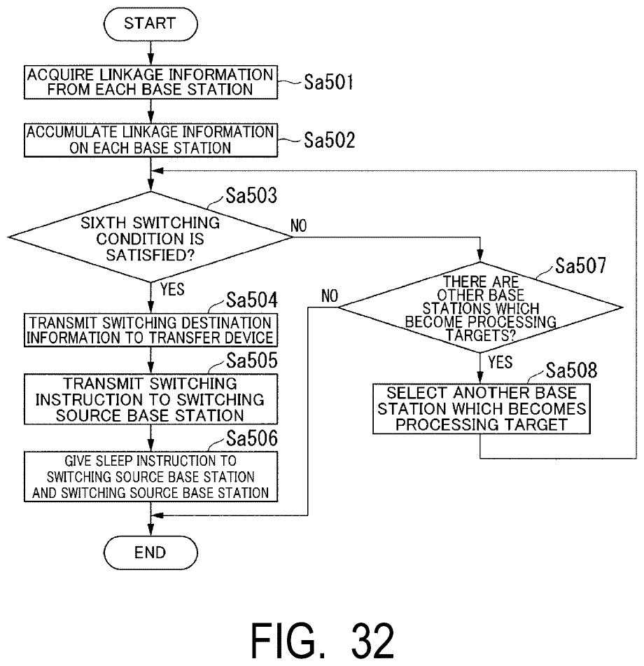

FIG. 32 is a flowchart showing one example of a flow of sleep processing executed by the management control device 60a according to the sixth embodiment. The flow of the processing in FIG. 32 is repeatedly executed with a predetermined period. Here, it is assumed that the switching source base station is a small cell base station. Therefore, the switching destination base station becomes a macro cell base station.

The acquisition unit 611a acquires the linkage information from each base station 55 (Step Sa501). For example, the acquisition unit 611a acquires the linkage information from each of the base stations 55-1 and 55-2. The acquisition unit 611a collects the linkage information at arbitrary timing or at every unit time. The unit time herein refers to slot length, sub-frame length, frame length, 1 millisecond, 1 second, 1 minute, and the like, for example. The acquisition unit 611a accumulates the acquired linkage information on each base station 55 in the linkage information accumulation unit 621 (step Sa502). The real-time analysis unit 622a judges whether or not the sixth switching condition is satisfied on the basis of the linkage information on each base station 55 and the switching determination threshold value (for example, traffic amount threshold value and communication quality threshold value) accumulated in the linkage information accumulation unit 621 (step Sa503).

As an example, when the switching source base station is the base station 55-1 and the switching destination base station is the base station 55-2, the traffic analysis unit 6221a first calculates the total value of the traffic amount of the base station 55-1 and the traffic amount of the base station 55-2. Next, the traffic analysis unit 6221a compares the calculated total value with the traffic threshold value for the base station 55-2. When the total value is equal to or more than the traffic threshold value for the base station 55-2 herein, the traffic analysis unit 6221a judges that the sixth switching condition is not satisfied.

On the other hand, when the total value is less than the traffic threshold value for the base station 55-2, the traffic analysis unit 6221a notifies the communication quality analysis unit 6222a that the condition related to the traffic is satisfied. The communication quality analysis unit 6222a compares the value of the post-switching communication quality when the terminal 11 connected to the base station 55-1 switches connections to the base station 55-2 with the communication quality threshold value for the base station 55-2. Here, when the post-switching communication quality indicates that the communication quality is bad in the comparison with the communication quality threshold value for the base station 55-2, the communication quality analysis unit 6222a judges that the sixth switching condition is not satisfied. On the other hand, when the post-switching communication quality indicates that the communication quality is good in the comparison with the communication quality threshold value for the base station 55-2, the communication quality analysis unit 6222a judges that the sixth switching condition is satisfied.

Note that although the comparison by the communication quality is performed after the comparison by the traffic is performed in this case, the comparison by the traffic may be performed after the comparison by the communication quality is performed. Even in this case, when the post-switching communication quality indicates that the communication quality is good in the comparison with the communication quality threshold value for the base station 55-2 and the total value is less than the traffic threshold value for the base station 55-2, the real-time analysis unit 622a judges that the sixth switching condition is satisfied.

When it is judged that the sixth switching condition is satisfied (step Sa503—YES), the real-time analysis unit 622a notifies the control unit 63a of the control information. The optical path switching control unit 631a determines the base station 55 which becomes the optical path switching destination on the basis of the control information notified from the real-time analysis unit 622a. Here, it is assumed that the optical path switching control unit 631a determines the base station 55-2 as the optical path switching destination. The optical path switching control unit 631a transmits the switching destination information including information indicating the base station 55-2 which becomes the determined optical path switching destination to the transfer device 52a (step Sa504). By doing this, the optical path switching control unit 631a instructs to switch the optical path between the switching source base station (for example, base station 55-2) and the transfer device 52a to the optical path between the base station 55-2 and the transfer device 52a.

Further, the optical path switching control unit 631a determines the base station 55 which becomes the optical path switching source on the basis of the control information notified from the real-time analysis unit 622a. Here, it is assumed that the optical path switching control unit 631a determines the base station 55-1 as the optical path switching source. The optical path switching control unit 631a transmits the optical path switching instruction to the base station 55-1 which becomes the determined optical path switching source (step Sa505). By doing this, the optical path switching control unit 631a controls the optical path between the switching source base station (for example, base station 55-1) and the transfer device 52a.

The sleep control unit 632a determines the base station 55 which becomes the sleep control target on the basis of the control information notified from the real-time analysis unit 622a. Here, the sleep control unit 632a determines the base station 55-1 as the sleep control target. The sleep control unit 632a transmits the sleep permission notification to the determined base station 55-1 (step Sa506). For example, when the optical path switching completion notification is obtained from the base station 55-1, the sleep control unit 632a may transmit the sleep permission notification. By doing this, the base station 55-1 can shift to the sleep state.

In the processing of the step Sa503, when it is judged that the sixth switching condition is not satisfied (step Sa503—NO), the real-time analysis unit 622a judges whether or not there are other base stations 55 which become the processing targets (step Sa507). Other base stations 55 which become the processing targets are the base stations 55 which are not judged by the sixth switching condition, for example. When it is judged that there are no other base stations 55 which become the processing targets (step Sa507—NO), the real-time analysis unit 622a terminates the processing.

On the other hand, when it is judged there are other base stations 55 which become the processing targets (step Sa507—YES), the real-time analysis unit 622a selects one base station 55 among other base stations 55 which become the processing targets (step Sa508). Thereafter, the real-time analysis unit 622a executes the processing of the step Sa503 again by using the linkage information obtained from the selected base station 55.

In the above-mentioned example, the case where the switching source base station is a small cell base station has been described, but even if the switching source base station is a macro cell base station, similar processing may be performed.

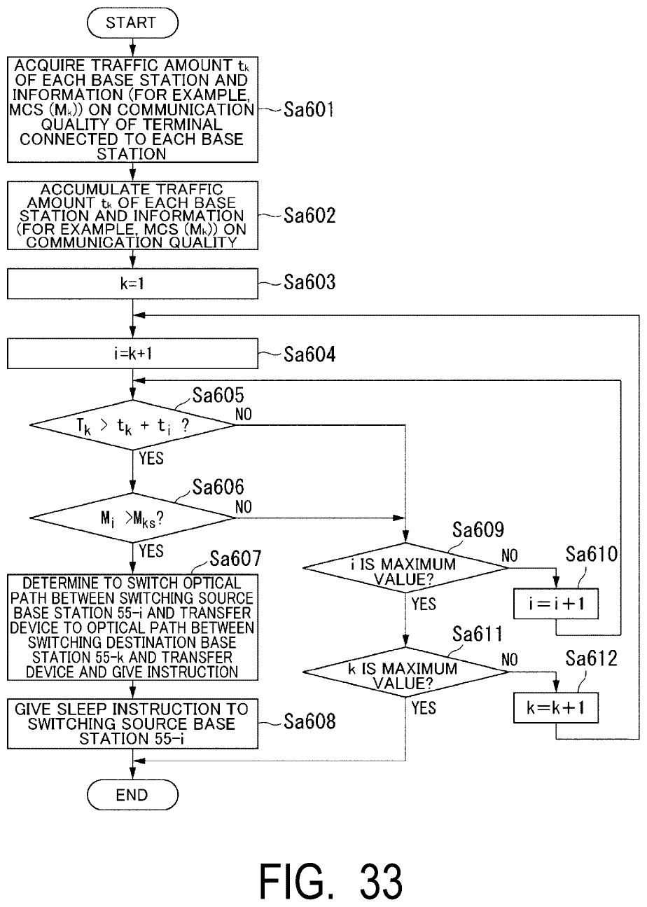

FIG. 33 is a flowchart showing one example of a flow of sleep processing executed by the management control device 60a according to the sixth embodiment. Note that the processing shown in FIG. 33 is the contents in which the processing shown in FIG. 32 is specifically shown, and the case where there is one terminal 11 connected to each base station 55 will be described.

The acquisition unit 611a acquires the traffic information indicating the traffic amount tₖ of each base station 55 and information (Mₖ) on the communication quality of the terminal 11 connected to each base station 55 as the linkage information (step Sa601). The acquisition unit 611a accumulates the acquired linkage information on each base station 55 in the linkage information accumulation unit 621 (step Sa602). The real-time analysis unit 622a substitutes a value of 1 to the constant k (step Sa603). The real-time analysis unit 622a substitutes a value of (k+1) to the constant i (step Sa604).

The traffic analysis unit 6221a judges whether or not the traffic threshold value Tₖ for the base station 55-k is larger than the total value of the traffic amount tₖ of the base station 55-k and the traffic amount tᵢ of the base station 55-i on the basis of the linkage information (for example, traffic amount tₖ of the base station 55-k) on the base station 55-k, the linkage information (for example, traffic amount tᵢ of the base station 55-i) on the base station 55-i, and the traffic threshold value Tₖ for the base station 55-k accumulated in the linkage information accumulation unit 621 (step Sa605). When the constant k=1 is satisfied, the traffic analysis unit 6221a judges whether or not the traffic threshold value T₁ for the base station 55-1 is larger than the total value of the traffic amount t₁ of the base station 55-1 and the traffic amount t₂ of the base station 55-2.

When the traffic analysis unit 6221a judges that the traffic threshold value Tₖ for the base station 55-k is larger than the total value of the traffic amount tₖ of the base station 55-k and the traffic amount tᵢ of the base station 55-i (step Sa605—YES), the traffic analysis unit 6221a notifies the communication quality analysis unit 6222a that the condition related to the traffic is satisfied. When receiving the notification from the traffic analysis unit 6221, the communication quality analysis unit 6222a calculates the post-switching communication quality Mᵢ when the terminal 11 connected to the base station 55-i changes the connections to the base station 55-k. For example, the communication quality analysis unit 6222a calculates the post-switching communication quality Mᵢ by using either of the calculation methods of (calculation method 1 of value of post-switching communication quality) or (calculation method 2 of value of post-switching communication quality) described above.

Here, a method of calculating the post-switching communication quality Mᵢ by using (calculation method 1 of value of post-switching communication quality) will be described as an example. First, the communication quality analysis unit 6222a calculates a distance (for example, first distance) between the terminal 11 connected to the switching destination base station (for example, base station 55-k) and the switching destination base station and a distance (for example, second distance) between the terminal 11 connected to the switching source base station (for example, base station 55-i) and the switching destination base station on the basis of each position information. Note that the position information on each base station 55 and the position information on the terminal 11 connected to each base station 55 may be acquired at the timing of step Sa601, for example. When the calculated first distance is represented by Lᵢ and the calculated second distance is represented by Lx herein, the communication quality analysis unit 6222a calculates the post-switching communication quality Mᵢ on the basis of the following Equation (3). In the Equation (3), Mₖ represents information (for example, MCS) on the communication quality of the terminal 11 connected to the switching destination base station.

$${M}_{i} = {M}_{k} \times ( {L}_{i} / {L}_{k} ) \qquad Equation ( 3 )$$

The communication quality analysis unit 6222a judges whether or not the calculated post-switching communication quality Mᵢ is higher than the communication quality threshold value Mₖₛ for the base station 55-k (step Sa606). For example, the communication quality analysis unit 6222a judges whether or not the post-switching communication quality M₂ is better than the communication quality threshold value Mᵢₛ for the base station 55-1 in the communication quality. The condition shown in the step Sa605 and step Sa606 are specific examples of the sixth switching condition.

Although the judgement is performed herein by judging whether or not the value of the post-switching communication quality Mᵢ is higher than the communication quality threshold value Mₖₛ for the base station 55-k, as mentioned above, a smaller value may provide better communication quality depending on the communication quality information. Therefore, when the communication quality indicating that the smaller value indicates the better communication quality is used, the communication quality analysis unit 6222a judges whether or not the calculated value of the post-switching communication quality Mᵢ is smaller than the communication quality threshold value Mₖₛ for the base station 55-k. In the following description, it is assumed that the communication quality is better when the value of the post-switching communication quality Mᵢ is higher than the communication quality threshold value Mₖₛ for the base station 55-k.

When it is judged that the calculated value of the post-switching communication quality Mᵢ is higher than the communication quality threshold value Mₖₛ for the base station 55-k (step Sa606—YES), the communication quality analysis unit 6222a judges that the sixth switching condition is satisfied. In this case, the real-time analysis unit 622a notifies the control unit 63 of the control information including information indicating the base station 55-i which becomes the optical path switching source, information indicating the base station 55-k which becomes the optical path switching destination, and information indicating the base station 55-i connected to the base station 55-i which becomes the sleep control target.

The optical path switching control unit 631a determines the base station 55 which becomes the optical path switching source and the base station 55 which becomes the optical path switching destination on the basis of the control information notified from the real-time analysis unit 622a. By doing this, the optical path switching control unit 631a determines to switch the optical path between the base station 55-i and the transfer device 52a to the optical path between the base station 55-k and the transfer device 52a. The optical path switching control unit 631a transmits the switching destination information including information indicating the base station 55-k which becomes the determined optical path switching destination to the transfer device 52a. Further, the optical path switching control unit 631a transmits the optical path switching instruction to the base station 55-i which becomes the determined optical path switching source (step Sa607).

The sleep control unit 632a determines the base station 55-i which becomes the sleep control target on the basis of the control information notified from the real-time analysis unit 622a. The sleep control unit 632a transmits the sleep permission notification to the determined base station 55-i (step Sa608).

In the processing of the step Sa606, when it is judged that the value of the calculated post-switching communication quality Mᵢ is not higher than the communication quality threshold value Mₖₛ for the base station 55-k (step Sa606—NO), the real-time analysis unit 622a judges that the sixth switching condition is not satisfied. In this case, the real-time analysis unit 622a judges whether or not the constant i is the maximum value (step Sa609). When it is judged that the constant i is not the maximum value (step Sa609—NO), the real-time analysis unit 622a adds a value of 1 to a value of the constant i (step Sa610). Thereafter, the real-time analysis unit 622a executes the processing of the step Sa605 again.

On the other hand, when it is judged that the constant i is the maximum value (step Sa609—YES), the real-time analysis unit 622a judges whether or not the constant k is the maximum value (step Sa611). When it is judged that the constant k is not the maximum value (step Sa611—NO), the real-time analysis unit 622a adds a value of 1 to a value of the constant k (step Sa612). Thereafter, the real-time analysis unit 622a executes the processing of the step Sa605 again. On the other hand, when it is judged that the constant k is the maximum value (step Sa611—YES), the real-time analysis unit 622a terminates the processing.

In the processing of the step Sa605, when it is judged that the traffic threshold value Tₖ for the base station 55-k is equal to or less than the total value of the traffic amount tₖ of the base station 55-k and the traffic amount tᵢ of the base station 55-i (step Sa605—NO), the real-time analysis unit 622a performs the processing of the step Sa609.

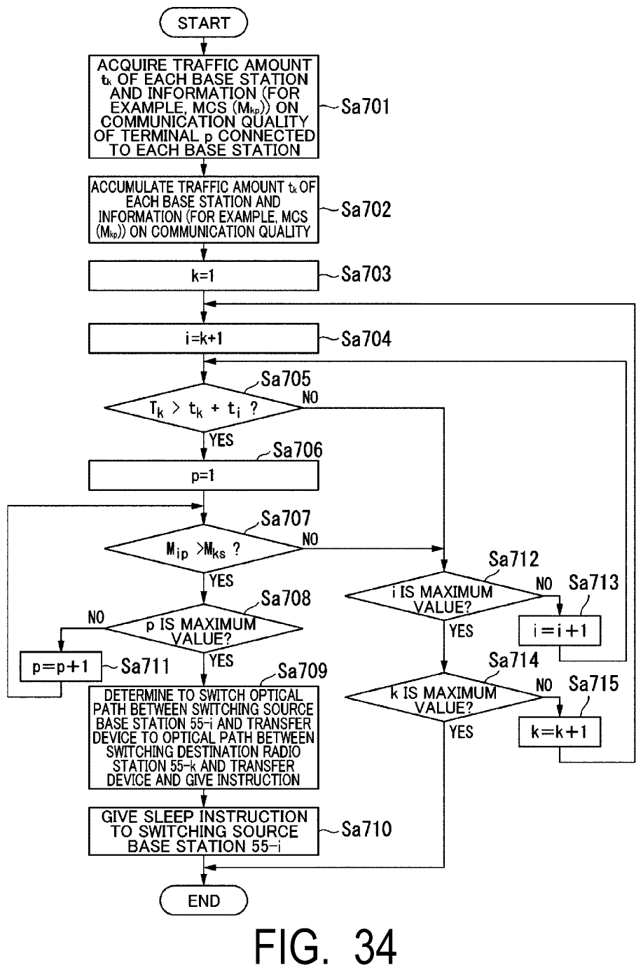

FIG. 34 is a flowchart showing one example of a flow of sleep processing executed by the management control device 60a according to the sixth embodiment. Note that the processing shown in FIG. 34 is the contents in which the processing shown in FIG. 32 is more specifically shown, and the case where there is a plurality of terminals 11 connected to each base station 55 will be described.

The acquisition unit 611a acquires the traffic information indicating the traffic amount tₖ of each base station 55 and information (Mₖₚ) on the communication quality of the terminal 11 connected to each base station 55 as the linkage information (step Sa701). Here, p represents the number of terminals 11 connected to the switching source base station. The acquisition unit 611a accumulates the acquired linkage information on each base station 55 in the linkage information accumulation unit 621 (step Sa702). The real-time analysis unit 622a substitutes a value of 1 to the constant k (step Sa703). The real-time analysis unit 622a substitutes a value of (k+1) to the constant i (step Sa704).

The traffic analysis unit 6221a judges whether or not the traffic threshold value Tₖ for the base station 55-k is larger than the total value of the traffic amount tₖ of the base station 55-k and the traffic amount tᵢ of the base station 55-i on the basis of the linkage information (for example, traffic amount tₖ of the base station 55-k) on the base station 55-k, the linkage information (for example, traffic amount tᵢ of the base station 55-i) on the base station 55-i, and the traffic threshold value Tₖ for the base station 55-k accumulated in the linkage information accumulation unit 621 (step Sa705). When the constant k=1 is satisfied, the traffic analysis unit 6221a judges whether or not the traffic threshold value T₁ for the base station 55-1 is larger than the total value of the traffic amount tᵢ of the base station 55-1 and the traffic amount t₂ of the base station 55-2.

When the traffic analysis unit 6221a judges that the traffic threshold value Tₖ for the base station 55-k is larger than the total value of the traffic amount tₖ of the base station 55-k and the traffic amount tᵢ of the base station 55-i (step Sa705—YES), the traffic analysis unit 6221a notifies the communication quality analysis unit 6222a that the condition related to the traffic is satisfied. The communication quality analysis unit 6222a substitutes a value of 1 to the constant p (step Sa706).

Thereafter, the communication quality analysis unit 6222a calculates the post-switching communication quality Mᵢₚ when the terminal 11-p connected to the base station 55-i changes the connections to the base station 55-k. For example, the communication quality analysis unit 6222a calculates the post-switching communication quality Mᵢₚ by using either of the calculation methods of (calculation method 1 of value of post-switching communication quality) or (calculation method 2 of value of post-switching communication quality) described above.

As one example, a method for calculating the post-switching communication quality Mil by setting p=1 and using (calculation method 1 of value of post-switching communication quality) will be described. First, the communication quality analysis unit 6222a calculates a distance (for example, first distance) between the terminal 11-1 connected to the switching destination base station (for example, base station 55-k) and the switching destination base station and a distance (for example, second distance) between the terminal 11-1 connected to the switching source base station (for example, base station 55-i) and the switching destination base station on the basis of each position information. Note that the position information on each base station 55 and the position information on the terminal 11-1 connected to each base station 55 may be acquired at the timing of the step Sa701, for example. When the calculated first distance is represented by Lin and the calculated second distance is represented by Lₖ₁ herein, the communication quality analysis unit 6222a calculates the post-switching communication quality Mil on the basis of the following Equation (4). In the Equation (4), Mₖ₁ represents information (for example, MCS) on the communication quality of the terminal 11-1 connected to the switching destination base station. Note that in the case of p=2, . . . . P (P is the maximum value), the first distance Lᵢₚ and the second distance Lₖₚ are similarly calculated on the basis of the Equation (4′). The Equation (4′) is a generalization of the Equation (4).

$${M}_{i 1} = {M}_{k 1} \times ( {L}_{i 1} / {L}_{k 1} ) \qquad Equation ( 4 )$$

$${M}_{i p} = {M}_{k p} \times ( {L}_{i p} / {L}_{k p} ) \qquad Equation ( 4 ' )$$

The communication quality analysis unit 6222a judges whether or not the calculated value of the post-switching communication quality Mᵢₚ is higher than the communication quality threshold value Mₖₛ for the base station 55-k (step Sa707). The conditions indicated by steps Sa705 and Sa707 are also specific examples of the sixth switching condition.

Although the judgement is performed by judging whether or not the value of the post-switching communication quality Mᵢₚ is higher than the communication quality threshold value Mₖₛ for the base station 55-k herein, as mentioned above, a smaller value may provide better communication quality depending on the communication quality information. Therefore, when the communication quality indicating that the smaller value indicates the better communication quality is used, the communication quality analysis unit 6222a judges whether or not the calculated value of the post-switching communication quality Mᵢₚ is smaller than the communication quality threshold value Mₖₛ for the base station 55-k. In the following description, it is assumed that the communication quality is better when the value of the post-switching communication quality Mᵢₚ is higher than the communication quality threshold value Mₖₛ for the base station 55-k.

When the communication quality analysis unit 6222a judges that the calculated value of the post-switching communication quality Mᵢₚ is higher than the communication quality threshold value Mₖₛ for the base station 55-k (step Sa707—YES), the communication quality analysis unit 6222a judges whether or not the constant p is the maximum value (step Sa708). When it is judged that the constant p is the maximum value (step Sa708—YES), the communication quality analysis unit 6222a judges that the sixth switching condition is satisfied. In this way, when all the terminals 11 connected to the switching source base station are connected to the switching destination base station, the communication quality analysis unit 6222a judges whether or not the communication quality is deteriorated in all the terminals 11. Then, when all the terminals 11 connected to the switching source base station are connected to the switching destination base station and the communication quality is not deteriorated in all the terminals 11, the communication quality analysis unit 6222a judges that the sixth switching condition is satisfied. That is, if even one of the terminals 11 connected to the switching source base station deteriorates the communication quality, the sixth switching condition is not satisfied.

When it is judged that the sixth switching condition is satisfied, the real-time analysis unit 622a notifies the control unit 63a of the control information including information indicating the base station 55-i which becomes the optical path switching source, information indicating the base station 55-k which becomes the optical path switching destination, and information indicating the base station 55-i which becomes the sleep control target.

The optical path switching control unit 631a determines the base station 55 which becomes the optical path switching source and the base station 55 which becomes the optical path switching destination on the basis of the control information notified from the real-time analysis unit 622a. By doing this, the optical path switching control unit 631a determines to switch the optical path between the base station 55-i and the transfer device 52a to the optical path between the base station 55-k and the transfer device 52a. The optical path switching control unit 631a transmits the switching destination information including information indicating the base station 55-k which becomes the determined optical path switching destination to the transfer device 52a. Further, the optical path switching control unit 631a transmits the optical path switching instruction to the base station 55-i which becomes the determined optical path switching source (step Sa709).

The sleep control unit 632a determines the base station 55-i which becomes the sleep control target on the basis of the control information notified from the real-time analysis unit 622a. The sleep control unit 632a transmits the sleep permission notification to the determined base station 55-i (step Sa710).

In the processing of the step Sa708, when it is judged that the constant p is not the maximum value (step Sa708—NO), the real-time analysis unit 622a adds a value of 1 to a value of the constant p (step Sa711). Thereafter, the real-time analysis unit 622a executes the processing of the step Sa707 again.

In the processing of the step Sa707, when it is judged that the calculated value of the post-switching communication quality Mᵢₚ is not higher than the communication quality threshold value Mₖₛ for the base station 55-k (step Sa707—NO), the real-time analysis unit 622a judges that the sixth switching condition is not satisfied. In this case, the real-time analysis unit 622a judges whether or not the constant i is the maximum value (step Sa712). When it is judged that the constant i is not the maximum value (step Sa712—NO), the real-time analysis unit 622a adds a value of 1 to a value of the constant i (step Sa713). Thereafter, the real-time analysis unit 622a executes the processing of the step Sa705 again.

On the other hand, when it is judged that the constant i is the maximum value (step Sa712—YES), the real-time analysis unit 622a judges whether or not the constant k is the maximum value (step Sa714). When it is judged that the constant k is not the maximum value (step Sa714—NO), the real-time analysis unit 622a adds a value of 1 to a value of the constant k (step Sa715). Thereafter, the real-time analysis unit 622a executes the processing of the step Sa704 again. On the other hand, when it is judged that the constant k is the maximum value (step Sa714—YES), the real-time analysis unit 622a terminates the processing.

In the processing of the step Sa705, when it is judged that the traffic threshold value Tₖ for the base station 55-k is equal to or less than the total value of the traffic amount tₖ of the base station 55-k and the traffic amount tᵢ of the base station 55-i (step Sa705—NO), the real-time analysis unit 622a performs the processing of the step Sa712.

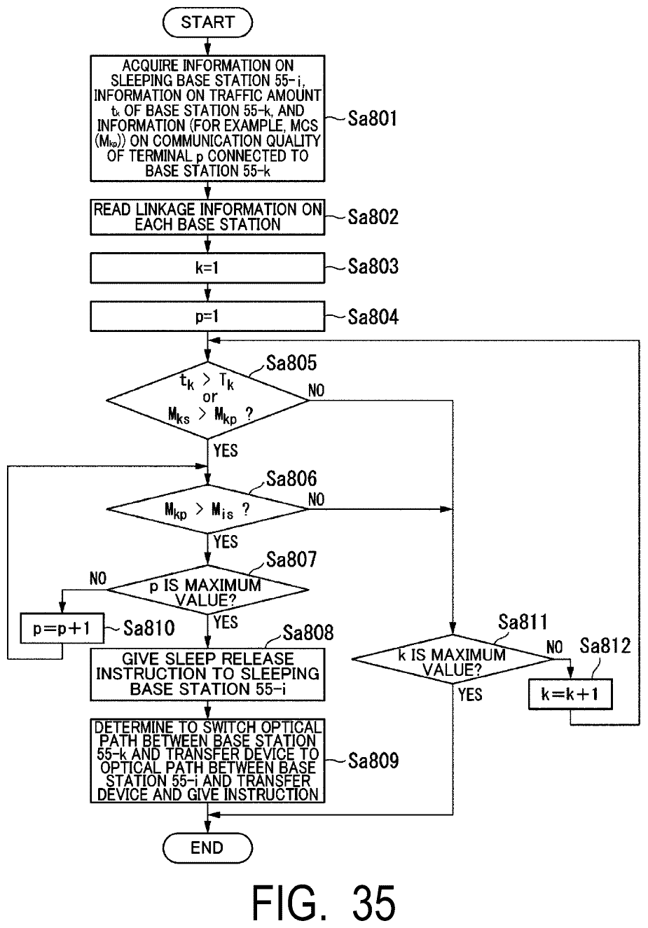

FIG. 35 is a flowchart showing one example of a flow of sleep release processing executed by the management control device 60a according to the sixth embodiment. The acquisition unit 611a acquires the traffic information indicating the traffic amount tₖ of each base station 55-k, information indicating the sleeping base station 55-i, and the communication quality information on the terminal 11-p connected to the base station 55-k as the linkage information (step Sa801). The acquisition unit 611a accumulates the acquired traffic information, information indicating the sleeping base station 55-i, and communication quality information in the linkage information accumulation unit 621.

The real-time analysis unit 622a reads the linkage information from the linkage information accumulation unit 621 (step Sa802). The real-time analysis unit 622a substitutes a value of 1 to the constant k (step Sa803). The real-time analysis unit 622a substitutes a value of 1 to the constant p (step Sa804). The traffic analysis unit 6221a compares the traffic amount tₖ of the base station 55-k with the traffic threshold value Tₖ for the base station 55-k. The communication quality analysis unit 6222a compares the value Mₖₚ of the communication quality of the terminal 11-p connected to the base station 55-k with the communication quality threshold value Mₖₛ for the base station 55-k.

The real-time analysis unit 622a judges whether or not the traffic amount tₖ of the base station 55-k is larger than the traffic threshold value Tₖ for the base station 55-k or the value Mₖₚ of the communication quality of the terminal 11-p connected to the base station 55-k is worse than the communication quality threshold value Mₖₛ for the base station 55-k (step Sa805). In this case, when the communication quality is lower than the communication quality threshold value Mₖₛ for the base station 55-k, it is assumed that the communication quality is bad. The condition represented by tₖ>Tₖ or Mₖₛ>Mᵢₚ is a specific example of the sixth sleep release condition.

When the traffic amount tₖ of the base station 55-k is larger than the traffic threshold value Tₖ for the base station 55-k or the value Mₖₚ of the communication quality of the terminal 11-p connected to the base station 55-k is worse than the communication quality threshold value Mₖₛ for the base station 55-k (step Sa805—YES), the real-time analysis unit 622a judges that the sixth sleep release condition is satisfied. By doing this, when either of the case in which the traffic amount flowing to the base station 55-k is large or the case in which the communication quality of the terminal 11-p connected to the base station 55-k is bad is satisfied, the real-time analysis unit 622a judges that the sixth sleep release condition is satisfied.

When the real-time analysis unit 622a judges that the sixth sleep release condition is satisfied (step Sa805—YES), the real-time analysis unit 622a calculates the post-switching communication quality Mₖₚ when the terminal 11-p connected to the base station 55-k changes the connections to the base station 55-i. The real-time analysis unit 622a judges whether or not the calculated value of the post-switching communication quality Mₖₚ is higher than the communication quality threshold value Mᵢₛ for the base station 55-i (step Sa806).

Although the judgement is performed by judging whether or not the value of the post-switching communication quality Mₖₚ is higher than the communication quality threshold value Mᵢₛ for the base station 55-i herein, as mentioned above, a smaller value may provide better communication quality depending on the communication quality information. Therefore, when the communication quality indicating that the smaller value indicates the better communication quality is used, the real-time analysis unit 622a judges whether or not the calculated value of the post-switching communication quality Mₖₚ is smaller than the communication quality threshold value Mᵢₛ for the base station 55-i. In the following description, it is assumed that the communication quality is better when the value of the post-switching communication quality Mₖₚ is higher than the communication quality threshold value Mᵢₛ for the base station 55-i.

When the real-time analysis unit 622a judges that the calculated value of the post-switching communication quality Mₖₚ is higher than the communication quality threshold value Mᵢₛ for the base station 55-i (step Sa806—YES), the real-time analysis unit 622a judges whether or not the constant p is the maximum value (step Sa807). When the real-time analysis unit 622a judges that the constant p is the maximum value (step Sa807—YES), the real-time analysis unit 622a notifies the control unit 63a of the control information including information indicating the base station 55-k which becomes the optical path switching source, the base station 55-i which becomes the optical path switching destination, and information indicating the base station 55-i which becomes the sleep control target.

The sleep control unit 632a transmits the sleep release instruction to the sleeping base station 55-i on the basis of the control information notified from the real-time analysis unit 622a (step a808). By doing this, the base station 55-i is released from the sleep state.

The optical path switching control unit 631a determines the base station 55 which becomes the optical path switching source and the base station 55 which becomes the optical path switching destination on the basis of the control information notified from the real-time analysis unit 622a. By doing this, the optical path switching control unit 631a determines to switch the optical path between the base station 55-k and the transfer device 52a to the optical path between the base station 55-i and the transfer device 52a. The optical path switching control unit 631a transmits the switching destination information including information indicating the base station 55-i which becomes the determined optical path switching destination to the transfer device 52a. Further, the optical path switching control unit 631a transmits the optical path switching instruction to the base station 55-k which becomes the determined optical path switching source (step Sa809). Since the connections of the terminals are changed by the optical path switching, the optical path switching control unit 631a may instruct the base station 55-k to change the connections of the terminal 11.

In the processing of the step Sa807, when it is judged that the constant p is not the maximum value (step Sa807—NO), the real-time analysis unit 622a adds a value of 1 to a value of the constant p (step Sa810). Thereafter, the real-time analysis unit 622a executes the processing of the step Sa806 again.

In the processing of the step Sa806, when the real-time analysis unit 622a judges that the calculated value of the post-switching communication quality Mₖₚ is lower than the communication quality threshold value Mᵢₛ for the base station 55-i (step Sa806—NO), the real-time analysis unit 622a judges whether or not the constant k is the maximum value (step Sa811).

When it is judged that the constant k is not the maximum value (step Sa811—NO), the real-time analysis unit 622a adds a value of 1 to a value of the constant k (step Sa812). Thereafter, the real-time analysis unit 622a executes the processing of the step Sa805 again. On the other hand, when it is judged that the constant k is the maximum value (step Sa811—YES), the real-time analysis unit 622a terminates the processing.

When the real-time analysis unit 622a judges that the sixth sleep release condition is not satisfied (step Sa805—NO), the real-time analysis unit 622a executes the processing after the step Sa811.

According to the mobile NW system 200a configured as described above, the management control device 60a includes the linkage information collection unit 61a that acquires the linkage information including information on the communication quality of the terminal 11 connected to each base station 55 in addition to the traffic amount from each base station 55 at a predetermined period or at arbitrary timing, the analysis unit 62a that determines whether or not the optical path switching is necessary on the basis of the linkage information, the optical path switching control unit 631a that controls the optical path switching when it is determined that the optical path switching is necessary, and the sleep control unit 632a that shifts the base station 55 in which the optical path switching is performed to the sleep state after the optical path switching is performed. By doing this, the management control device 60a determines whether or not the optical path switching is necessary in consideration of not only the traffic amount but also the communication quality of the terminal 11 after the connection switching. By doing this, the communication quality of the terminal 11 after the connection switching can be guaranteed. Therefore, it is possible to suppress the power consumption while satisfying the delay requirement.

### Modification Example 1 Common to Fifth Embodiment to Sixth Embodiment

Although the description has been made on the assumption that the communication area of the small cell is formed in the communication area of the macro cell in each embodiment shown in the fifth embodiment to the sixth embodiment, a communication area other than the small cell may be formed in the communication area of the macro cell. The communication area other than the small cell is a smaller range communication area than the communication area of the macro cell such as a communication area of a femtocell or a communication area of a picocell, for example.

### Modification Example 2 Common to Fifth Embodiment to Sixth Embodiment

In each embodiment shown in the fifth embodiment to the sixth embodiment, the configuration is shown, in which the radio station 51 (for example, switching source radio station) and the central station 53 (for example, switching source central station) which become the sleep targets or the base station 55 (for example, switching source base station) which becomes the sleep target are shifted to the sleep after the optical path switching is completed in FIG. 26 to FIG. 29 and FIG. 32 to FIG. 35. Specifically, the configuration is shown, in which the management control device 60 shifts the radio station 51 (for example, switching source radio station) and the central station 53 (for example, switching source central station) which become the sleep targets to the sleep after the optical path switching is completed (for example, after the optical path switching instruction is transmitted) and the management control device 60a shifts the base station 55 (for example, switching source base station) which becomes the sleep target to the sleep after the optical path switching is completed (for example, after the optical path switching instruction is transmitted).

On the other hand, the mobile NW systems 200 and 200a in FIG. 26 to FIG. 29 and FIG. 32 to FIG. 35 may be configured so that the optical path switching is performed after the radio station 51 (for example, switching source radio station) and the central station 53 (for example, switching source central station) which become the sleep targets or the base station 55 which becomes the sleep target are shifted to the sleep (for example, after the sleep instruction is transmitted). In such a configuration, the management control device 60 performs the optical path switching after shifting the radio station 51 (for example, switching source radio station) and the central station 53 (for example, switching source central station) which become the sleep targets to the sleep (for example, after the sleep instruction is transmitted). The management control device 60a execute the optical path switching after shifting the base station 55 (for example, switching source base station) which becomes the sleep target to the sleep (for example, after the sleep instruction is transmitted).

### Modification Example 3 Common to Fifth Embodiment to Sixth Embodiment

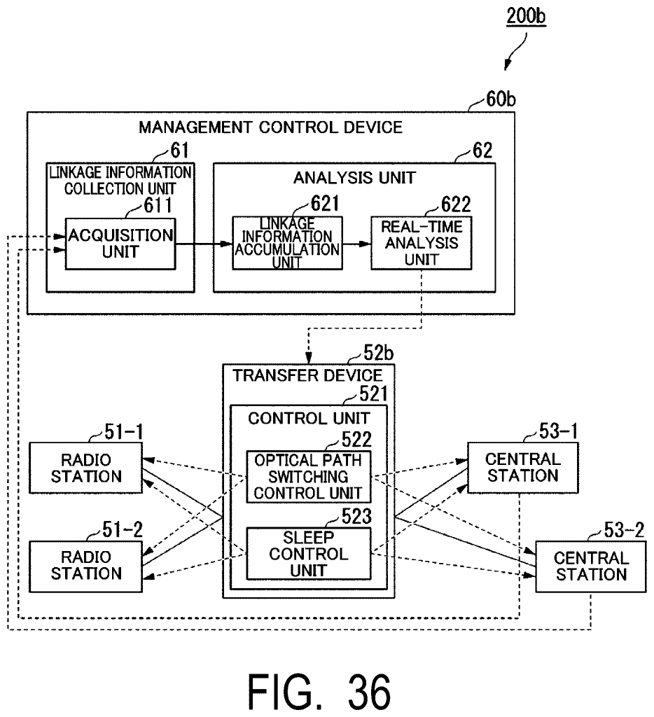

In each embodiment shown in the fifth embodiment to the sixth embodiment, the configuration is shown, in which the management control devices 60 and 60a perform the optical path switching control processing and the sleep control processing. On the other hand, the transfer device may be configured so as to perform the optical path switching control processing and the sleep control processing. Here, the fifth embodiment will be described as an example. FIG. 36 is a diagram showing a configuration example of a mobile NW system 200b according to a modification example 3 of the fifth embodiment. The mobile NW system 200b includes a plurality of radio stations 51-1 and 51-2, a transfer device 52b, a plurality of central stations 53-1 and 53-2, and a management control device 60b.

As shown in FIG. 36, the transfer device 52b includes a control unit 521, and the management control device 60b does not include the control units 63 and 63a. The real-time analysis unit 622 of the management control device 60b notifies the transfer device 52b of the control information. Note that the real-time analysis unit 622 may notify the transfer device 52b of the control information only when the optical path switching and the sleep control are performed. The control unit 521 of the transfer device 52b performs the optical path switching control processing and the sleep control processing on the basis of the control information notified from the management control device 60b.

The control unit 521 of the transfer device 52b includes an optical path switching control unit 522 and a sleep control unit 523. The optical path switching control unit 522 performs the processing similar to that of the optical path switching control unit 631. The sleep control unit 523 performs the processing similar to that of the sleep control unit 632. Note that when the configuration shown in FIG. 36 is applied to the mobile NW system 200a according to the sixth embodiment, the radio station 51-1 and the central station 53-1 shown in FIG. 36 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

### Modification Example 4 Common to Fifth Embodiment to Sixth Embodiment

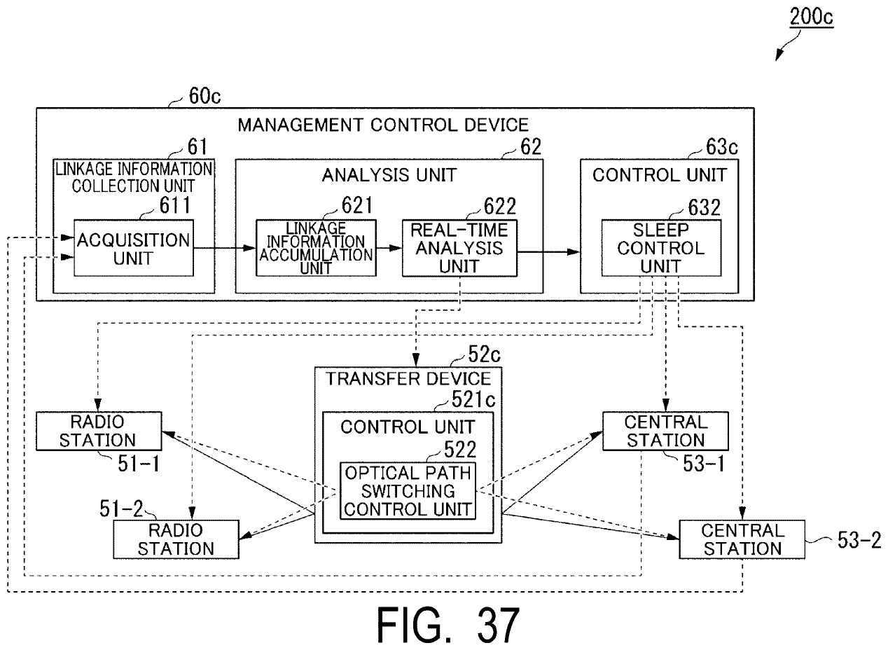

In each embodiment shown in the fifth embodiment to the sixth embodiment, the configuration is shown, in which the management control devices 60 and 60a perform the optical path switching control processing and the sleep control processing. On the other hand, the management control device may be configured to perform the sleep control processing and the transfer device may be configured to perform the optical path switching control processing. Here, the fifth embodiment will be described as an example. FIG. 37 is a diagram showing a configuration example of a mobile NW system 200c according to a modification example 4 of the fifth embodiment. The mobile NW system 200c includes a plurality of radio stations 51-1 and 51-2, a transfer device 52c, a plurality of central stations 53-1 and 53-2, and a management control device 60c.

As shown in FIG. 37, the transfer device 52c includes a control unit 521c, and the management control device 60c does not include a control unit 63c. A real-time analysis unit 622 of the management control device 60c notifies the transfer device 52c of the control information including information indicating the central station 53 which becomes the optical path switching source and information indicating the central station 53 which becomes the optical path switching destination, and notifies the control unit 63c of the control information including information indicating the radio station 51 and the central station 53 which become the sleep control targets.

Note that the real-time analysis unit 622 may notify the control information only when the optical path switching and the sleep control are performed. The control unit 521c of the transfer device 52c performs the optical path switching control processing on the basis of the control information notified from the management control device 60c. The control unit 63c of the management control device 60c performs the sleep control processing on the basis of the control information notified from the real-time analysis unit 622. The control unit 521c of the transfer device 52c includes an optical path switching control unit 522. The optical path switching control unit 522 performs the processing similar to that of the optical path switching control unit 631. Note that when the configuration shown in FIG. 37 is applied to the mobile NW system 200a according to the sixth embodiment, the radio station 51-1 and the central station 53-1 shown in FIG. 37 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

### Modification Example 5 Common to Fifth Embodiment to Sixth Embodiment

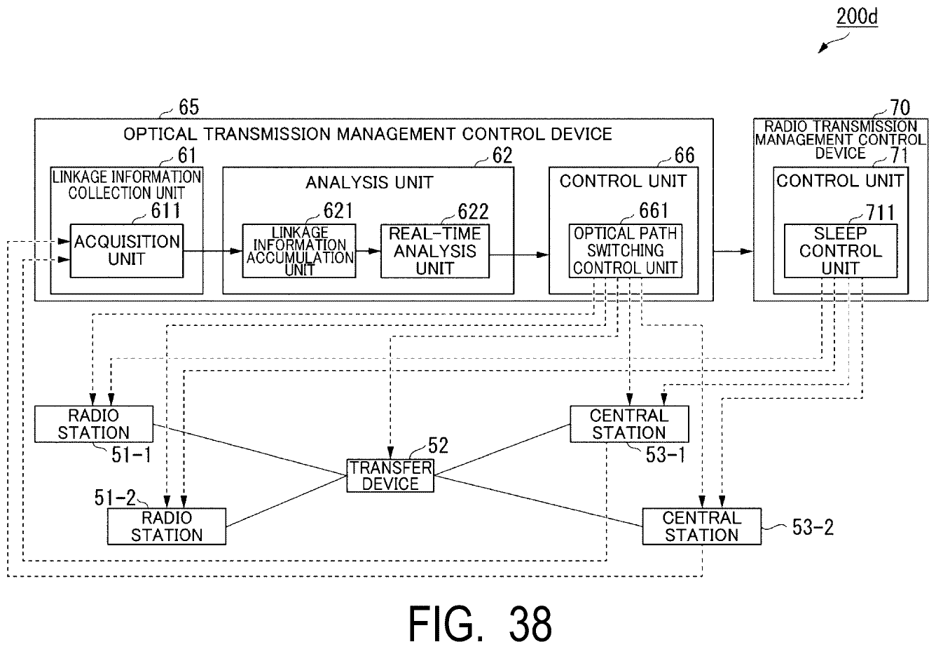

In each embodiment shown in the fifth embodiment to the sixth embodiment, the configuration is shown, in which the management control devices 60 and 60a perform the optical path switching control processing and the sleep control processing. On the other hand, the optical path switching control processing and the sleep control processing may be performed by different devices. Here, the fifth embodiment will be described as an example. FIG. 38 is a diagram showing a configuration example of a mobile NW system 200d according to a modification example 5 of the fifth embodiment. The mobile NW system 200d includes a plurality of radio stations 51-1 and 51-2, a transfer device 52, a plurality of central stations 53-1 and 53-2, an optical transmission management control device 65, and a radio transmission management control device 70. As shown in FIG. 38, the mobile NW system 200d includes the optical transmission management control device 65 and the radio transmission management control device 70 in place of the management control device 60.

The optical transmission management control device 65 controls the optical transmission section. The optical transmission management control device 65 includes a linkage information collection unit 61, an analysis unit 62, and a control unit 66. The linkage information collection unit 61 and the analysis unit 62 perform the processing similar to those of the linkage information collection unit 61 and the analysis unit 62 included in the above-described management control device 60. The control unit 66 includes an optical path switching control unit 661. The optical path switching control unit 661 performs the processing similar to that of the optical path switching control unit 631 included in the above-described management control device 60.

The radio transmission management control device 70 controls the radio transmission section. The radio transmission management control device 70 includes a control unit 71. The control unit 71 includes a sleep control unit 711. The sleep control unit 711 performs the processing similar to that of the sleep control unit 632 included in the above-described management control device 60.

The real-time analysis unit 622 of the optical transmission management control device 65 transmits the control information including information indicating the radio station 51 and the central station 53 which become the sleep control targets to the radio transmission management control device 70. The radio transmission management control device 70 causes the radio station 51 and the central station 53 which become the sleep control targets to execute the sleep or release the sleep on the basis of the control information transmitted from the optical transmission management control device 65. Note that when the configuration shown in FIG. 38 is applied to the mobile NW system 200a according to the sixth embodiment, the radio station 51-1 and the central station 53-1 shown in FIG. 38 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

By being configured in this way, different types of processing such as optical path switching and sleep control can be performed by a plurality of devices. By doing this, it is possible to reduce processing to be performed by one device.

### Modification Example 6 Common to Fifth Embodiment to Sixth Embodiment

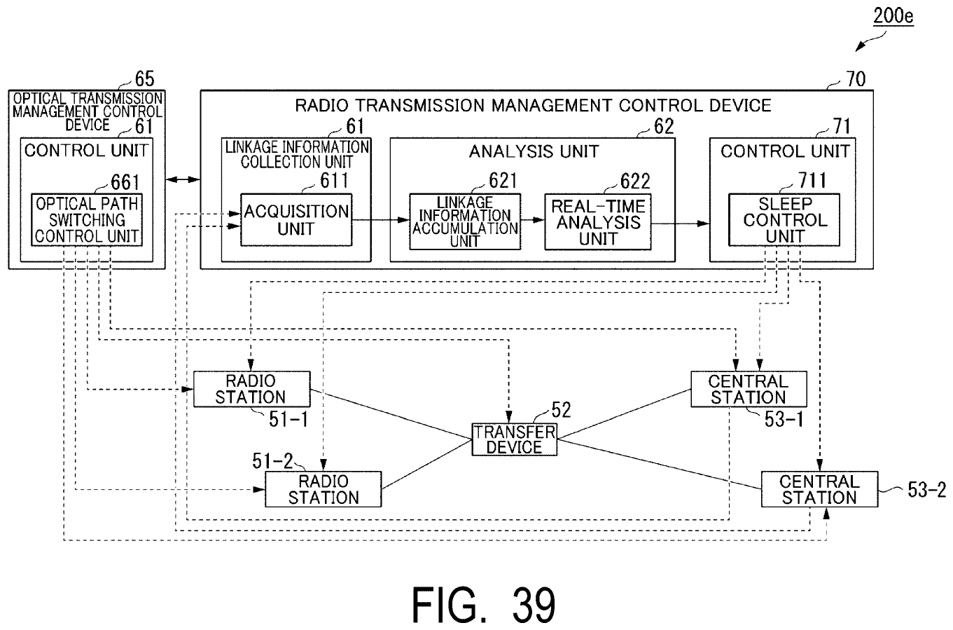

In each embodiment shown in the fifth embodiment to the sixth embodiment, the configuration is shown, in which the management control devices 60 and 60a perform the optical path switching control processing and the sleep control processing. On the other hand, the optical path switching control processing and the sleep control processing may be performed by different devices. Here, the fifth embodiment will be described as an example. FIG. 39 is a diagram showing a configuration example of a mobile NW system 200e according to a modification example 6 of the fifth embodiment. The mobile NW system 200e includes a plurality of radio stations 51-1 and 51-2, a transfer device 52, a plurality of central stations 53-1 and 53-2, an optical transmission management control device 65, and a radio transmission management control device 70. As shown in FIG. 39, the mobile NW system 200e includes the optical transmission management control device 65 and the radio transmission management control device 70 in place of the management control device 60.

The optical transmission management control device 65 controls the optical transmission section. The optical transmission management control device 65 includes a control unit 66. The control unit 66 includes an optical path switching control unit 661. The optical path switching control unit 661 performs the processing similar to that of the optical path switching control unit 631 included in the above-described management control device 60.

The radio transmission management control device 70 controls the radio transmission section. The radio transmission management control device 70 includes a linkage information collection unit 61, an analysis unit 62, and a control unit 71. The linkage information collection unit 61 and the analysis unit 62 perform the processing similar to those of the linkage information collection unit 61 and the analysis unit 62 included in the above-described management control device 60. The control unit 71 includes a sleep control unit 711. The sleep control unit 711 performs the processing similar to that of the sleep control unit 632 included in the above-described management control device 60.

The real-time analysis unit 622 of the radio transmission management control device 70 transmits the control information including information indicating the central station 53 which becomes the optical path switching source and information indicating the central station 53 which becomes the optical path switching destination to the optical transmission management control device 65. The optical transmission management control device 65 performs the optical path switching on the basis of the control information transmitted from the radio transmission management control device 70. Note that when the configuration shown in FIG. 39 is applied to the mobile NW system 200a according to the sixth embodiment, the radio station 51-1 and the central station 53-1 shown in FIG. 39 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

By being configured in this way, different types of processing such as optical path switching and sleep control can be performed by a plurality of devices. By doing this, it is possible to reduce processing to be performed by one device.

### Modification Example 7 Common to Fifth Embodiment to Sixth Embodiment

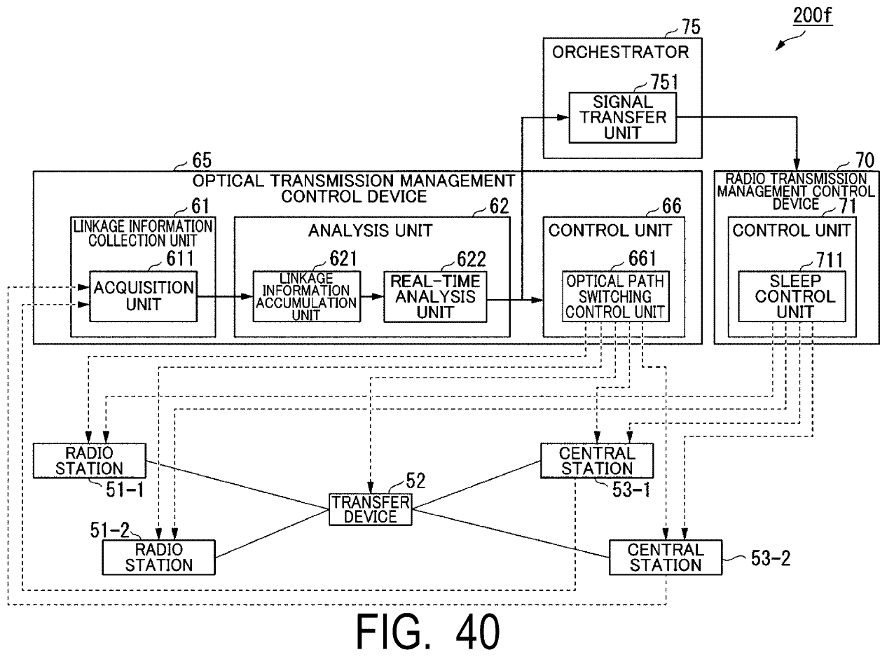

Each embodiment shown in the fifth embodiment to the sixth embodiment may be configured as shown in FIG. 40. Here, the fifth embodiment will be described as an example. FIG. 40 is a diagram showing a configuration example of a mobile NW system 200f according to a modification example 7 of the fifth embodiment. The mobile NW system 200f includes a plurality of radio stations 51-1 and 51-2, a transfer device 52, a plurality of central stations 53-1 and 53-2, an optical transmission management control device 65, a radio transmission management control device 70, and an orchestrator 75. As shown in FIG. 40, the mobile NW system 200f includes the optical transmission management control device 65 and the radio transmission management control device 70 in place of the management control device 60, and further includes the orchestrator 75.

The orchestrator 75 is provided in high level of the optical transmission management control device 65 and the radio transmission management control device 70, and is a host device that controls the optical transmission management control device 65 and the radio transmission management control device 70. The orchestrator 75 transfers the signals between the optical transmission management control device 65 and the radio transmission management control device 70. The orchestrator 75 includes a signal transfer unit 751. The signal transfer unit 751 receives the control information addressed to the radio transmission management control device 70 transmitted from the optical transmission management control device 65. The signal transfer unit 751 transfers the received control information to the radio transmission management control device 70.

The optical transmission management control device 65 performs the processing similar to that of the optical transmission management control device 65 shown in FIG. 38 except that it transmits the control information addressed to the radio transmission management control device 70 to the orchestrator 75. The radio transmission management control device 70 performs the processing similar to that of the radio transmission management control device 70 shown in FIG. 38 except that it receives the control information from the orchestrator 75. Note that when the configuration shown in FIG. 40 is applied to the mobile NW system 200a according to the sixth embodiment, the radio station 51-1 and the central station 53-1 shown in FIG. 40 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

### Modification Example 8 Common to Fifth Embodiment to Sixth Embodiment

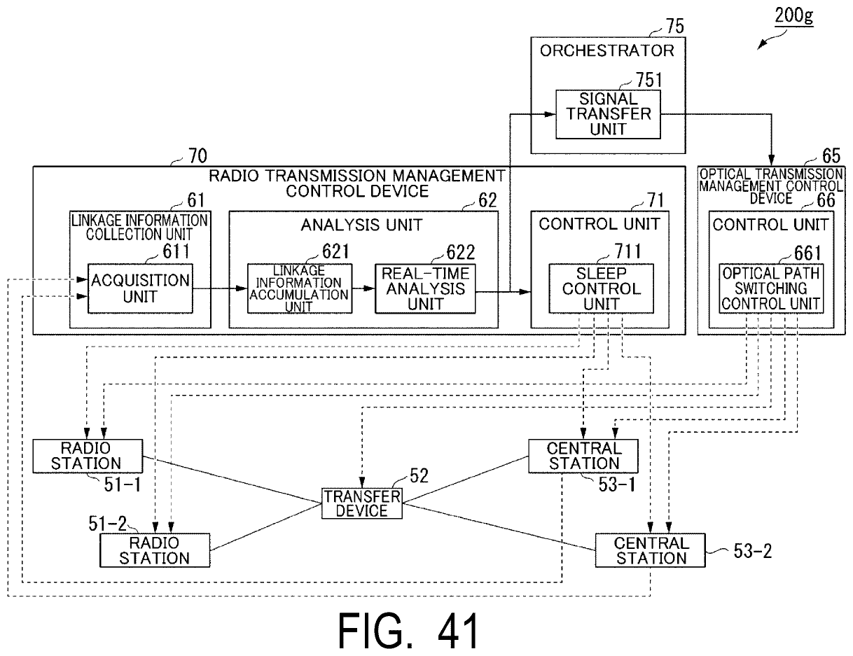

Each embodiment shown in the fifth embodiment to the sixth embodiment may be configured as shown in FIG. 41. Here, the fifth embodiment will be described as an example. FIG. 41 is a diagram showing a configuration example of a mobile NW system 200g according to a modification example 8 of the fifth embodiment. The mobile NW system 200g includes a plurality of radio stations 51-1 and 51-2, a transfer device 52, a plurality of central stations 53-1 and 53-2, an optical transmission management control device 65, a radio transmission management control device 70, and an orchestrator 75. As shown in FIG. 41, the mobile NW system 200g includes the optical transmission management control device 65 and the radio transmission management control device 70 in place of the management control device 60, and further includes the orchestrator 75.

The orchestrator 75 is provided in high level of the optical transmission management control device 65 and the radio transmission management control device 70, and is a host device that controls the optical transmission management control device 65 and the radio transmission management control device 70. The orchestrator 75 transfers the signals between the optical transmission management control device 65 and the radio transmission management control device 70. The orchestrator 75 includes a signal transfer unit 751. The signal transfer unit 751 receives the control information addressed to the optical transmission management control device 65 transmitted from the radio transmission management control device 70. The signal transfer unit 751 transfers the received control information to the optical transmission management control device 65.

The optical transmission management control device 65 performs the processing similar to that of the optical transmission management control device 65 shown in FIG. 39 except that it receives the control information from the orchestrator 75. The radio transmission management control device 70 performs the processing similar to that of the radio transmission management control device 70 shown in FIG. 39 except that it transmits the control information addressed to the optical transmission management control device 65 to the orchestrator 75. Note that when the configuration shown in FIG. 41 is applied to the mobile NW system 200a according to the sixth embodiment, the radio station 51-1 and the central station 53-1 shown in FIG. 41 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

### Modification Example 9 Common to Fifth Embodiment to Sixth Embodiment

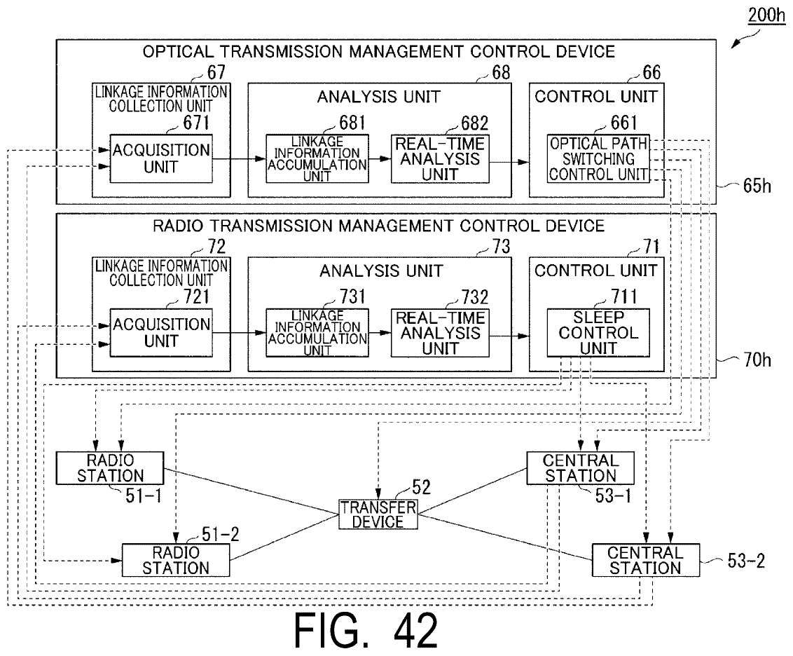

Each embodiment shown in the fifth embodiment to the sixth embodiment may be configured as shown in FIG. 42. Here, the fifth embodiment will be described as an example. FIG. 42 is a diagram showing a configuration example of a mobile NW system 200h according to a modification example 9 of the fifth embodiment. The mobile NW system 200h includes a plurality of radio stations 51-1 and 51-2, a transfer device 52, a plurality of central stations 53-1 and 53-2, an optical transmission management control device 65h, and a radio transmission management control device 70h. As shown in FIG. 42, the mobile NW system 200h includes the optical transmission management control device 65h and the radio transmission management control device 70h in place of the management control device 60. The mobile NW system 200h has a configuration in which the optical transmission management control device 65h and the radio transmission management control device 70h receive the linkage information from each central station 53, respectively.

The optical transmission management control device 65h includes a linkage information collection unit 67, an analysis unit 68, and a control unit 66. The linkage information collection unit 67 includes an acquisition unit 671. The acquisition unit 671 performs the processing similar to that of the acquisition unit 611 included in the above-described management control device 60. The analysis unit 68 includes a linkage information accumulation unit 681 and a real-time analysis unit 682. The linkage information accumulation unit 681 and the real-time analysis unit 682 perform the processing similar to those of the linkage information accumulation unit 621 and the real-time analysis unit 622 included in the management control device 60. The control unit 66 includes an optical path switching control unit 661. The optical path switching control unit 661 performs the processing similar to that of the optical path switching control unit 631 included in the above-described management control device 60.

The radio transmission management control device 70h includes a linkage information collection unit 72, an analysis unit 73, and a control unit 71. The linkage information collection unit 72 includes an acquisition unit 721. The acquisition unit 721 performs the processing similar to that of the acquisition unit 611 included in the above-described management control device 60. The analysis unit 73 includes a linkage information accumulation unit 731 and a real-time analysis unit 732. The linkage information accumulation unit 731 and the real-time analysis unit 732 perform the processing similar to those of the linkage information accumulation unit 621 and the real-time analysis unit 622 included in the management control device 60. The control unit 71 includes a sleep control unit 711. The sleep control unit 711 performs the processing similar to that of the sleep control unit 632 included in the above-described management control device 60.

Note that the timing at which the optical transmission management control device 65h performs the optical path switching control processing and the timing at which the radio transmission management control device 70h performs the sleep control processing may be the timing determined by each device. The mobile NW system 200h includes an orchestrator 75 that controls the optical transmission management control device 65 and the radio transmission management control device 70, and the orchestrator 75 may match the timing at which the optical transmission management control device 65h performs the optical path switching control processing with the timing at which the radio transmission management control device 70h performs the sleep control processing.

Note that when the configuration shown in FIG. 42 is applied to the mobile NW system 200a according to the sixth embodiment, the radio station 51-1 and the central station 53-1 shown in FIG. 42 may be replaced with the base station 55-1 as shown in FIG. 31, the radio station 51-2 and the central station 53-2 may be replaced with the base station 55-2 as shown in FIG. 31, and information indicating the radio station 51 and the central station 53 included in the control information may be read as that of the base station 55.

### Modification Example 10 Common to Fifth Embodiment to Sixth Embodiment

In each embodiment shown in the fifth embodiment to the sixth embodiment, fairness is shown, in which the management control devices 60 and 60a acquire the traffic information and the communication quality information at the same timing. The management control devices 60 and 60a may acquire the traffic information and the communication quality information at different timings. In such a configuration, information of either the traffic information or the communication quality information is acquired with a delay. The management control devices 60 and 60a may be configured to perform the optical path switching control processing and the sleep control processing at the timing when either the traffic information or the communication quality information is acquired. The management control devices 60 and 60a perform the optical path switching control processing and the sleep control processing by using previously acquired information until next information is acquired, if the timing to acquire the information is late. For example, when the traffic information is acquired first, the management control devices 60 and 60a perform the optical path switching control processing and the sleep control processing by using the acquired traffic information and the previously acquired communication quality information.

By being configured in this way, even when some of information among pieces of information used for the optical path switching control processing and the sleep control processing is acquired at early timing, the optical path switching control processing and the sleep control processing can be performed.

### Modification Example 11 Common to Fifth Embodiment to Sixth Embodiment

In each embodiment shown in the fifth embodiment to the sixth embodiment, the configuration is shown, in which the MCS is used as the communication quality information. The management control devices 60 and 60a may perform the determination of the optical path switching control processing and the sleep control processing by using the value of delay of the radio section in addition to the MCS as the communication quality information. In such a configuration, the management control devices 60 and 60a acquire the value of delay of the radio section in addition to the MCS as the communication quality information. Here, the fifth embodiment will be described as an example.

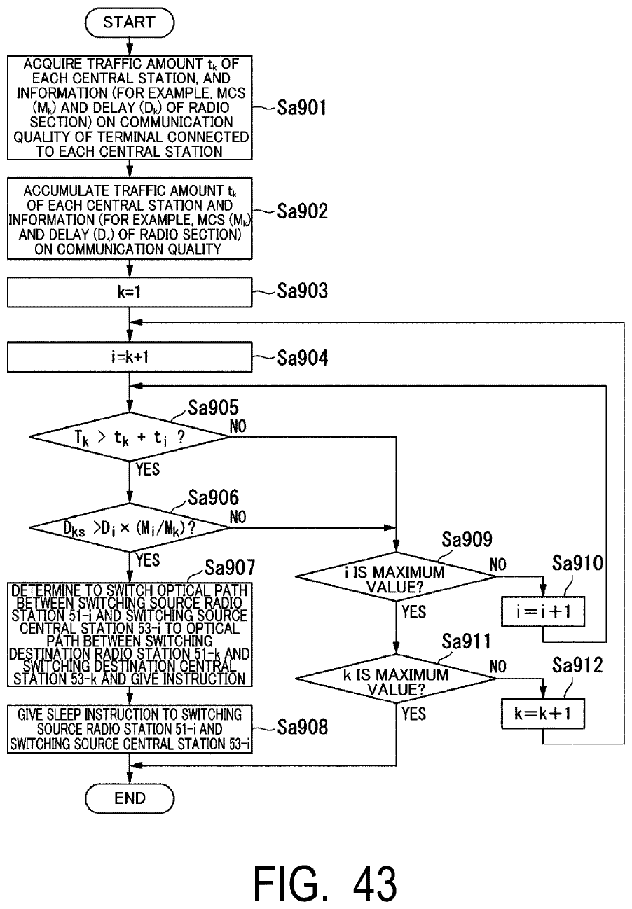

FIG. 43 is a flowchart showing one example of a flow of sleep processing executed by the management control device 60 according to a modification example 11 of the fifth embodiment. Note that the case where there is one terminal 11 connected to each central station 53 will be described.

The acquisition unit 611 acquires the traffic information indicating the traffic amount tₖ of each central station 53, and the MCS (Mₖ) and the delay (Dₖ) of the radio section as information on the communication quality of the terminal 11 connected to each central station 53 as the linkage information (step Sa901). The acquisition unit 611 accumulates the acquired linkage information on each central station 53 in the linkage information accumulation unit 621 (step Sa902). The real-time analysis unit 622 substitutes a value of 1 to the constant k (step Sa903). The real-time analysis unit 622 substitutes a value of (k+1) to the constant i (step Sa904).

The traffic analysis unit 6221 judges whether or not the traffic threshold value Tₖ for the central station 53-k is larger than the total value of the traffic amount tₖ of the central station 53-k and the traffic amount tᵢ of the central station 53-i on the basis of the linkage information (for example, traffic amount tₖ of the central station 53-k) on the central station 53-k, the linkage information (for example, traffic amount tᵢ of the central station 53-i) on the central station 53-i, and the traffic threshold value Tₖ for the central station 53-k accumulated in the linkage information accumulation unit 621 (step Sa905).

When the traffic analysis unit 6221 judges that the traffic threshold value Tₖ for the central station 53-k is larger than the total value of the traffic amount tₖ of the central station 53-k and the traffic amount tᵢ of the central station 53-i (step Sa905—YES), the traffic analysis unit 6221 notifies the communication quality analysis unit 6222 that the condition related to the traffic is satisfied. The communication quality analysis unit 6222 performs the judgement based on the delay value of the radio section. Specifically, the communication quality analysis unit 6222 multiplies the result of dividing the value Mᵢ of the MCS when the connections are changed from the central station 53-i which becomes the switching source central station to the switching destination central station by the value Mₖ of the MCS of the central station 53-k which becomes the switching destination central station by the delay Di of the radio section of the terminal 11 connected to the switching source central station to calculate the delay of the radio section of the terminal 11 changing the connections from the switching source central station to the switching destination central station.

The communication quality analysis unit 6222 compares the calculated delay of the radio section of the terminal 11 with a delay threshold value Dₖₛ for the central station 53-k. The delay threshold value is an example of a switching determination threshold value, and is a threshold value for determining that the optical path switching is necessary, for example. The communication quality analysis unit 6222 judges whether or not the calculated delay of the radio section of the terminal 11 is higher than the delay threshold value Dₖₛ for the central station 53-k (step Sa906). The conditions indicated by the step Sa905 and the step Sa906 are specific examples of the fifth switching condition.

When it is judged that the calculated delay of the radio section of the terminal 11 is higher than the delay threshold value Dₖₛ for the central station 53-k (step Sa906—YES), the communication quality analysis unit 6222 judges that the fifth switching condition is satisfied. In this case, the real-time analysis unit 622 notifies the control unit 63 of the control information including information indicating the central station 53-i which becomes the optical path switching source, information indicating the central station 53-k which becomes the optical path switching destination, and information indicating the radio station 51-i connected to the central station 53-i and the central station 53-i which become the sleep control targets.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-i and the central station 53-i to the optical path between the radio station 51-k and the central station 53-k. The optical path switching control unit 631 transmits the switching destination information including information indicating the radio station 51-k and the central station 53-k which become the determined optical path switching destinations to the transfer device 52. Further, the optical path switching control unit 631 transmits the optical path switching instruction to the radio station 51-i and the central station 53-i which become the determined optical path switching sources (step Sa907).

The sleep control unit 632 determines the radio station 51-i and the central station 53-i which become the sleep control targets on the basis of the control information notified from the real-time analysis unit 622. The sleep control unit 632 transmits the sleep permission notification to the determined radio station 51-i and central station 53-i (step Sa908).

In the processing of the step Sa906, when it is judged that the calculated delay of the radio section of the terminal 11 is not higher than the delay threshold value Dₖₛ for the central station 53-k (step Sa906—NO), the real-time analysis unit 622 judges that the fifth switching condition is not satisfied. In this case, the real-time analysis unit 622 judges whether or not the constant i is the maximum value (step Sa909). When it is judged that the constant i is not the maximum value (step Sa909—NO), the real-time analysis unit 622 adds a value of 1 to a value of the constant i (step Sa910). Thereafter, the real-time analysis unit 622 executes the processing of the step Sa905 again.

On the other hand, when it is judged that the constant i is the maximum value (step Sa909—YES), the real-time analysis unit 622 judges whether or not the constant k is the maximum value (step Sa911). When it is judged that the constant k is not the maximum value (step Sa911—NO), the real-time analysis unit 622 adds a value of 1 to a value of the constant k (step Sa912). Thereafter, the real-time analysis unit 622 executes the processing of the step Sa904 again. On the other hand, when it is judged that the constant k is the maximum value (step Sa911—YES), the real-time analysis unit 622 terminates the processing.

In the processing of the step Sa905, when it is judged that the traffic threshold value Tₖ for the central station 53-k is equal to or less than the total value of the traffic amount tₖ of the central station 53-k and the traffic amount tᵢ of the central station 53-i (step Sa905—NO), the real-time analysis unit 622 performs the processing of the step Sa909.

Note that although the MCS has been used in the processing shown in FIG. 43, the reception power and the information on the distance between the terminal 11 and the central station 53 may be used. Note that when the processing shown in FIG. 43 is applied to the configuration shown in FIG. 36, the radio station 51-1 and the central station 53-1 shown in FIG. 43 may be replaced by the base station 55-1 as shown in FIG. 31, the radio stations 51-2 and the central station 53-2 may be replaced by the base station 55-2 as shown in FIG. 31, and information indicating the radio station 51 and the central station 53 included in the control information may be read as that of the base station 55.

### Modification Example 12 Common to Fifth Embodiment to Sixth Embodiment

In each embodiment shown in the fifth embodiment to the sixth embodiment, in each embodiment shown in the fifth embodiment to the sixth embodiment, the configuration is shown, in which the MCS is used as the communication quality information. The management control devices 60 and 60a may perform the determination of the optical path switching control processing and the sleep control processing by using information on the distance in addition to the MCS as the communication quality information. In such a configuration, the management control devices 60 and 60a acquire the value of delay of the radio section in addition to the MCS as the communication quality information. Here, the fifth embodiment will be described as an example.

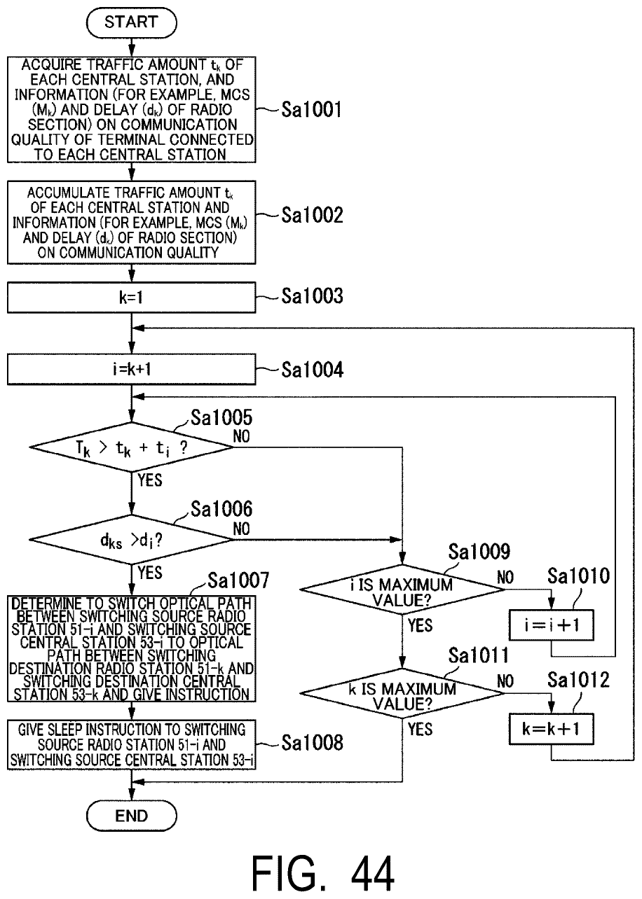

FIG. 44 is a flowchart showing one example of a flow of sleep processing executed by the management control device 60 according to a modification example 12 of the fifth embodiment. Note that the case where there is one terminal 11 connected to each central station 53 will be described.

The acquisition unit 611 acquires the traffic information indicating the traffic amount tₖ of each central station 53, and the MCS (Mₖ) and the delay (dₖ) of the radio section as information on the communication quality of the terminal 11 connected to each central station 53 as the linkage information (step Sa1001). The acquisition unit 611 accumulates the acquired linkage information on each central station 53 in the linkage information accumulation unit 621 (step Sa1002). The real-time analysis unit 622 substitutes a value of 1 to the constant k (step Sa1003). The real-time analysis unit 622 substitutes a value of (k+1) to the constant i (step Sa1004).

The traffic analysis unit 6221 judges whether or not the traffic threshold value Tₖ for the central station 53-k is larger than the total value of the traffic amount tₖ of the central station 53-k and the traffic amount tᵢ of the central station 53-i on the basis of the linkage information (for example, traffic amount tₖ of the central station 53-k) on the central station 53-k, the linkage information (for example, traffic amount tᵢ of the central station 53-i) on the central station 53-i, and the traffic threshold value Tₖ for the central station 53-k accumulated in the linkage information accumulation unit 621 (step Sa1005).

When the traffic analysis unit 6221 judges that the traffic threshold value Tₖ for the central station 53-k is larger than the total value of the traffic amount tₖ of the central station 53-k and the traffic amount tᵢ of the central station 53-i (step Sa1005—YES), the traffic analysis unit 6221 notifies the communication quality analysis unit 6222 that the condition related to the traffic is satisfied. The communication quality analysis unit 6222 performs the judgement based on the distance. Specifically, the communication quality analysis unit 6222 calculates a distance di when the terminal 11 connected to the central station 53-i which becomes the switching source central station changes the connections to the central station 53-k which becomes the switching destination central station.

The communication quality analysis unit 6222 compares the calculated distance dᵢ with a distance threshold value dₖₛ for the central station 53-k. The distance threshold value is an example of a switching determination threshold value, and is a threshold value for determining that the optical path switching is necessary, for example. The communication quality analysis unit 6222 judges whether or not the calculated distance dᵢ is higher than the distance threshold value dₖₛ for the central station 53-k (step Sa1006). The conditions indicated by the step Sa1005 and the step Sa1006 are specific examples of the fifth switching condition.

When it is judged that the calculated distance dᵢ is higher than the distance threshold value dₖₛ for the central station 53-k (step Sa1006—YES), the communication quality analysis unit 6222 judges that the fifth switching condition is satisfied. In this case, the real-time analysis unit 622 notifies the control unit 63 of the control information including information indicating the central station 53-i which becomes the optical path switching source, information indicating the central station 53-k which becomes the optical path switching destination, and information indicating the radio station 51-i connected to the central station 53-i and the central station 53-i which become the sleep control targets.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-i and the central station 53-i to the optical path between the radio station 51-k and the central station 53-k. The optical path switching control unit 631 transmits the switching destination information including information indicating the radio station 51-k and the central station 53-k which become the determined optical path switching destinations to the transfer device 52. Further, the optical path switching control unit 631 transmits the optical path switching instruction to the radio station 51-i and the central station 53-i which become the determined optical path switching sources (step Sa1007).

The sleep control unit 632 determines the radio station 51-i and the central station 53-i which become the sleep control targets on the basis of the control information notified from the real-time analysis unit 622. The sleep control unit 632 transmits the sleep permission notification to the determined radio station 51-i and central station 53-i (step Sa1008).

In the processing of the step Sa1006, when it is judged that the calculated distance dᵢ is not higher than the distance threshold value dₖₛ for the central station 53-k (step Sa1006—NO), the real-time analysis unit 622 judges that the fifth switching condition is not satisfied. In this case, the real-time analysis unit 622 judges whether or not the constant i is the maximum value (step Sa1009). When it is judged that the constant i is not the maximum value (step Sa1009—NO), the real-time analysis unit 622 adds a value of 1 to a value of the constant i (step Sa1010). Thereafter, the real-time analysis unit 622 executes the processing of the step Sa1005 again.

On the other hand, when it is judged that the constant i is the maximum value (step Sa1009—YES), the real-time analysis unit 622 judges whether or not the constant k is the maximum value (step Sa1011). When it is judged that the constant k is not the maximum value (step Sa1011—NO), the real-time analysis unit 622 adds a value of 1 to a value of the constant k (step Sa1012). Thereafter, the real-time analysis unit 622 executes the processing of the step Sa1004 again. On the other hand, when it is judged that the constant k is the maximum value (step Sa1011—YES), the real-time analysis unit 622 terminates the processing.

In the processing of the step Sa1005, when it is judged that the traffic threshold value Tₖ for the central station 53-k is equal to or less than the total value of the traffic amount tₖ of the central station 53-k and the traffic amount tᵢ of the central station 53-i (step Sa1005—NO), the real-time analysis unit 622 performs the processing of the step Sa1009.

Note that when the processing shown in FIG. 44 is applied to the configuration shown in FIG. 36, the radio station 51-1 and the central station 53-1 shown in FIG. 44 may be replaced by the base station 55-1 as shown in FIG. 31, the radio stations 51-2 and the central station 53-2 may be replaced by the base station 55-2 as shown in FIG. 31, and information indicating the radio station 51 and the central station 53 included in the control information may be replaced as that of the base station 55.

### Modification Example 13 Common to Fifth Embodiment to Sixth Embodiment

In each embodiment shown in the fifth embodiment to the sixth embodiment, in each embodiment shown in the fifth embodiment to the sixth embodiment, the configuration is shown, in which the MCS is used as the communication quality information. The management control devices 60 and 60a may perform the determination of the optical path switching control processing and the sleep control processing by using the reception power as the communication quality information. In such a configuration, the management control devices 60 and 60a acquire the value of the reception power as the communication quality information. Here, the fifth embodiment will be described as an example.

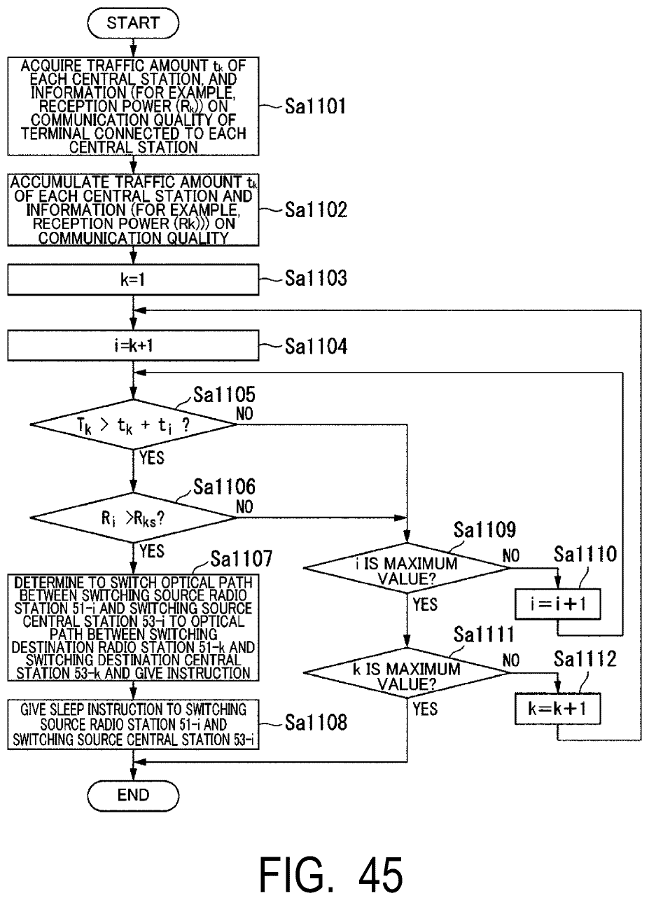

FIG. 45 is a flowchart showing one example of a flow of sleep processing executed by the management control device 60 according to a modification example 13 of the fifth embodiment. Note that the case where there is one terminal 11 connected to each central station 53 will be described.

The acquisition unit 611 acquires the traffic information indicating the traffic amount tₖ of each central station 53 and the reception power (Rk) as information on the communication quality of the terminal 11 connected to each central station 53 as the linkage information (step Sa1101). The acquisition unit 611 accumulates the acquired linkage information on each central station 53 in the linkage information accumulation unit 621 (step Sa1102). The real-time analysis unit 622 substitutes a value of 1 to the constant k (step Sa1103). The real-time analysis unit 622 substitutes a value of (k+1) to the constant i (step Sa1104).

The traffic analysis unit 6221 judges whether or not the traffic threshold value Tₖ for the central station 53-k is larger than the total value of the traffic amount tₖ of the central station 53-k and the traffic amount tᵢ of the central station 53-i on the basis of the linkage information (for example, traffic amount tₖ of the central station 53-k) on the central station 53-k, the linkage information (for example, traffic amount tᵢ of the central station 53-i) on the central station 53-i, and the traffic threshold value Tₖ for the central station 53-k accumulated in the linkage information accumulation unit 621 (step Sa1105).

When the traffic analysis unit 6221 judges that the traffic threshold value Tₖ for the central station 53-k is larger than the total value of the traffic amount tₖ of the central station 53-k and the traffic amount tᵢ of the central station 53-i (step Sa1105—YES), the traffic analysis unit 6221 notifies the communication quality analysis unit 6222 that the condition related to the traffic is satisfied. The communication quality analysis unit 6222 performs the judgement based on the reception power. Specifically, the communication quality analysis unit 6222 calculates the reception power Ri when the terminal 11 connected to the central station 53-i which becomes the switching source central station changes the connections to the central station 53-k which becomes the switching destination central station.

The communication quality analysis unit 6222 compares the calculated reception power Ri with a reception power threshold value Rₖₛ for the central station 53-k. The reception power threshold value is an example of a switching determination threshold value, and is a threshold value for determining that the optical path switching is necessary, for example. The communication quality analysis unit 6222 judges whether or not the calculated reception power Ri is higher than the reception power threshold value Rₖₛ for the central station 53-k (step Sa1106). The conditions indicated by the step Sa1105 and the step Sa1106 are specific examples of the fifth switching condition.

When it is judged that the calculated reception power Ri is higher than the reception power threshold value Rₖₛ for the central station 53-k (step Sa1106—YES), the communication quality analysis unit 6222 judges that the fifth switching condition is satisfied. In this case, the real-time analysis unit 622 notifies the control unit 63 of the control information including information indicating the central station 53-i which becomes the optical path switching source, information indicating the central station 53-k which becomes the optical path switching destination, and information indicating the radio station 51-i connected to the central station 53-i and the central station 53-i which become the sleep control targets.

The optical path switching control unit 631 determines the radio station 51 and the central station 53 which become the optical path switching sources, and the radio station 51 and the central station 53 which become the optical path switching destinations on the basis of the control information notified from the real-time analysis unit 622. By doing this, the optical path switching control unit 631 determines to switch the optical path between the radio station 51-i and the central station 53-i to the optical path between the radio station 51-k and the central station 53-k. The optical path switching control unit 631 transmits the switching destination information including information indicating the radio station 51-k and the central station 53-k which become the determined optical path switching destinations to the transfer device 52. Further, the optical path switching control unit 631 transmits the optical path switching instruction to the radio station 51-i and the central station 53-i which become the determined optical path switching sources (step Sa1107).

The sleep control unit 632 determines the radio station 51-i and the central station 53-i which become the sleep control targets on the basis of the control information notified from the real-time analysis unit 622. The sleep control unit 632 transmits the sleep permission notification to the determined radio station 51-i and central station 53-i (step Sa1108).

In the processing of the step Sa1106, when it is judged that the calculated reception power Ri is not higher than the reception power threshold value Rₖₛ for the central station 53-k (step Sa1106—NO), the real-time analysis unit 622 judges that the fifth switching condition is not satisfied. In this case, the real-time analysis unit 622 judges whether or not the constant i is the maximum value (step Sa1109). When it is judged that the constant i is not the maximum value (step Sa1109—NO), the real-time analysis unit 622 adds a value of 1 to a value of the constant i (step Sa1110). Thereafter, the real-time analysis unit 622 executes the processing of the step Sa1105 again.

On the other hand, when it is judged that the constant i is the maximum value (step Sa1109—YES), the real-time analysis unit 622 judges whether or not the constant k is the maximum value (step Sa1111). When it is judged that the constant k is not the maximum value (step Sa1111—NO), the real-time analysis unit 622 adds a value of 1 to a value of the constant k (step Sa1112). Thereafter, the real-time analysis unit 622 executes the processing of the step Sa1104 again. On the other hand, when it is judged that the constant k is the maximum value (step Sa1111—YES), the real-time analysis unit 622 terminates the processing.

In the processing of the step Sa1105, when it is judged that the traffic threshold value Tₖ for the central station 53-k is equal to or less than the total value of the traffic amount tₖ of the central station 53-k and the traffic amount tᵢ of the central station 53-i (step Sa1105—NO), the real-time analysis unit 622 performs the processing of the step Sa1109.

Note that when the processing shown in FIG. 45 is applied to the configuration shown in FIG. 36, the radio station 51-1 and the central station 53-1 shown in FIG. 45 may be replaced by the base station 55-1 as shown in FIG. 31, the radio stations 51-2 and the central station 53-2 may be replaced by the base station 55-2 as shown in FIG. 31, and information indicating the radio station 51 and the central station 53 included in the control information may be replaced as that of the base station 55.

At least, some or all of each functional unit of the management control devices 20, 20a, 20b, 20c, 20d, 60, 60a, 60b, and 60c, some or all of each functional unit of the optical transmission management control devices 30 and 65, some or all of each functional unit of the radio transmission management control devices 40 and 70, or some or all of each functional unit of the transfer devices 14, 14c, 52, 52a, 52b, and 52c are realized as software by causing a processor such as a CPU (Central Processing Unit) to execute a program sored in a storage device having a non-volatile recording medium (non-transitory recording medium) and a storage unit. The program may be recorded on a computer-readable non-transitory recording medium. The computer-readable non-transitory recording medium is a non-temporary recording medium such as a portable medium such as a flexible disk, a magneto-optical disc, a ROM (Read Only Memory), or a CD-ROM (Compact Disc Read Only Memory), or a storage device such as a hard disk built into a computer system.

At lease, some or all of each functional unit of the management control devices 20, 20a, 20b, 20c, 20d, 60, 60a, 60b, and 60c, some or all of each functional unit of the optical transmission management control devices 30 and 65, some or all of each functional unit of the radio transmission management control devices 40 and 70, or some or all of each functional unit of the transfer devices 14, 14c, 52, 52a, 52b, and 52c may be realized by using hardware including an electronic circuit or circuitry using LSI (Large Scale Integrated circuit), ASIC (Application Specific Integrated Circuit), PLD (Programmable Logic Device), FPGA (Field Programmable Gate Array), or the like, for example.

Although the embodiment of the present invention has been described above in detail with reference to the drawings, a specific configuration is not limited to this embodiment and design within the scope of the gist of the present invention, and the like are included.

### INDUSTRIAL APPLICABILITY

The present invention is applicable to the optical communication systems such as an optical access system.

### REFERENCE SIGNS LIST

11 Terminal
12 Small cell radio station
13 Macro cell radio station
14, 14a, 14c, 52, 52a, 52b, 52c Transfer device
15 Small cell central station
16 Macro cell central station
17 Small cell base station
18 Macro cell base station
19, 56 Server
20, 20a, 20b, 20c, 20d, 60, 60a, 60b, 60c Management control device
21, 21b, 21c, 61, 61a, 67, 72 Linkage information collection unit
22, 22b, 22c, 22d, 62, 62a, 68, 73 Analysis unit
23, 23b, 23c, 23d, 31, 41, 63, 63a, 63c, 66, 71, 521, 521c Control unit
30, 65, 65h Optical transmission management control device
40, 70, 70h Radio transmission management control device
51, 51-1, 51-2 Radio station
53, 53-1, 53-2 Central station
75 Orchestrator
100, 100a, 100b, 100c, 100d, 110, 120, 200, 200a, 200b, 200c, 200d, 200e, 200f, 200g, 200h Mobile NW system
211, 211b, 211c, 611, 671, 721 Acquisition unit
221, 621, 681, 731 Linkage information accumulation unit
222, 222b, 222c, 222d, 622, 682, 732 Real-time analysis unit
231, 231b, 231c, 231d, 311, 522, 631, 631a, 661 Optical path switching control unit
232, 232b, 232c, 232d, 411, 523, 632, 632a, 711 Sleep control unit
751 Signal transfer unit
6221, 6221a Traffic analysis unit
6222, 6222a Communication quality analysis unit

1. A management control device comprising:
a information collector configured to acquire information indicating a communication state with one or more terminals from each of one or more first base stations which perform radio communication with the one or more terminals and one or more second base stations which form a smaller range communication area than that of the one or more first base stations in a communication area formed by the one or more first base stations and perform the radio communication with the one or more terminals;
an analyzer configured to determine whether or not an optical path switching is necessary on the basis of the information;
an optical path switching controller configured to control the switching of optical paths of the one or more first base stations or optical paths of the one or more second base stations when it is determined that the optical path switching is necessary; and
a sleep controller configured to shift the one or more first base stations or the one or more second base stations to a sleep state before the optical path switching is performed or after the switching is performed.

2. The management control device according to claim 1, wherein
the information is traffic amount information, and
the analyzer compares a traffic amount indicated by the traffic amount information with a threshold value for determining that the optical path switching is necessary and determines that the optical path switching is necessary when the traffic amount is smaller than the threshold value.

3. The management control device according to claim 2, wherein
the optical path switching controller controls so as to switch the optical path of the one or more second base stations to the one or more first base stations when the traffic amount indicated by the traffic amount information obtained from the one or more second base stations is smaller than the threshold value, and
the sleep controller shifts the one or more second base stations to the sleep state before the optical path switching is performed or after the switching is performed.

4. The management control device according to claim 2, wherein
the optical path switching controller controls so as to switch the optical path of the one or more first base stations to the one or more second base stations when the traffic amount indicated by the traffic amount information obtained from the one or more first base stations is smaller than the threshold value, and
the sleep controller shifts the one or more first base stations to the sleep state before the optical path switching is performed or after the switching is performed.

5. The management control device according to claim 2, wherein
the information further includes information on communication quality of the one or more terminals, and
the analyzer determines that the optical path switching is necessary when the traffic amount is smaller than the threshold value and a condition indicating that the communication quality is good is satisfied.

6. The management control device according to claim 5, wherein
in a case where one or more terminals are multiple,
the analyzer determines that the optical path switching is necessary when the traffic amount is smaller than the threshold value and the condition indicating that the communication quality is good is satisfied when all terminals connected to the one or more first base stations or the one or more second base stations which become switching sources are connected to the one or more first base stations or the one or more second base stations which become switching destinations.

7. The management control device according to claim 5, wherein
the analyzer uses at least any of MCS (Modulation and Coding Scheme), reception power, and delay and distance of a radio section as information on the communication quality.

8. A base station that forms a first communication area or a base station that forms a second communication area with a range smaller than that of the base station in a first communication area formed by the base station, the base station comprising:
a transmitter configured to transmit information indicating a communication state with one or more terminals to a management control device that controls a system;
a receiver configured to receive an optical path switching instruction indicating that the management control device determines that an optical path switching is necessary on the basis of the information; and
a sleep processor configured to shift to a sleep state before the optical path switching is performed or after the switching is performed based on the optical path switching instruction.

9. (canceled)

10. (canceled)

11. (canceled)

12. A control method comprising:
acquiring information indicating a communication state with one or more terminals from each of one or more first base stations which perform radio communication with the one or more terminals and one or more second base stations which form a smaller range communication area than that of the one or more first base stations in a communication area formed by the one or more first base stations and perform the radio communication with the one or more terminals;
determining whether or not an optical path switching and sleep control are necessary on the basis of the information;
controlling the switching of optical paths of the one or more first base stations or optical paths of the one or more second base stations when it is determined that the optical path switching is necessary; and
shifting the one or more first base stations or the one or more second base stations to a sleep state before the optical path switching is performed or after the switching is performed.
